(19) United States
(12) Patent Application Publication
(10) Pub. No.: US 2021/0214058 A1
(43) Pub. Date: Jul. 15, 2021

(54) MULTI-HULL UNMANNED WATER VEHICLE

(71) Applicant: ThayerMahan, Inc., Groton, CT (US)

(72) Inventors: Richard J. HINE, Mystic, CT (US); Alexander LORMAN, Mystic, CT (US); Michael Joseph CONNOR, Mystic, CT (US)

(21) Appl. No.: 17/145,094

(22) Filed: Jan. 8, 2021

Related U.S. Application Data
(60) Provisional application No. 63/073,054, filed on Sep. 1, 2020.
(60) Provisional application No. 62/958,944, filed on Jan. 9, 2020.

(51) Int. Cl. B63B 79/40; B63B 1/12; B63B 3/48; G05D 1/00; B63B 79/10; B63B 21/16; B63B 35/00; B63H 25/06; B63H 25/46; B63H 1/14; G08G 3/02; B63B 13/02; F02B 63/04; G05D 1/02; B60L 8/00; F03D 9/32; F03D 9/11; F03D 9/00; H02S 20/30; H02S 40/38; H02J 7/35

(52) U.S. Cl. CPC B63B 79/40; H02J 7/14; B63B 3/48; G05D 1/0022; B63B 79/10; G05D 1/0016; B63B 21/16; B63B 35/003; B63H 25/06; B63H 25/46; B63H 1/14; G08G 3/02; B63B 13/02; F02B 63/042; B63B 1/121; G05D 1/0088; G05D 1/0206; B60L 8/003; F03D 9/32; F03D 9/11; F03D 9/007; H02S 20/30; H02S 40/38; H02J 7/35; B63B 2035/007; B60L 2200/32; F05B 2220/708; F05B 2240/931; B63B 1/125

(57) ABSTRACT

Described herein is an unmanned water vehicle comprising two or more hulls, a retractable sensor apparatus, a wireless communications device, a steerable drive apparatus, a mobility and control module providing operation of the unmanned water vehicle, and a power system comprising: one or more solar panels and an energy storage device, wherein the unmanned water vehicle is capable of continuous operation for a period of at least 3 months.

### CROSS-REFERENCE TO RELATED APPLICATIONS

This application claims the priority and benefit of U.S. Provisional Application No. 62/958,944, filed Jan. 9, 2020, and entitled: MULTI-HULL UNMANNED WATER VEHICLE, and U.S. Provisional Application No. 63/073,054, filed Sep. 1, 2020, and entitled: MULTI-HULL UNMANNED WATER VEHICLE, the contents of which are incorporated herein by reference in their entirety.

### BACKGROUND

Marine monitoring, testing, and surveillance, operations require towing, releasing, or transporting a plurality of sensors within or above the water. Such operations are performed in seas and oceans worldwide for conservation efforts and scientific explorations as well as for industrial and military inspection purposes.

### SUMMARY

Provided herein is an unmanned water vehicle comprising: two or more hulls; a deck coupled between the two or more hulls; a communication and control system comprising: a wireless communications device; a steerable drive apparatus; and a mobility and control module providing operation of the unmanned water vehicle in a remote piloted mode, a semi-autonomous mode, and a fully autonomous mode; and a power system comprising: one or more solar panels; and an energy storage device receiving energy from the one or more solar panels; the power system enabling continuous operation of the unmanned water vehicle for a period of at least 3 months.

In some embodiments, the two or more hulls have a length of about 9 feet to about 40 feet. In some embodiments, the two or more hulls have a length of about 9 feet to about 12 feet, about 9 feet to about 15 feet, about 9 feet to about 18 feet, about 9 feet to about 20 feet, about 9 feet to about 25 feet, about 9 feet to about 30 feet, about 9 feet to about 35 feet, about 9 feet to about 40 feet, about 12 feet to about 15 feet, about 12 feet to about 18 feet, about 12 feet to about 20 feet, about 12 feet to about 25 feet, about 12 feet to about 30 feet, about 12 feet to about 35 feet, about 12 feet to about 40 feet, about 15 feet to about 18 feet, about 15 feet to about 20 feet, about 15 feet to about 25 feet, about 15 feet to about 30 feet, about 15 feet to about 35 feet, about 15 feet to about 40 feet, about 18 feet to about 20 feet, about 18 feet to about 25 feet, about 18 feet to about 30 feet, about 18 feet to about 35 feet, about 18 feet to about 40 feet, about 20 feet to about 25 feet, about 20 feet to about 30 feet, about 20 feet to about 35 feet, about 20 feet to about 40 feet, about 25 feet to about 30 feet, about 25 feet to about 35 feet, about 25 feet to about 40 feet, about 30 feet to about 35 feet, about 30 feet to about 40 feet, or about 35 feet to about 40 feet. In some embodiments, the two or more hulls have a length of about 9 feet, about 12 feet, about 15 feet, about 18 feet, about 20 feet, about 25 feet, about 30 feet, about 35 feet, or about 40 feet, including increments therein. In some embodiments, the two or more hulls have a length of at least about 9 feet, about 12 feet, about 15 feet, about 18 feet, about 20 feet, about 25 feet, about 30 feet, or about 35 feet, including increments therein. In some embodiments, the two or more hulls have a length of at most about 12 feet, about 15 feet, about 18 feet, about 20 feet, about 25 feet, about 30 feet, about 35 feet, or about 40 feet, including increments therein.

In some embodiments, the two or more hulls have a height of about 1 foot to about 6 feet. In some embodiments, the two or more hulls have a height of about 1 foot to about 1.5 feet, about 1 foot to about 2 feet, about 1 foot to about 2.5 feet, about 1 foot to about 3 feet, about 1 foot to about 3.5 feet, about 1 foot to about 4 feet, about 1 foot to about 4.5 feet, about 1 foot to about 5 feet, about 1 foot to about 5.5 feet, about 1 foot to about 6 feet, about 1.5 feet to about 2 feet, about 1.5 feet to about 2.5 feet, about 1.5 feet to about 3 feet, about 1.5 feet to about 3.5 feet, about 1.5 feet to about 4 feet, about 1.5 feet to about 4.5 feet, about 1.5 feet to about 5 feet, about 1.5 feet to about 5.5 feet, about 1.5 feet to about 6 feet, about 2 feet to about 2.5 feet, about 2 feet to about 3 feet, about 2 feet to about 3.5 feet, about 2 feet to about 4 feet, about 2 feet to about 4.5 feet, about 2 feet to about 5 feet, about 2 feet to about 5.5 feet, about 2 feet to about 6 feet, about 2.5 feet to about 3 feet, about 2.5 feet to about 3.5 feet, about 2.5 feet to about 4 feet, about 2.5 feet to about 4.5 feet, about 2.5 feet to about 5 feet, about 2.5 feet to about 5.5 feet, about 2.5 feet to about 6 feet, about 3 feet to about 3.5 feet, about 3 feet to about 4 feet, about 3 feet to about 4.5 feet, about 3 feet to about 5 feet, about 3 feet to about 5.5 feet, about 3 feet to about 6 feet, about 3.5 feet to about 4 feet, about 3.5 feet to about 4.5 feet, about 3.5 feet to about 5 feet, about 3.5 feet to about 5.5 feet, about 3.5 feet to about 6 feet, about 4 feet to about 4.5 feet, about 4 feet to about 5 feet, about 4 feet to about 5.5 feet, about 4 feet to about 6 feet, about 4.5 feet to about 5 feet, about 4.5 feet to about 5.5 feet, about 4.5 feet to about 6 feet, about 5 feet to about 5.5 feet, about 5 feet to about 6 feet, or about 5.5 feet to about 6 feet. In some embodiments, the two or more hulls have a height of about 1 foot, about 1.5 feet, about 2 feet, about 2.5 feet, about 3 feet, about 3.5 feet, about 4 feet, about 4.5 feet, about 5 feet, about 5.5 feet, or about 6 feet, including increments therein. In some embodiments, the two or more hulls have a height of at least about 1 foot, about 1.5 feet, about 2 feet, about 2.5 feet, about 3 feet, about 3.5 feet, about 4 feet, about 4.5 feet, about 5 feet, or about 5.5 feet, including increments therein. In some embodiments, the two or more hulls have a height of at most about 1.5 feet, about 2 feet, about 2.5 feet, about 3 feet, about 3.5 feet, about 4 feet, about 4.5 feet, about 5 feet, about 5.5 feet, or about 6 feet, including increments therein.

In some embodiments, the unmanned water vehicle has a width of about 5 feet to about 30 feet. In some embodiments, the unmanned water vehicle has a width of about 5 feet to about 8 feet, about 5 feet to about 11 feet, about 5 feet to about 14 feet, about 5 feet to about 17 feet, about 5 feet to about 20 feet, about 5 feet to about 23 feet, about 5 feet to about 26 feet, about 5 feet to about 30 feet, about 8 feet to about 11 feet, about 8 feet to about 14 feet, about 8 feet to about 17 feet, about 8 feet to about 20 feet, about 8 feet to about 23 feet, about 8 feet to about 26 feet, about 8 feet to about 30 feet, about 11 feet to about 14 feet, about 11 feet to about 17 feet, about 11 feet to about 20 feet, about 11 feet to about 23 feet, about 11 feet to about 26 feet, about 11 feet to about 30 feet, about 14 feet to about 17 feet, about 14 feet to about 20 feet, about 14 feet to about 23 feet, about 14 feet to about 26 feet, about 14 feet to about 30 feet, about 17 feet to about 20 feet, about 17 feet to about 23 feet, about 17 feet to about 26 feet, about 17 feet to about 30 feet, about 20 feet to about 23 feet, about 20 feet to about 26 feet, about 20 feet to about 30 feet, about 23 feet to about 26 feet, about 23 feet to about 30 feet, or about 26 feet to about 30 feet, including increments therein. In some embodiments, the unmanned water vehicle has a width of about 5 feet, about 8 feet, about 11 feet, about 14 feet, about 17 feet, about 20 feet, about 23 feet, about 26 feet, or about 30 feet, including increments therein. In some embodiments, the unmanned water vehicle has a width of at least about 5 feet, about 8 feet, about 11 feet, about 14 feet, about 17 feet, about 20 feet, about 23 feet, or about 26 feet, including increments therein. In some embodiments, the unmanned water vehicle has a width of at most about 8 feet, about 11 feet, about 14 feet, about 17 feet, about 20 feet, about 23 feet, about 26 feet, or about 30 feet, including increments therein.

In some embodiments, the two or more hulls and the deck weigh about 50 pounds to about 200 pounds. In some embodiments, the two or more hulls and the deck weigh about 50 pounds to about 60 pounds, about 50 pounds to about 70 pounds, about 50 pounds to about 80 pounds, about 50 pounds to about 90 pounds, about 50 pounds to about 100 pounds, about 50 pounds to about 120 pounds, about 50 pounds to about 140 pounds, about 50 pounds to about 160 pounds, about 50 pounds to about 180 pounds, about 50 pounds to about 200 pounds, about 60 pounds to about 70 pounds, about 60 pounds to about 80 pounds, about 60 pounds to about 90 pounds, about 60 pounds to about 100 pounds, about 60 pounds to about 120 pounds, about 60 pounds to about 140 pounds, about 60 pounds to about 160 pounds, about 60 pounds to about 180 pounds, about 60 pounds to about 200 pounds, about 70 pounds to about 80 pounds, about 70 pounds to about 90 pounds, about 70 pounds to about 100 pounds, about 70 pounds to about 120 pounds, about 70 pounds to about 140 pounds, about 70 pounds to about 160 pounds, about 70 pounds to about 180 pounds, about 70 pounds to about 200 pounds, about 80 pounds to about 90 pounds, about 80 pounds to about 100 pounds, about 80 pounds to about 120 pounds, about 80 pounds to about 140 pounds, about 80 pounds to about 160 pounds, about 80 pounds to about 180 pounds, about 80 pounds to about 200 pounds, about 90 pounds to about 100 pounds, about 90 pounds to about 120 pounds, about 90 pounds to about 140 pounds, about 90 pounds to about 160 pounds, about 90 pounds to about 180 pounds, about 90 pounds to about 200 pounds, about 100 pounds to about 120 pounds, about 100 pounds to about 140 pounds, about 100 pounds to about 160 pounds, about 100 pounds to about 180 pounds, about 100 pounds to about 200 pounds, about 120 pounds to about 140 pounds, about 120 pounds to about 160 pounds, about 120 pounds to about 180 pounds, about 120 pounds to about 200 pounds, about 140 pounds to about 160 pounds, about 140 pounds to about 180 pounds, about 140 pounds to about 200 pounds, about 160 pounds to about 180 pounds, about 160 pounds to about 200 pounds, or about 180 pounds to about 200 pounds. In some embodiments, the two or more hulls and the deck weigh about 50 pounds, about 60 pounds, about 70 pounds, about 80 pounds, about 90 pounds, about 100 pounds, about 120 pounds, about 140 pounds, about 160 pounds, about 180 pounds, or about 200 pounds, including increments therein. In some embodiments, the two or more hulls and the deck weigh at least about 50 pounds, about 60 pounds, about 70 pounds, about 80 pounds, about 90 pounds, about 100 pounds, about 120 pounds, about 140 pounds, about 160 pounds, or about 180 pounds, including increments therein. In some embodiments, the two or more hulls and the deck weigh at most about 60 pounds, about 70 pounds, about 80 pounds, about 90 pounds, about 100 pounds, about 120 pounds, about 140 pounds, about 160 pounds, about 180 pounds, or about 200 pounds, including increments therein.

In some embodiments, at least one of the two or more hulls, and the deck are formed of aluminum, steel, stainless steel, carbon fiber, fiberglass, fabric, wood, plastic, or any combination thereof. In some embodiments, the two or more hulls comprise a honeycomb structure. In some embodiments, the unmanned water vehicle further comprises an above-water sensor coupled to one or more of the two or more hulls, the deck, or both. In some embodiments, the above-water sensor comprises an acoustic sensor, a RADAR, a LiDAR, a thermometer, a barometer, a pitot tube, a pH meter, a salinity meter, a conductivity sensor, a depth sensor, wave height sensor, a camera, an infrared camera, an inertial reference system, a magnetic compass, a magnetometer or any combination thereof. In some embodiments, the camera comprises a 360-degree panoramic camera. In some embodiments, the unmanned water vehicle further comprises a storage system to store the sensor data. In some embodiments, the unmanned water vehicle further comprises a retractable sensor apparatus comprising: a winch having a cable; and at least one sensor configured to record a sensor data, the at least one sensor attached to a distal end of the cable.

In some embodiments, the winch has a power of about 0.25 horsepower to about 3 horsepower. In some embodiments, the winch has a power of about 0.25 horsepower to about 0.3 horsepower, about 0.25 horsepower to about 0.35 horsepower, about 0.25 horsepower to about 0.4 horsepower, about 0.25 horsepower to about 0.5 horsepower, about 0.25 horsepower to about 0.6 horsepower, about 0.25 horsepower to about 0.7 horsepower, about 0.25 horsepower to about 0.8 horsepower, about 0.25 horsepower to about 0.9 horsepower, about 0.25 horsepower to about 1 horsepower, about 0.25 horsepower to about 2 horsepower, about 0.25 horsepower to about 3 horsepower, about 0.3 horsepower to about 0.35 horsepower, about 0.3 horsepower to about 0.4 horsepower, about 0.3 horsepower to about 0.5 horsepower, about 0.3 horsepower to about 0.6 horsepower, about 0.3 horsepower to about 0.7 horsepower, about 0.3 horsepower to about 0.8 horsepower, about 0.3 horsepower to about 0.9 horsepower, about 0.3 horsepower to about 1 horsepower, about 0.3 horsepower to about 2 horsepower, about 0.3 horsepower to about 3 horsepower, about 0.35 horsepower to about 0.4 horsepower, about 0.35 horsepower to about 0.5 horsepower, about 0.35 horsepower to about 0.6 horsepower, about 0.35 horsepower to about 0.7 horsepower, about 0.35 horsepower to about 0.8 horsepower, about 0.35 horsepower to about 0.9 horsepower, about 0.35 horsepower to about 1 horsepower, about 0.35 horsepower to about 2 horsepower, about 0.35 horsepower to about 3 horsepower, about 0.4 horsepower to about 0.5 horsepower, about 0.4 horsepower to about 0.6 horsepower, about 0.4 horsepower to about 0.7 horsepower, about 0.4 horsepower to about 0.8 horsepower, about 0.4 horsepower to about 0.9 horsepower, about 0.4 horsepower to about 1 horsepower, about 0.4 horsepower to about 2 horsepower, about 0.4 horsepower to about 3 horsepower, about 0.5 horsepower to about 0.6 horsepower, about 0.5 horsepower to about 0.7 horsepower, about 0.5 horsepower to about 0.8 horsepower, about 0.5 horsepower to about 0.9 horsepower, about 0.5 horsepower to about 1 horsepower, about 0.5 horsepower to about 2 horsepower, about 0.5 horsepower to about 3 horsepower, about 0.6 horsepower to about 0.7 horsepower, about 0.6 horsepower to about 0.8 horsepower, about 0.6 horsepower to about 0.9 horsepower, about 0.6 horsepower to about 1 horsepower, about 0.6 horsepower to about 2 horsepower, about 0.6 horsepower to about 3 horsepower, about 0.7 horsepower to about 0.8 horsepower, about 0.7 horsepower to about 0.9 horsepower, about 0.7 horsepower to about 1 horsepower, about 0.7 horsepower to about 2 horsepower, about 0.7 horsepower to about 3 horsepower, about 0.8 horsepower to about 0.9 horsepower, about 0.8 horsepower to about 1 horsepower, about 0.8 horsepower to about 2 horsepower, about 0.8 horsepower to about 3 horsepower, about 0.9 horsepower to about 1 horsepower, about 0.9 horsepower to about 2 horsepower, about 0.9 horsepower to about 3 horsepower, about 1 horsepower to about 2 horsepower, about 1 horsepower to about 3 horsepower, or about 2 horsepower to about 3 horsepower. In some embodiments, the winch has a power of about 0.25 horsepower, about 0.3 horsepower, about 0.35 horsepower, about 0.4 horsepower, about 0.5 horsepower, about 0.6 horsepower, about 0.7 horsepower, about 0.8 horsepower, about 0.9 horsepower, about 1 horsepower, about 2 horsepower, or about 3 horsepower, including increments therein. In some embodiments, the winch has a power of at least about 0.25 horsepower, about 0.3 horsepower, about 0.35 horsepower, about 0.4 horsepower, about 0.5 horsepower, about 0.6 horsepower, about 0.7 horsepower, about 0.8 horsepower, about 0.9 horsepower, about 1 horsepower, or about 2 horsepower, including increments therein. In some embodiments, the winch has a power of at most about 0.3 horsepower, about 0.35 horsepower, about 0.4 horsepower, about 0.5 horsepower, about 0.6 horsepower, about 0.7 horsepower, about 0.8 horsepower, about 0.9 horsepower, about 1 horsepower, about 2 horsepower, or about 3 horsepower, including increments therein.

In some embodiments, the cable has a length of about 50 m to about 200 m. In some embodiments, the cable has a length of about 50 m to about 60 m, about 50 m to about 70 m, about 50 m to about 80 m, about 50 m to about 90 m, about 50 m to about 100 m, about 50 m to about 120 m, about 50 m to about 140 m, about 50 m to about 160 m, about 50 m to about 180 m, about 50 m to about 200 m, about 60 m to about 70 m, about 60 m to about 80 m, about 60 m to about 90 m, about 60 m to about 100 m, about 60 m to about 120 m, about 60 m to about 140 m, about 60 m to about 160 m, about 60 m to about 180 m, about 60 m to about 200 m, about 70 m to about 80 m, about 70 m to about 90 m, about 70 m to about 100 m, about 70 m to about 120 m, about 70 m to about 140 m, about 70 m to about 160 m, about 70 m to about 180 m, about 70 m to about 200 m, about 80 m to about 90 m, about 80 m to about 100 m, about 80 m to about 120 m, about 80 m to about 140 m, about 80 m to about 160 m, about 80 m to about 180 m, about 80 m to about 200 m, about 90 m to about 100 m, about 90 m to about 120 m, about 90 m to about 140 m, about 90 m to about 160 m, about 90 m to about 180 m, about 90 m to about 200 m, about 100 m to about 120 m, about 100 m to about 140 m, about 100 m to about 160 m, about 100 m to about 180 m, about 100 m to about 200 m, about 120 m to about 140 m, about 120 m to about 160 m, about 120 m to about 180 m, about 120 m to about 200 m, about 140 m to about 160 m, about 140 m to about 180 m, about 140 m to about 200 m, about 160 m to about 180 m, about 160 m to about 200 m, or about 180 m to about 200 m. In some embodiments, the cable has a length of about 50 m, about 60 m, about 70 m, about 80 m, about 90 m, about 100 m, about 120 m, about 140 m, about 160 m, about 180 m, or about 200 m, including increments therein. In some embodiments, the cable has a length of at least about 50 m, about 60 m, about 70 m, about 80 m, about 90 m, about 100 m, about 120 m, about 140 m, about 160 m, or about 180 m, including increments therein. In some embodiments, the cable has a length of at most about 60 m, about 70 m, about 80 m, about 90 m, about 100 m, about 120 m, about 140 m, about 160 m, about 180 m, or about 200 m, including increments therein.

In some embodiments, the unmanned water comprises two or more winches. In some embodiments, the at least one sensor comprises an acoustic sensor, a RADAR, a LiDAR, a thermometer, a barometer, a pitot tube, a pH meter, a salinity meter, a conductivity sensor, a depth sensor, wave height sensor, a camera, an infrared camera, an inertial measurement system, a magnetic compass, a magnetometer or any combination thereof. In some embodiments, the camera comprises a 360-degree panoramic camera. In some embodiments, the wireless communication device transmits the sensor data. In some embodiments, the wireless communications device comprises a Wi-Fi device, a cellular device, a satellite communications systems, an over the horizon RF communications system, or any combination thereof. In some embodiments, the steerable drive apparatus comprises a propeller, a ducted propeller, a propulsor, a rudder, a waterjet, an azimuth drive, or any combination thereof. In some embodiments, the steerable drive apparatus is coupled to the deck, the two or more hulls, or both. In some embodiments, the steerable drive apparatus is coupled to the deck, the two or more hulls, or both via a vertically rotatable coupling. In some embodiments, the vertically rotatable coupling enables at least a portion of the steerable drive apparatus to rotate from a position below one or more of the two or more hulls, to a position above one or more of the two or more hulls. In some embodiments, the rotatable coupling enables the vehicle to be towed on a standard trailer. In some embodiments, each of the two or more hulls comprises a lifting point. In some embodiments, the steerable drive apparatus comprises an electric, hydraulic, pneumatic, ocean-assisted, or servo-steerable drive apparatus.

In some embodiments, the steerable drive apparatus operates on a current of about 200 amps to about 800 amps. In some embodiments, the steerable drive apparatus operates on a current of about 200 amps to about 250 amps, about 200 amps to about 300 amps, about 200 amps to about 350 amps, about 200 amps to about 400 amps, about 200 amps to about 450 amps, about 200 amps to about 500 amps, about 200 amps to about 550 amps, about 200 amps to about 600 amps, about 200 amps to about 700 amps, about 200 amps to about 800 amps, about 250 amps to about 300 amps, about 250 amps to about 350 amps, about 250 amps to about 400 amps, about 250 amps to about 450 amps, about 250 amps to about 500 amps, about 250 amps to about 550 amps, about 250 amps to about 600 amps, about 250 amps to about 700 amps, about 250 amps to about 800 amps, about 300 amps to about 350 amps, about 300 amps to about 400 amps, about 300 amps to about 450 amps, about 300 amps to about 500 amps, about 300 amps to about 550 amps, about 300 amps to about 600 amps, about 300 amps to about 700 amps, about 300 amps to about 800 amps, about 350 amps to about 400 amps, about 350 amps to about 450 amps, about 350 amps to about 500 amps, about 350 amps to about 550 amps, about 350 amps to about 600 amps, about 350 amps to about 700 amps, about 350 amps to about 800 amps, about 400 amps to about 450 amps, about 400 amps to about 500 amps, about 400 amps to about 550 amps, about 400 amps to about 600 amps, about 400 amps to about 700 amps, about 400 amps to about 800 amps, about 450 amps to about 500 amps, about 450 amps to about 550 amps, about 450 amps to about 600 amps, about 450 amps to about 700 amps, about 450 amps to about 800 amps, about 500 amps to about 550 amps, about 500 amps to about 600 amps, about 500 amps to about 700 amps, about 500 amps to about 800 amps, about 550 amps to about 600 amps, about 550 amps to about 700 amps, about 550 amps to about 800 amps, about 600 amps to about 700 amps, about 600 amps to about 800 amps, or about 700 amps to about 800 amps. In some embodiments, the steerable drive apparatus operates on a current of about 200 amps, about 250 amps, about 300 amps, about 350 amps, about 400 amps, about 450 amps, about 500 amps, about 550 amps, about 600 amps, about 700 amps, or about 800 amps, including increments therein. In some embodiments, the steerable drive apparatus operates on a current of at least about 200 amps, about 250 amps, about 300 amps, about 350 amps, about 400 amps, about 450 amps, about 500 amps, about 550 amps, about 600 amps, or about 700 amps, including increments therein. In some embodiments, the steerable drive apparatus operates on a current of at most about 250 amps, about 300 amps, about 350 amps, about 400 amps, about 450 amps, about 500 amps, about 550 amps, about 600 amps, about 700 amps, or about 800 amps, including increments therein.

In some embodiments, the steerable drive apparatus requires a power of about 1,000 W to about 5,000 W. In some embodiments, the steerable drive apparatus requires a power of about 1,000 W to about 1,500 W, about 1,000 W to about 2,000 W, about 1,000 W to about 2,500 W, about 1,000 W to about 3,000 W, about 1,000 W to about 3,500 W, about 1,000 W to about 4,000 W, about 1,000 W to about 4,500 W, about 1,000 W to about 5,000 W, about 1,500 W to about 2,000 W, about 1,500 W to about 2,500 W, about 1,500 W to about 3,000 W, about 1,500 W to about 3,500 W, about 1,500 W to about 4,000 W, about 1,500 W to about 4,500 W, about 1,500 W to about 5,000 W, about 2,000 W to about 2,500 W, about 2,000 W to about 3,000 W, about 2,000 W to about 3,500 W, about 2,000 W to about 4,000 W, about 2,000 W to about 4,500 W, about 2,000 W to about 5,000 W, about 2,500 W to about 3,000 W, about 2,500 W to about 3,500 W, about 2,500 W to about 4,000 W, about 2,500 W to about 4,500 W, about 2,500 W to about 5,000 W, about 3,000 W to about 3,500 W, about 3,000 W to about 4,000 W, about 3,000 W to about 4,500 W, about 3,000 W to about 5,000 W, about 3,500 W to about 4,000 W, about 3,500 W to about 4,500 W, about 3,500 W to about 5,000 W, about 4,000 W to about 4,500 W, about 4,000 W to about 5,000 W, or about 4,500 W to about 5,000 W. In some embodiments, the steerable drive apparatus requires a power of about 1,000 W, about 1,500 W, about 2,000 W, about 2,500 W, about 3,000 W, about 3,500 W, about 4,000 W, about 4,500 W, or about 5,000 W, including increments therein. In some embodiments, the steerable drive apparatus requires a power of at least about 1,000 W, about 1,500 W, about 2,000 W, about 2,500 W, about 3,000 W, about 3,500 W, about 4,000 W, or about 4,500 W, including increments therein. In some embodiments, the steerable drive apparatus requires a power of at most about 1,500 W, about 2,000 W, about 2,500 W, about 3,000 W, about 3,500 W, about 4,000 W, about 4,500 W, or about 5,000 W, including increments therein.

In some embodiments, the steerable drive apparatus outputs a power at a speed of 1 knot of about 150 W to about 1,600 W. In some embodiments, the steerable drive apparatus outputs a power at a speed of 1 knot of about 150 W to about 300 W, about 150 W to about 450 W, about 150 W to about 600 W, about 150 W to about 750 W, about 150 W to about 900 W, about 150 W to about 1,050 W, about 150 W to about 1,200 W, about 150 W to about 1,350 W, about 150 W to about 1,500 W, about 150 W to about 1,600 W, about 300 W to about 450 W, about 300 W to about 600 W, about 300 W to about 750 W, about 300 W to about 900 W, about 300 W to about 1,050 W, about 300 W to about 1,200 W, about 300 W to about 1,350 W, about 300 W to about 1,500 W, about 300 W to about 1,600 W, about 450 W to about 600 W, about 450 W to about 750 W, about 450 W to about 900 W, about 450 W to about 1,050 W, about 450 W to about 1,200 W, about 450 W to about 1,350 W, about 450 W to about 1,500 W, about 450 W to about 1,600 W, about 600 W to about 750 W, about 600 W to about 900 W, about 600 W to about 1,050 W, about 600 W to about 1,200 W, about 600 W to about 1,350 W, about 600 W to about 1,500 W, about 600 W to about 1,600 W, about 750 W to about 900 W, about 750 W to about 1,050 W, about 750 W to about 1,200 W, about 750 W to about 1,350 W, about 750 W to about 1,500 W, about 750 W to about 1,600 W, about 900 W to about 1,050 W, about 900 W to about 1,200 W, about 900 W to about 1,350 W, about 900 W to about 1,500 W, about 900 W to about 1,600 W, about 1,050 W to about 1,200 W, about 1,050 W to about 1,350 W, about 1,050 W to about 1,500 W, about 1,050 W to about 1,600 W, about 1,200 W to about 1,350 W, about 1,200 W to about 1,500 W, about 1,200 W to about 1,600 W, about 1,350 W to about 1,500 W, about 1,350 W to about 1,600 W, or about 1,500 W to about 1,600 W. In some embodiments, the steerable drive apparatus outputs a power at a speed of 1 knot of about 150 W, about 300 W, about 450 W, about 600 W, about 750 W, about 900 W, about 1,050 W, about 1,200 W, about 1,350 W, about 1,500 W, or about 1,600 W, including increments therein. In some embodiments, the steerable drive apparatus outputs a power at a speed of 1 knot of at least about 150 W, about 300 W, about 450 W, about 600 W, about 750 W, about 900 W, about 1,050 W, about 1,200 W, about 1,350 W, or about 1,500 W, including increments therein. In some embodiments, the steerable drive apparatus outputs a power at a speed of 1 knot of at most about 300 W, about 450 W, about 600 W, about 750 W, about 900 W, about 1,050 W, about 1,200 W, about 1,350 W, about 1,500 W, or about 1,600 W, including increments therein.

In some embodiments, the steerable drive apparatus has a power efficiency of about 40% to about 80%. In some embodiments, the steerable drive apparatus has a power efficiency of about 40% to about 45%, about 40% to about 50%, about 40% to about 55%, about 40% to about 60%, about 40% to about 65%, about 40% to about 70%, about 40% to about 75%, about 40% to about 80%, about 45% to about 50%, about 45% to about 55%, about 45% to about 60%, about 45% to about 65%, about 45% to about 70%, about 45% to about 75%, about 45% to about 80%, about 50% to about 55%, about 50% to about 60%, about 50% to about 65%, about 50% to about 70%, about 50% to about 75%, about 50% to about 80%, about 55% to about 60%, about 55% to about 65%, about 55% to about 70%, about 55% to about 75%, about 55% to about 80%, about 60% to about 65%, about 60% to about 70%, about 60% to about 75%, about 60% to about 80%, about 65% to about 70%, about 65% to about 75%, about 65% to about 80%, about 70% to about 75%, about 70% to about 80%, or about 75% to about 80%. In some embodiments, the steerable drive apparatus has a power efficiency of about 40%, about 45%, about 50%, about 55%, about 60%, about 65%, about 70%, about 75%, or about 80%, including increments therein. In some embodiments, the steerable drive apparatus has a power efficiency of at least about 40%, about 45%, about 50%, about 55%, about 60%, about 65%, about 70%, or about 75%, including increments therein. In some embodiments, the steerable drive apparatus has a power efficiency of at most about 45%, about 50%, about 55%, about 60%, about 65%, about 70%, about 75%, or about 80%, including increments therein.

In some embodiments, the steerable drive apparatus requires a voltage of about 20 V to about 100 V. In some embodiments, the steerable drive apparatus requires a voltage of about 20 V to about 30 V, about 20 V to about 40 V, about 20 V to about 50 V, about 20 V to about 60 V, about 20 V to about 70 V, about 20 V to about 80 V, about 20 V to about 90 V, about 20 V to about 100 V, about 30 V to about 40 V, about 30 V to about 50 V, about 30 V to about 60 V, about 30 V to about 70 V, about 30 V to about 80 V, about 30 V to about 90 V, about 30 V to about 100 V, about 40 V to about 50 V, about 40 V to about 60 V, about 40 V to about 70 V, about 40 V to about 80 V, about 40 V to about 90 V, about 40 V to about 100 V, about 50 V to about 60 V, about 50 V to about 70 V, about 50 V to about 80 V, about 50 V to about 90 V, about 50 V to about 100 V, about 60 V to about 70 V, about 60 V to about 80 V, about 60 V to about 90 V, about 60 V to about 100 V, about 70 V to about 80 V, about 70 V to about 90 V, about 70 V to about 100 V, about 80 V to about 90 V, about 80 V to about 100 V, or about 90 V to about 100 V. In some embodiments, the steerable drive apparatus requires a voltage of about 20 V, about 30 V, about 40 V, about 50 V, about 60 V, about 70 V, about 80 V, about 90 V, or about 100 V, including increments therein. In some embodiments, the steerable drive apparatus requires a voltage of at least about 20 V, about 30 V, about 40 V, about 50 V, about 60 V, about 70 V, about 80 V, or about 90 V, including increments therein. In some embodiments, the steerable drive apparatus requires a voltage of at most about 30 V, about 40 V, about 50 V, about 60 V, about 70 V, about 80 V, about 90 V, or about 100 V, including increments therein.

In some embodiments, the steerable drive apparatus produces a thrust of about 90 pounds to about 380 pounds. In some embodiments, the steerable drive apparatus produces a thrust of about 90 pounds to about 120 pounds, about 90 pounds to about 150 pounds, about 90 pounds to about 180 pounds, about 90 pounds to about 200 pounds, about 90 pounds to about 230 pounds, about 90 pounds to about 260 pounds, about 90 pounds to about 290 pounds, about 90 pounds to about 310 pounds, about 90 pounds to about 330 pounds, about 90 pounds to about 380 pounds, about 120 pounds to about 150 pounds, about 120 pounds to about 180 pounds, about 120 pounds to about 200 pounds, about 120 pounds to about 230 pounds, about 120 pounds to about 260 pounds, about 120 pounds to about 290 pounds, about 120 pounds to about 310 pounds, about 120 pounds to about 330 pounds, about 120 pounds to about 380 pounds, about 150 pounds to about 180 pounds, about 150 pounds to about 200 pounds, about 150 pounds to about 230 pounds, about 150 pounds to about 260 pounds, about 150 pounds to about 290 pounds, about 150 pounds to about 310 pounds, about 150 pounds to about 330 pounds, about 150 pounds to about 380 pounds, about 180 pounds to about 200 pounds, about 180 pounds to about 230 pounds, about 180 pounds to about 260 pounds, about 180 pounds to about 290 pounds, about 180 pounds to about 310 pounds, about 180 pounds to about 330 pounds, about 180 pounds to about 380 pounds, about 200 pounds to about 230 pounds, about 200 pounds to about 260 pounds, about 200 pounds to about 290 pounds, about 200 pounds to about 310 pounds, about 200 pounds to about 330 pounds, about 200 pounds to about 380 pounds, about 230 pounds to about 260 pounds, about 230 pounds to about 290 pounds, about 230 pounds to about 310 pounds, about 230 pounds to about 330 pounds, about 230 pounds to about 380 pounds, about 260 pounds to about 290 pounds, about 260 pounds to about 310 pounds, about 260 pounds to about 330 pounds, about 260 pounds to about 380 pounds, about 290 pounds to about 310 pounds, about 290 pounds to about 330 pounds, about 290 pounds to about 380 pounds, about 310 pounds to about 330 pounds, about 310 pounds to about 380 pounds, or about 330 pounds to about 380 pounds. In some embodiments, the steerable drive apparatus produces a thrust of about 90 pounds, about 120 pounds, about 150 pounds, about 180 pounds, about 200 pounds, about 230 pounds, about 260 pounds, about 290 pounds, about 310 pounds, about 330 pounds, or about 380 pounds, including increments therein. In some embodiments, the steerable drive apparatus produces a thrust of at least about 90 pounds, about 120 pounds, about 150 pounds, about 180 pounds, about 200 pounds, about 230 pounds, about 260 pounds, about 290 pounds, about 310 pounds, or about 330 pounds, including increments therein. In some embodiments, the steerable drive apparatus produces a thrust of at most about 120 pounds, about 150 pounds, about 180 pounds, about 200 pounds, about 230 pounds, about 260 pounds, about 290 pounds, about 310 pounds, about 330 pounds, or about 380 pounds, including increments therein.

In some embodiments, the steerable drive apparatus produces a thrust of about 4 horsepower to about 50 horsepower. In some embodiments, the steerable drive apparatus produces a thrust of about 4 horsepower to about 6 horsepower, about 4 horsepower to about 8 horsepower, about 4 horsepower to about 10 horsepower, about 4 horsepower to about 15 horsepower, about 4 horsepower to about 20 horsepower, about 4 horsepower to about 25 horsepower, about 4 horsepower to about 30 horsepower, about 4 horsepower to about 35 horsepower, about 4 horsepower to about 40 horsepower, about 4 horsepower to about 50 horsepower, about 6 horsepower to about 8 horsepower, about 6 horsepower to about 10 horsepower, about 6 horsepower to about 15 horsepower, about 6 horsepower to about 20 horsepower, about 6 horsepower to about 25 horsepower, about 6 horsepower to about 30 horsepower, about 6 horsepower to about 35 horsepower, about 6 horsepower to about 40 horsepower, about 6 horsepower to about 50 horsepower, about 8 horsepower to about 10 horsepower, about 8 horsepower to about 15 horsepower, about 8 horsepower to about 20 horsepower, about 8 horsepower to about 25 horsepower, about 8 horsepower to about 30 horsepower, about 8 horsepower to about 35 horsepower, about 8 horsepower to about 40 horsepower, about 8 horsepower to about 50 horsepower, about 10 horsepower to about 15 horsepower, about 10 horsepower to about 20 horsepower, about 10 horsepower to about 25 horsepower, about 10 horsepower to about 30 horsepower, about 10 horsepower to about 35 horsepower, about 10 horsepower to about 40 horsepower, about 10 horsepower to about 50 horsepower, about 15 horsepower to about 20 horsepower, about 15 horsepower to about 25 horsepower, about 15 horsepower to about 30 horsepower, about 15 horsepower to about 35 horsepower, about 15 horsepower to about 40 horsepower, about 15 horsepower to about 50 horsepower, about 20 horsepower to about 25 horsepower, about 20 horsepower to about 30 horsepower, about 20 horsepower to about 35 horsepower, about 20 horsepower to about 40 horsepower, about 20 horsepower to about 50 horsepower, about 25 horsepower to about 30 horsepower, about 25 horsepower to about 35 horsepower, about 25 horsepower to about 40 horsepower, about 25 horsepower to about 50 horsepower, about 30 horsepower to about 35 horsepower, about 30 horsepower to about 40 horsepower, about 30 horsepower to about 50 horsepower, about 35 horsepower to about 40 horsepower, about 35 horsepower to about 50 horsepower, or about 40 horsepower to about 50 horsepower, including increments therein. In some embodiments, the steerable drive apparatus produces a thrust of about 4 horsepower, about 6 horsepower, about 8 horsepower, about 10 horsepower, about 15 horsepower, about 20 horsepower, about 25 horsepower, about 30 horsepower, about 35 horsepower, about 40 horsepower, or about 50 horsepower. In some embodiments, the steerable drive apparatus produces a thrust of at least about 4 horsepower, about 6 horsepower, about 8 horsepower, about 10 horsepower, about 15 horsepower, about 20 horsepower, about 25 horsepower, about 30 horsepower, about 35 horsepower, or about 40 horsepower, including increments therein. In some embodiments, the steerable drive apparatus produces a thrust of at most about 6 horsepower, about 8 horsepower, about 10 horsepower, about 15 horsepower, about 20 horsepower, about 25 horsepower, about 30 horsepower, about 35 horsepower, about 40 horsepower, or about 50 horsepower, including increments therein.

In some embodiments, the unmanned water vehicle comprises two or more steerable drive apparatus. In some embodiments, the unmanned water vehicle further comprises one or more non-steerable drive apparatus. In some embodiments, the mobility and control module commands the steerable drive apparatus, the non-steerable drive apparatus, or both based on a heading, a position, or both. In some embodiments, the command comprises a direction, a speed, or both. In some embodiments, the mobility and control module comprises a Real-Time Kinematic GPS, a gyrocompass, a magnetic compass, or any combination thereof. In some embodiments, the mobility and control module operates the unmanned water vehicle in the remote piloted mode via a command received by the wireless communication device. In some embodiments, the wireless communication device receives the command from a handheld remote control, a fixed remote control, or both In some embodiments, the command comprises a waypoint, a speed, a heading, a thrust output, a motor position, a motor differential thrust, or any combination thereof. In some embodiments, the mobility and control module commands the winch to retract the cable and extend the cable. In some embodiments, the mobility and control module commands the winch to retract the cable by a retraction distance. In some embodiments, the mobility and control module commands the winch to extend the cable by an extension distance. In some embodiments, operation of the unmanned water vehicle in at least one of the semi-autonomous mode and the fully autonomous mode comprises automatic obstacle avoidance.

In some embodiments, a total surface area of the one or more solar panels is about 45 sq. ft. to about 180 sq. ft. In some embodiments, a total surface area of the one or more solar panels is about 45 sq. ft. to about 50 sq. ft., about 45 sq. ft. to about 60 sq. ft., about 45 sq. ft. to about 70 sq. ft., about 45 sq. ft. to about 80 sq. ft., about 45 sq. ft. to about 90 sq. ft., about 45 sq. ft. to about 100 sq. ft., about 45 sq. ft. to about 120 sq. ft., about 45 sq. ft. to about 140 sq. ft., about 45 sq. ft. to about 160 sq. ft., about 45 sq. ft. to about 180 sq. ft., about 50 sq. ft. to about 60 sq. ft., about 50 sq. ft. to about 70 sq. ft., about 50 sq. ft. to about 80 sq. ft., about 50 sq. ft. to about 90 sq. ft., about 50 sq. ft. to about 100 sq. ft., about 50 sq. ft. to about 120 sq. ft., about 50 sq. ft. to about 140 sq. ft., about 50 sq. ft. to about 160 sq. ft., about 50 sq. ft. to about 180 sq. ft., about 60 sq. ft. to about 70 sq. ft., about 60 sq. ft. to about 80 sq. ft., about 60 sq. ft. to about 90 sq. ft., about 60 sq. ft. to about 100 sq. ft., about 60 sq. ft. to about 120 sq. ft., about 60 sq. ft. to about 140 sq. ft., about 60 sq. ft. to about 160 sq. ft., about 60 sq. ft. to about 180 sq. ft., about 70 sq. ft. to about 80 sq. ft., about 70 sq. ft. to about 90 sq. ft., about 70 sq. ft. to about 100 sq. ft., about 70 sq. ft. to about 120 sq. ft., about 70 sq. ft. to about 140 sq. ft., about 70 sq. ft. to about 160 sq. ft., about 70 sq. ft. to about 180 sq. ft., about 80 sq. ft. to about 90 sq. ft., about 80 sq. ft. to about 100 sq. ft., about 80 sq. ft. to about 120 sq. ft., about 80 sq. ft. to about 140 sq. ft., about 80 sq. ft. to about 160 sq. ft., about 80 sq. ft. to about 180 sq. ft., about 90 sq. ft. to about 100 sq. ft., about 90 sq. ft. to about 120 sq. ft., about 90 sq. ft. to about 140 sq. ft., about 90 sq. ft. to about 160 sq. ft., about 90 sq. ft. to about 180 sq. ft., about 100 sq. ft. to about 120 sq. ft., about 100 sq. ft. to about 140 sq. ft., about 100 sq. ft. to about 160 sq. ft., about 100 sq. ft. to about 180 sq. ft., about 120 sq. ft. to about 140 sq. ft., about 120 sq. ft. to about 160 sq. ft., about 120 sq. ft. to about 180 sq. ft., about 140 sq. ft. to about 160 sq. ft., about 140 sq. ft. to about 180 sq. ft., or about 160 sq. ft. to about 180 sq. ft. In some embodiments, a total surface area of the one or more solar panels is about 45 sq. ft., about 50 sq. ft., about 60 sq. ft., about 70 sq. ft., about 80 sq. ft., about 90 sq. ft., about 100 sq. ft., about 120 sq. ft., about 140 sq. ft., about 160 sq. ft., or about 180 sq. ft., including increments therein. In some embodiments, a total surface area of the one or more solar panels is at least about 45 sq. ft., about 50 sq. ft., about 60 sq. ft., about 70 sq. ft., about 80 sq. ft., about 90 sq. ft., about 100 sq. ft., about 120 sq. ft., about 140 sq. ft., or about 160 sq. ft., including increments therein. In some embodiments, a total surface area of the one or more solar panels is at most about 50 sq. ft., about 60 sq. ft., about 70 sq. ft., about 80 sq. ft., about 90 sq. ft., about 100 sq. ft., about 120 sq. ft., about 140 sq. ft., about 160 sq. ft., or about 180 sq. ft., including increments therein.

In some embodiments, the one or more solar panels have a total power of about 700 W to about 2,800 W. In some embodiments, the one or more solar panels have a total power of about 700 W to about 800 W, about 700 W to about 900 W, about 700 W to about 1,000 W, about 700 W to about 1,200 W, about 700 W to about 1,400 W, about 700 W to about 1,600 W, about 700 W to about 1,800 W, about 700 W to about 2,000 W, about 700 W to about 2,400 W, about 700 W to about 2,800 W, about 800 W to about 900 W, about 800 W to about 1,000 W, about 800 W to about 1,200 W, about 800 W to about 1,400 W, about 800 W to about 1,600 W, about 800 W to about 1,800 W, about 800 W to about 2,000 W, about 800 W to about 2,400 W, about 800 W to about 2,800 W, about 900 W to about 1,000 W, about 900 W to about 1,200 W, about 900 W to about 1,400 W, about 900 W to about 1,600 W, about 900 W to about 1,800 W, about 900 W to about 2,000 W, about 900 W to about 2,400 W, about 900 W to about 2,800 W, about 1,000 W to about 1,200 W, about 1,000 W to about 1,400 W, about 1,000 W to about 1,600 W, about 1,000 W to about 1,800 W, about 1,000 W to about 2,000 W, about 1,000 W to about 2,400 W, about 1,000 W to about 2,800 W, about 1,200 W to about 1,400 W, about 1,200 W to about 1,600 W, about 1,200 W to about 1,800 W, about 1,200 W to about 2,000 W, about 1,200 W to about 2,400 W, about 1,200 W to about 2,800 W, about 1,400 W to about 1,600 W, about 1,400 W to about 1,800 W, about 1,400 W to about 2,000 W, about 1,400 W to about 2,400 W, about 1,400 W to about 2,800 W, about 1,600 W to about 1,800 W, about 1,600 W to about 2,000 W, about 1,600 W to about 2,400 W, about 1,600 W to about 2,800 W, about 1,800 W to about 2,000 W, about 1,800 W to about 2,400 W, about 1,800 W to about 2,800 W, about 2,000 W to about 2,400 W, about 2,000 W to about 2,800 W, or about 2,400 W to about 2,800 W. In some embodiments, the one or more solar panels have a total power of about 700 W, about 800 W, about 900 W, about 1,000 W, about 1,200 W, about 1,400 W, about 1,600 W, about 1,800 W, about 2,000 W, about 2,400 W, or about 2,800 W, including increments therein. In some embodiments, the one or more solar panels have a total power of at least about 700 W, about 800 W, about 900 W, about 1,000 W, about 1,200 W, about 1,400 W, about 1,600 W, about 1,800 W, about 2,000 W, or about 2,400 W, including increments therein. In some embodiments, the one or more solar panels have a total power of at most about 800 W, about 900 W, about 1,000 W, about 1,200 W, about 1,400 W, about 1,600 W, about 1,800 W, about 2,000 W, about 2,400 W, or about 2,800 W, including increments therein.

In some embodiments, the unmanned water vehicle further comprises a solar controller regulating the charging of the one or more solar panels.

In some embodiments, the solar controller regulates the voltage output of the one or more panels to about 25 V DC to about 100 V DC. In some embodiments, the solar controller regulates the voltage output of the one or more panels to about 25 V DC to about 30 V DC, about 25 V DC to about 35 V DC, about 25 V DC to about 40 V DC, about 25 V DC to about 45 V DC, about 25 V DC to about 50 V DC, about 25 V DC to about 55 V DC, about 25 V DC to about 60 V DC, about 25 V DC to about 70 V DC, about 25 V DC to about 80 V DC, about 25 V DC to about 90 V DC, about 25 V DC to about 100 V DC, about 30 V DC to about 35 V DC, about 30 V DC to about 40 V DC, about 30 V DC to about 45 V DC, about 30 V DC to about 50 V DC, about 30 V DC to about 55 V DC, about 30 V DC to about 60 V DC, about 30 V DC to about 70 V DC, about 30 V DC to about 80 V DC, about 30 V DC to about 90 V DC, about 30 V DC to about 100 V DC, about 35 V DC to about 40 V DC, about 35 V DC to about 45 V DC, about 35 V DC to about 50 V DC, about 35 V DC to about 55 V DC, about 35 V DC to about 60 V DC, about 35 V DC to about 70 V DC, about 35 V DC to about 80 V DC, about 35 V DC to about 90 V DC, about 35 V DC to about 100 V DC, about 40 V DC to about 45 V DC, about 40 V DC to about 50 V DC, about 40 V DC to about 55 V DC, about 40 V DC to about 60 V DC, about 40 V DC to about 70 V DC, about 40 V DC to about 80 V DC, about 40 V DC to about 90 V DC, about 40 V DC to about 100 V DC, about 45 V DC to about 50 V DC, about 45 V DC to about 55 V DC, about 45 V DC to about 60 V DC, about 45 V DC to about 70 V DC, about 45 V DC to about 80 V DC, about 45 V DC to about 90 V DC, about 45 V DC to about 100 V DC, about 50 V DC to about 55 V DC, about 50 V DC to about 60 V DC, about 50 V DC to about 70 V DC, about 50 V DC to about 80 V DC, about 50 V DC to about 90 V DC, about 50 V DC to about 100 V DC, about 55 V DC to about 60 V DC, about 55 V DC to about 70 V DC, about 55 V DC to about 80 V DC, about 55 V DC to about 90 V DC, about 55 V DC to about 100 V DC, about 60 V DC to about 70 V DC, about 60 V DC to about 80 V DC, about 60 V DC to about 90 V DC, about 60 V DC to about 100 V DC, about 70 V DC to about 80 V DC, about 70 V DC to about 90 V DC, about 70 V DC to about 100 V DC, about 80 V DC to about 90 V DC, about 80 V DC to about 100 V DC, or about 90 V DC to about 100 V DC. In some embodiments, the solar controller regulates the voltage output of the one or more panels to about 25 V DC, about 30 V DC, about 35 V DC, about 40 V DC, about 45 V DC, about 50 V DC, about 55 V DC, about 60 V DC, about 70 V DC, about 80 V DC, about 90 V DC, or about 100 V DC, including increments therein. In some embodiments, the solar controller regulates the voltage output of the one or more panels to at least about 25 V DC, about 30 V DC, about 35 V DC, about 40 V DC, about 45 V DC, about 50 V DC, about 55 V DC, about 60 V DC, about 70 V DC, about 80 V DC, or about 90 V DC, including increments therein. In some embodiments, the solar controller regulates the voltage output of the one or more panels to at most about 30 V DC, about 35 V DC, about 40 V DC, about 45 V DC, about 50 V DC, about 55 V DC, about 60 V DC, about 70 V DC, about 80 V DC, about 90 V DC, or about 100 V DC, including increments therein.

In some embodiments, the solar controller regulates the current output of the one or more panels to about 4 A to about 16 A. In some embodiments, the solar controller regulates the current output of the one or more panels to about 4 A to about 5 A, about 4 A to about 6 A, about 4 A to about 7 A, about 4 A to about 8 A, about 4 A to about 9 A, about 4 A to about 10 A, about 4 A to about 11 A, about 4 A to about 12 A, about 4 A to about 13 A, about 4 A to about 14 A, about 4 A to about 16 A, about 5 A to about 6 A, about 5 A to about 7 A, about 5 A to about 8 A, about 5 A to about 9 A, about 5 A to about 10 A, about 5 A to about 11 A, about 5 A to about 12 A, about 5 A to about 13 A, about 5 A to about 14 A, about 5 A to about 16 A, about 6 A to about 7 A, about 6 A to about 8 A, about 6 A to about 9 A, about 6 A to about 10 A, about 6 A to about 11 A, about 6 A to about 12 A, about 6 A to about 13 A, about 6 A to about 14 A, about 6 A to about 16 A, about 7 A to about 8 A, about 7 A to about 9 A, about 7 A to about 10 A, about 7 A to about 11 A, about 7 A to about 12 A, about 7 A to about 13 A, about 7 A to about 14 A, about 7 A to about 16 A, about 8 A to about 9 A, about 8 A to about 10 A, about 8 A to about 11 A, about 8 A to about 12 A, about 8 A to about 13 A, about 8 A to about 14 A, about 8 A to about 16 A, about 9 A to about 10 A, about 9 A to about 11 A, about 9 A to about 12 A, about 9 A to about 13 A, about 9 A to about 14 A, about 9 A to about 16 A, about 10 A to about 11 A, about 10 A to about 12 A, about 10 A to about 13 A, about 10 A to about 14 A, about 10 A to about 16 A, about 11 A to about 12 A, about 11 A to about 13 A, about 11 A to about 14 A, about 11 A to about 16 A, about 12 A to about 13 A, about 12 A to about 14 A, about 12 A to about 16 A, about 13 A to about 14 A, about 13 A to about 16 A, or about 14 A to about 16 A. In some embodiments, the solar controller regulates the current output of the one or more panels to about 4 A, about 5 A, about 6 A, about 7 A, about 8 A, about 9 A, about 10 A, about 11 A, about 12 A, about 13 A, about 14 A, or about 16 A, including increments therein. In some embodiments, the solar controller regulates the current output of the one or more panels to at least about 4 A, about 5 A, about 6 A, about 7 A, about 8 A, about 9 A, about 10 A, about 11 A, about 12 A, about 13 A, or about 14 A. In some embodiments, the solar controller regulates the current output of the one or more panels to at most about 5 A, about 6 A, about 7 A, about 8 A, about 9 A, about 10 A, about 11 A, about 12 A, about 13 A, about 14 A, or about 16 A, including increments therein.

In some embodiments, the unmanned water vehicle comprises 10 solar panels.

In some embodiments, each solar panel has a surface area of about 4 sq. ft. to about 18 sq. ft. In some embodiments, each solar panel has a surface area of about 4 sq. ft. to about 5 sq. ft., about 4 sq. ft. to about 6 sq. ft., about 4 sq. ft. to about 7 sq. ft., about 4 sq. ft. to about 8 sq. ft., about 4 sq. ft. to about 9 sq. ft., about 4 sq. ft. to about 10 sq. ft., about 4 sq. ft. to about 12 sq. ft., about 4 sq. ft. to about 14 sq. ft., about 4 sq. ft. to about 16 sq. ft., about 4 sq. ft. to about 18 sq. ft., about 5 sq. ft. to about 6 sq. ft., about 5 sq. ft. to about 7 sq. ft., about 5 sq. ft. to about 8 sq. ft., about 5 sq. ft. to about 9 sq. ft., about 5 sq. ft. to about 10 sq. ft., about 5 sq. ft. to about 12 sq. ft., about 5 sq. ft. to about 14 sq. ft., about 5 sq. ft. to about 16 sq. ft., about 5 sq. ft. to about 18 sq. ft., about 6 sq. ft. to about 7 sq. ft., about 6 sq. ft. to about 8 sq. ft., about 6 sq. ft. to about 9 sq. ft., about 6 sq. ft. to about 10 sq. ft., about 6 sq. ft. to about 12 sq. ft., about 6 sq. ft. to about 14 sq. ft., about 6 sq. ft. to about 16 sq. ft., about 6 sq. ft. to about 18 sq. ft., about 7 sq. ft. to about 8 sq. ft., about 7 sq. ft. to about 9 sq. ft., about 7 sq. ft. to about 10 sq. ft., about 7 sq. ft. to about 12 sq. ft., about 7 sq. ft. to about 14 sq. ft., about 7 sq. ft. to about 16 sq. ft., about 7 sq. ft. to about 18 sq. ft., about 8 sq. ft. to about 9 sq. ft., about 8 sq. ft. to about 10 sq. ft., about 8 sq. ft. to about 12 sq. ft., about 8 sq. ft. to about 14 sq. ft., about 8 sq. ft. to about 16 sq. ft., about 8 sq. ft. to about 18 sq. ft., about 9 sq. ft. to about 10 sq. ft., about 9 sq. ft. to about 12 sq. ft., about 9 sq. ft. to about 14 sq. ft., about 9 sq. ft. to about 16 sq. ft., about 9 sq. ft. to about 18 sq. ft., about 10 sq. ft. to about 12 sq. ft., about 10 sq. ft. to about 14 sq. ft., about 10 sq. ft. to about 16 sq. ft., about 10 sq. ft. to about 18 sq. ft., about 12 sq. ft. to about 14 sq. ft., about 12 sq. ft. to about 16 sq. ft., about 12 sq. ft. to about 18 sq. ft., about 14 sq. ft. to about 16 sq. ft., about 14 sq. ft. to about 18 sq. ft., or about 16 sq. ft. to about 18 sq. ft. In some embodiments, each solar panel has a surface area of about 4 sq. ft., about 5 sq. ft., about 6 sq. ft., about 7 sq. ft., about 8 sq. ft., about 9 sq. ft., about 10 sq. ft., about 12 sq. ft., about 14 sq. ft., about 16 sq. ft., or about 18 sq. ft., including increments therein. In some embodiments, each solar panel has a surface area of at least about 4 sq. ft., about 5 sq. ft., about 6 sq. ft., about 7 sq. ft., about 8 sq. ft., about 9 sq. ft., about 10 sq. ft., about 12 sq. ft., about 14 sq. ft., or about 16 sq. ft., including increments therein. In some embodiments, each solar panel has a surface area of at most about 5 sq. ft., about 6 sq. ft., about 7 sq. ft., about 8 sq. ft., about 9 sq. ft., about 10 sq. ft., about 12 sq. ft., about 14 sq. ft., about 16 sq. ft., or about 18 sq. ft., including increments therein.

In some embodiments, each solar panel has a power of about 60 W to about 300 W. In some embodiments, each solar panel has a power of about 60 W to about 80 W, about 60 W to about 100 W, about 60 W to about 120 W, about 60 W to about 140 W, about 60 W to about 160 W, about 60 W to about 180 W, about 60 W to about 200 W, about 60 W to about 220 W, about 60 W to about 240 W, about 60 W to about 260 W, about 60 W to about 300 W, about 80 W to about 100 W, about 80 W to about 120 W, about 80 W to about 140 W, about 80 W to about 160 W, about 80 W to about 180 W, about 80 W to about 200 W, about 80 W to about 220 W, about 80 W to about 240 W, about 80 W to about 260 W, about 80 W to about 300 W, about 100 W to about 120 W, about 100 W to about 140 W, about 100 W to about 160 W, about 100 W to about 180 W, about 100 W to about 200 W, about 100 W to about 220 W, about 100 W to about 240 W, about 100 W to about 260 W, about 100 W to about 300 W, about 120 W to about 140 W, about 120 W to about 160 W, about 120 W to about 180 W, about 120 W to about 200 W, about 120 W to about 220 W, about 120 W to about 240 W, about 120 W to about 260 W, about 120 W to about 300 W, about 140 W to about 160 W, about 140 W to about 180 W, about 140 W to about 200 W, about 140 W to about 220 W, about 140 W to about 240 W, about 140 W to about 260 W, about 140 W to about 300 W, about 160 W to about 180 W, about 160 W to about 200 W, about 160 W to about 220 W, about 160 W to about 240 W, about 160 W to about 260 W, about 160 W to about 300 W, about 180 W to about 200 W, about 180 W to about 220 W, about 180 W to about 240 W, about 180 W to about 260 W, about 180 W to about 300 W, about 200 W to about 220 W, about 200 W to about 240 W, about 200 W to about 260 W, about 200 W to about 300 W, about 220 W to about 240 W, about 220 W to about 260 W, about 220 W to about 300 W, about 240 W to about 260 W, about 240 W to about 300 W, or about 260 W to about 300 W. In some embodiments, each solar panel has a power of about 60 W, about 80 W, about 100 W, about 120 W, about 140 W, about 160 W, about 180 W, about 200 W, about 220 W, about 240 W, about 260 W, or about 300 W, including increments therein. In some embodiments, each solar panel has a power of at least about 60 W, about 80 W, about 100 W, about 120 W, about 140 W, about 160 W, about 180 W, about 200 W, about 220 W, about 240 W, or about 260 W, including increments therein. In some embodiments, each solar panel has a power of at most about 80 W, about 100 W, about 120 W, about 140 W, about 160 W, about 180 W, about 200 W, about 220 W, about 240 W, about 260 W, or about 300 W, including increments therein.

In some embodiments, the energy storage device has a power of about 10 W to about 30 W. In some embodiments, the energy storage device has a power of about 10 W to about 12 W, about 10 W to about 14 W, about 10 W to about 16 W, about 10 W to about 18 W, about 10 W to about 20 W, about 10 W to about 22 W, about 10 W to about 24 W, about 10 W to about 26 W, about 10 W to about 28 W, about 10 W to about 30 W, about 12 W to about 14 W, about 12 W to about 16 W, about 12 W to about 18 W, about 12 W to about 20 W, about 12 W to about 22 W, about 12 W to about 24 W, about 12 W to about 26 W, about 12 W to about 28 W, about 12 W to about 30 W, about 14 W to about 16 W, about 14 W to about 18 W, about 14 W to about 20 W, about 14 W to about 22 W, about 14 W to about 24 W, about 14 W to about 26 W, about 14 W to about 28 W, about 14 W to about 30 W, about 16 W to about 18 W, about 16 W to about 20 W, about 16 W to about 22 W, about 16 W to about 24 W, about 16 W to about 26 W, about 16 W to about 28 W, about 16 W to about 30 W, about 18 W to about 20 W, about 18 W to about 22 W, about 18 W to about 24 W, about 18 W to about 26 W, about 18 W to about 28 W, about 18 W to about 30 W, about 20 W to about 22 W, about 20 W to about 24 W, about 20 W to about 26 W, about 20 W to about 28 W, about 20 W to about 30 W, about 22 W to about 24 W, about 22 W to about 26 W, about 22 W to about 28 W, about 22 W to about 30 W, about 24 W to about 26 W, about 24 W to about 28 W, about 24 W to about 30 W, about 26 W to about 28 W, about 26 W to about 30 W, or about 28 W to about 30 W. In some embodiments, the energy storage device has a power of about 10 W, about 12 W, about 14 W, about 16 W, about 18 W, about 20 W, about 22 W, about 24 W, about 26 W, about 28 W, or about 30 W, including increments therein. In some embodiments, the energy storage device has a power of at least about 10 W, about 12 W, about 14 W, about 16 W, about 18 W, about 20 W, about 22 W, about 24 W, about 26 W, or about 28 W, including increments therein. In some embodiments, the energy storage device has a power of at most about 12 W, about 14 W, about 16 W, about 18 W, about 20 W, about 22 W, about 24 W, about 26 W, about 28 W, or about 30 W, including increments therein.

In some embodiments, the energy storage device has a voltage of about 24 V DC to about 120 V DC. In some embodiments, the energy storage device has a voltage of about 24 V DC to about 30 V DC, about 24 V DC to about 36 V DC, about 24 V DC to about 42 V DC, about 24 V DC to about 48 V DC, about 24 V DC to about 54 V DC, about 24 V DC to about 60 V DC, about 24 V DC to about 70 V DC, about 24 V DC to about 80 V DC, about 24 V DC to about 90 V DC, about 24 V DC to about 100 V DC, about 24 V DC to about 120 V DC, about 30 V DC to about 36 V DC, about 30 V DC to about 42 V DC, about 30 V DC to about 48 V DC, about 30 V DC to about 54 V DC, about 30 V DC to about 60 V DC, about 30 V DC to about 70 V DC, about 30 V DC to about 80 V DC, about 30 V DC to about 90 V DC, about 30 V DC to about 100 V DC, about 30 V DC to about 120 V DC, about 36 V DC to about 42 V DC, about 36 V DC to about 48 V DC, about 36 V DC to about 54 V DC, about 36 V DC to about 60 V DC, about 36 V DC to about 70 V DC, about 36 V DC to about 80 V DC, about 36 V DC to about 90 V DC, about 36 V DC to about 100 V DC, about 36 V DC to about 120 V DC, about 42 V DC to about 48 V DC, about 42 V DC to about 54 V DC, about 42 V DC to about 60 V DC, about 42 V DC to about 70 V DC, about 42 V DC to about 80 V DC, about 42 V DC to about 90 V DC, about 42 V DC to about 100 V DC, about 42 V DC to about 120 V DC, about 48 V DC to about 54 V DC, about 48 V DC to about 60 V DC, about 48 V DC to about 70 V DC, about 48 V DC to about 80 V DC, about 48 V DC to about 90 V DC, about 48 V DC to about 100 V DC, about 48 V DC to about 120 V DC, about 54 V DC to about 60 V DC, about 54 V DC to about 70 V DC, about 54 V DC to about 80 V DC, about 54 V DC to about 90 V DC, about 54 V DC to about 100 V DC, about 54 V DC to about 120 V DC, about 60 V DC to about 70 V DC, about 60 V DC to about 80 V DC, about 60 V DC to about 90 V DC, about 60 V DC to about 100 V DC, about 60 V DC to about 120 V DC, about 70 V DC to about 80 V DC, about 70 V DC to about 90 V DC, about 70 V DC to about 100 V DC, about 70 V DC to about 120 V DC, about 80 V DC to about 90 V DC, about 80 V DC to about 100 V DC, about 80 V DC to about 120 V DC, about 90 V DC to about 100 V DC, about 90 V DC to about 120 V DC, or about 100 V DC to about 120 V DC. In some embodiments, the energy storage device has a voltage of about 24 V DC, about 30 V DC, about 36 V DC, about 42 V DC, about 48 V DC, about 54 V DC, about 60 V DC, about 70 V DC, about 80 V DC, about 90 V DC, about 100 V DC, or about 120 V DC, including increments therein. In some embodiments, the energy storage device has a voltage of at least about 24 V DC, about 30 V DC, about 36 V DC, about 42 V DC, about 48 V DC, about 54 V DC, about 60 V DC, about 70 V DC, about 80 V DC, about 90 V DC, or about 100 V DC, including increments therein. In some embodiments, the energy storage device has a voltage of at most about 30 V DC, about 36 V DC, about 42 V DC, about 48 V DC, about 54 V DC, about 60 V DC, about 70 V DC, about 80 V DC, about 90 V DC, about 100 V DC, or about 120 V DC, including increments therein.

In some embodiments, the energy storage device has a current of about 200 A to about 600 A. In some embodiments, the energy storage device has a current of about 200 A to about 250 A, about 200 A to about 300 A, about 200 A to about 350 A, about 200 A to about 400 A, about 200 A to about 450 A, about 200 A to about 500 A, about 200 A to about 550 A, about 200 A to about 600 A, about 250 A to about 300 A, about 250 A to about 350 A, about 250 A to about 400 A, about 250 A to about 450 A, about 250 A to about 500 A, about 250 A to about 550 A, about 250 A to about 600 A, about 300 A to about 350 A, about 300 A to about 400 A, about 300 A to about 450 A, about 300 A to about 500 A, about 300 A to about 550 A, about 300 A to about 600 A, about 350 A to about 400 A, about 350 A to about 450 A, about 350 A to about 500 A, about 350 A to about 550 A, about 350 A to about 600 A, about 400 A to about 450 A, about 400 A to about 500 A, about 400 A to about 550 A, about 400 A to about 600 A, about 450 A to about 500 A, about 450 A to about 550 A, about 450 A to about 600 A, about 500 A to about 550 A, about 500 A to about 600 A, or about 550 A to about 600 A. In some embodiments, the energy storage device has a current of about 200 A, about 250 A, about 300 A, about 350 A, about 400 A, about 450 A, about 500 A, about 550 A, or about 600 A, including increments therein. In some embodiments, the energy storage device has a current of at least about 200 A, about 250 A, about 300 A, about 350 A, about 400 A, about 450 A, about 500 A, or about 550 A, including increments therein. In some embodiments, the energy storage device has a current of at most about 250 A, about 300 A, about 350 A, about 400 A, about 450 A, about 500 A, about 550 A, or about 600 A, including increments therein.

In some embodiments, the energy storage device has a capacity of about 50 Ah to about 200 Ah. In some embodiments, the energy storage device has a capacity of about 50 Ah to about 60 Ah, about 50 Ah to about 70 Ah, about 50 Ah to about 80 Ah, about 50 Ah to about 90 Ah, about 50 Ah to about 100 Ah, about 50 Ah to about 120 Ah, about 50 Ah to about 140 Ah, about 50 Ah to about 160 Ah, about 50 Ah to about 180 Ah, about 50 Ah to about 200 Ah, about 60 Ah to about 70 Ah, about 60 Ah to about 80 Ah, about 60 Ah to about 90 Ah, about 60 Ah to about 100 Ah, about 60 Ah to about 120 Ah, about 60 Ah to about 140 Ah, about 60 Ah to about 160 Ah, about 60 Ah to about 180 Ah, about 60 Ah to about 200 Ah, about 70 Ah to about 80 Ah, about 70 Ah to about 90 Ah, about 70 Ah to about 100 Ah, about 70 Ah to about 120 Ah, about 70 Ah to about 140 Ah, about 70 Ah to about 160 Ah, about 70 Ah to about 180 Ah, about 70 Ah to about 200 Ah, about 80 Ah to about 90 Ah, about 80 Ah to about 100 Ah, about 80 Ah to about 120 Ah, about 80 Ah to about 140 Ah, about 80 Ah to about 160 Ah, about 80 Ah to about 180 Ah, about 80 Ah to about 200 Ah, about 90 Ah to about 100 Ah, about 90 Ah to about 120 Ah, about 90 Ah to about 140 Ah, about 90 Ah to about 160 Ah, about 90 Ah to about 180 Ah, about 90 Ah to about 200 Ah, about 100 Ah to about 120 Ah, about 100 Ah to about 140 Ah, about 100 Ah to about 160 Ah, about 100 Ah to about 180 Ah, about 100 Ah to about 200 Ah, about 120 Ah to about 140 Ah, about 120 Ah to about 160 Ah, about 120 Ah to about 180 Ah, about 120 Ah to about 200 Ah, about 140 Ah to about 160 Ah, about 140 Ah to about 180 Ah, about 140 Ah to about 200 Ah, about 160 Ah to about 180 Ah, about 160 Ah to about 200 Ah, or about 180 Ah to about 200 Ah. In some embodiments, the energy storage device has a capacity of about 50 Ah, about 60 Ah, about 70 Ah, about 80 Ah, about 90 Ah, about 100 Ah, about 120 Ah, about 140 Ah, about 160 Ah, about 180 Ah, or about 200 Ah, including increments therein. In some embodiments, the energy storage device has a capacity of at least about 50 Ah, about 60 Ah, about 70 Ah, about 80 Ah, about 90 Ah, about 100 Ah, about 120 Ah, about 140 Ah, about 160 Ah, or about 180 Ah, including increments therein. In some embodiments, the energy storage device has a capacity of at most about 60 Ah, about 70 Ah, about 80 Ah, about 90 Ah, about 100 Ah, about 120 Ah, about 140 Ah, about 160 Ah, about 180 Ah, or about 200 Ah, including increments therein.

In some embodiments, the energy storage device has an energy of about 10 kW/h to about 40 kW/h. In some embodiments, the energy storage device has an energy of about 10 kW/h to about 12 kW/h, about 10 kW/h to about 14 kW/h, about 10 kW/h to about 16 kW/h, about 10 kW/h to about 18 kW/h, about 10 kW/h to about 20 kW/h, about 10 kW/h to about 24 kW/h, about 10 kW/h to about 28 kW/h, about 10 kW/h to about 32 kW/h, about 10 kW/h to about 36 kW/h, about 10 kW/h to about 40 kW/h, about 12 kW/h to about 14 kW/h, about 12 kW/h to about 16 kW/h, about 12 kW/h to about 18 kW/h, about 12 kW/h to about 20 kW/h, about 12 kW/h to about 24 kW/h, about 12 kW/h to about 28 kW/h, about 12 kW/h to about 32 kW/h, about 12 kW/h to about 36 kW/h, about 12 kW/h to about 40 kW/h, about 14 kW/h to about 16 kW/h, about 14 kW/h to about 18 kW/h, about 14 kW/h to about 20 kW/h, about 14 kW/h to about 24 kW/h, about 14 kW/h to about 28 kW/h, about 14 kW/h to about 32 kW/h, about 14 kW/h to about 36 kW/h, about 14 kW/h to about 40 kW/h, about 16 kW/h to about 18 kW/h, about 16 kW/h to about 20 kW/h, about 16 kW/h to about 24 kW/h, about 16 kW/h to about 28 kW/h, about 16 kW/h to about 32 kW/h, about 16 kW/h to about 36 kW/h, about 16 kW/h to about 40 kW/h, about 18 kW/h to about 20 kW/h, about 18 kW/h to about 24 kW/h, about 18 kW/h to about 28 kW/h, about 18 kW/h to about 32 kW/h, about 18 kW/h to about 36 kW/h, about 18 kW/h to about 40 kW/h, about 20 kW/h to about 24 kW/h, about 20 kW/h to about 28 kW/h, about 20 kW/h to about 32 kW/h, about 20 kW/h to about 36 kW/h, about 20 kW/h to about 40 kW/h, about 24 kW/h to about 28 kW/h, about 24 kW/h to about 32 kW/h, about 24 kW/h to about 36 kW/h, about 24 kW/h to about 40 kW/h, about 28 kW/h to about 32 kW/h, about 28 kW/h to about 36 kW/h, about 28 kW/h to about 40 kW/h, about 32 kW/h to about 36 kW/h, about 32 kW/h to about 40 kW/h, or about 36 kW/h to about 40 kW/h. In some embodiments, the energy storage device has an energy of about 10 kW/h, about 12 kW/h, about 14 kW/h, about 16 kW/h, about 18 kW/h, about 20 kW/h, about 24 kW/h, about 28 kW/h, about 32 kW/h, about 36 kW/h, or about 40 kW/h, including increments therein. In some embodiments, the energy storage device has an energy of at least about 10 kW/h, about 12 kW/h, about 14 kW/h, about 16 kW/h, about 18 kW/h, about 20 kW/h, about 24 kW/h, about 28 kW/h, about 32 kW/h, or about 36 kW/h, including increments therein. In some embodiments, the energy storage device has an energy of at most about 12 kW/h, about 14 kW/h, about 16 kW/h, about 18 kW/h, about 20 kW/h, about 24 kW/h, about 28 kW/h, about 32 kW/h, about 36 kW/h, or about 40 kW/h, including increments therein.

In some embodiments, the energy storage device comprises a battery, a supercapacitor, a capacitor, a spring, a flywheel, an accumulator device, or any combination thereof. In some embodiments, the energy storage device comprises a rechargeable energy storage device. In some embodiments, the energy storage device comprises a non-rechargeable energy storage device. In some embodiments, the non-rechargeable energy storage device is configured to be jettisoned from one or more of the hulls, or the deck during operation. In some embodiments, the energy storage device comprises a lithium iron phosphate energy storage device. In some embodiments, the energy storage device comprises a state of charge display. In some embodiments, the unmanned water vehicle comprises two or more batteries. In some embodiments, each of the two or more hulls comprises at least one energy storage device.

In some embodiments, the two or more batteries have a total energy of about 10 kW/h to about 40 kW/h. In some embodiments, the two or more batteries have a total energy of about 10 kW/h to about 12 kW/h, about 10 kW/h to about 14 kW/h, about 10 kW/h to about 16 kW/h, about 10 kW/h to about 18 kW/h, about 10 kW/h to about 20 kW/h, about 10 kW/h to about 24 kW/h, about 10 kW/h to about 28 kW/h, about 10 kW/h to about 32 kW/h, about 10 kW/h to about 36 kW/h, about 10 kW/h to about 40 kW/h, about 12 kW/h to about 14 kW/h, about 12 kW/h to about 16 kW/h, about 12 kW/h to about 18 kW/h, about 12 kW/h to about 20 kW/h, about 12 kW/h to about 24 kW/h, about 12 kW/h to about 28 kW/h, about 12 kW/h to about 32 kW/h, about 12 kW/h to about 36 kW/h, about 12 kW/h to about 40 kW/h, about 14 kW/h to about 16 kW/h, about 14 kW/h to about 18 kW/h, about 14 kW/h to about 20 kW/h, about 14 kW/h to about 24 kW/h, about 14 kW/h to about 28 kW/h, about 14 kW/h to about 32 kW/h, about 14 kW/h to about 36 kW/h, about 14 kW/h to about 40 kW/h, about 16 kW/h to about 18 kW/h, about 16 kW/h to about 20 kW/h, about 16 kW/h to about 24 kW/h, about 16 kW/h to about 28 kW/h, about 16 kW/h to about 32 kW/h, about 16 kW/h to about 36 kW/h, about 16 kW/h to about 40 kW/h, about 18 kW/h to about 20 kW/h, about 18 kW/h to about 24 kW/h, about 18 kW/h to about 28 kW/h, about 18 kW/h to about 32 kW/h, about 18 kW/h to about 36 kW/h, about 18 kW/h to about 40 kW/h, about 20 kW/h to about 24 kW/h, about 20 kW/h to about 28 kW/h, about 20 kW/h to about 32 kW/h, about 20 kW/h to about 36 kW/h, about 20 kW/h to about 40 kW/h, about 24 kW/h to about 28 kW/h, about 24 kW/h to about 32 kW/h, about 24 kW/h to about 36 kW/h, about 24 kW/h to about 40 kW/h, about 28 kW/h to about 32 kW/h, about 28 kW/h to about 36 kW/h, about 28 kW/h to about 40 kW/h, about 32 kW/h to about 36 kW/h, about 32 kW/h to about 40 kW/h, or about 36 kW/h to about 40 kW/h. In some embodiments, the two or more batteries have a total energy of about 10 kW/h, about 12 kW/h, about 14 kW/h, about 16 kW/h, about 18 kW/h, about 20 kW/h, about 24 kW/h, about 28 kW/h, about 32 kW/h, about 36 kW/h, or about 40 kW/h, including increments therein. In some embodiments, the two or more batteries have a total energy of at least about 10 kW/h, about 12 kW/h, about 14 kW/h, about 16 kW/h, about 18 kW/h, about 20 kW/h, about 24 kW/h, about 28 kW/h, about 32 kW/h, or about 36 kW/h, including increments therein. In some embodiments, the two or more batteries have a total energy of at most about 12 kW/h, about 14 kW/h, about 16 kW/h, about 18 kW/h, about 20 kW/h, about 24 kW/h, about 28 kW/h, about 32 kW/h, about 36 kW/h, or about 40 kW/h, including increments therein.

In some embodiments, the unmanned water vehicle further comprises a ballast system comprising a ballast tank within one or more of the two or more hulls, the deck, or both, and at least one of a ballast pump and a ballast valve.

In some embodiments, the ballast tank has a capacity of about 50 gallons to about 200 gallons. In some embodiments, the ballast tank has a capacity of about 50 gallons to about 60 gallons, about 50 gallons to about 70 gallons, about 50 gallons to about 80 gallons, about 50 gallons to about 90 gallons, about 50 gallons to about 100 gallons, about 50 gallons to about 120 gallons, about 50 gallons to about 140 gallons, about 50 gallons to about 160 gallons, about 50 gallons to about 180 gallons, about 50 gallons to about 200 gallons, about 60 gallons to about 70 gallons, about 60 gallons to about 80 gallons, about 60 gallons to about 90 gallons, about 60 gallons to about 100 gallons, about 60 gallons to about 120 gallons, about 60 gallons to about 140 gallons, about 60 gallons to about 160 gallons, about 60 gallons to about 180 gallons, about 60 gallons to about 200 gallons, about 70 gallons to about 80 gallons, about 70 gallons to about 90 gallons, about 70 gallons to about 100 gallons, about 70 gallons to about 120 gallons, about 70 gallons to about 140 gallons, about 70 gallons to about 160 gallons, about 70 gallons to about 180 gallons, about 70 gallons to about 200 gallons, about 80 gallons to about 90 gallons, about 80 gallons to about 100 gallons, about 80 gallons to about 120 gallons, about 80 gallons to about 140 gallons, about 80 gallons to about 160 gallons, about 80 gallons to about 180 gallons, about 80 gallons to about 200 gallons, about 90 gallons to about 100 gallons, about 90 gallons to about 120 gallons, about 90 gallons to about 140 gallons, about 90 gallons to about 160 gallons, about 90 gallons to about 180 gallons, about 90 gallons to about 200 gallons, about 100 gallons to about 120 gallons, about 100 gallons to about 140 gallons, about 100 gallons to about 160 gallons, about 100 gallons to about 180 gallons, about 100 gallons to about 200 gallons, about 120 gallons to about 140 gallons, about 120 gallons to about 160 gallons, about 120 gallons to about 180 gallons, about 120 gallons to about 200 gallons, about 140 gallons to about 160 gallons, about 140 gallons to about 180 gallons, about 140 gallons to about 200 gallons, about 160 gallons to about 180 gallons, about 160 gallons to about 200 gallons, or about 180 gallons to about 200 gallons. In some embodiments, the ballast tank has a capacity of about 50 gallons, about 60 gallons, about 70 gallons, about 80 gallons, about 90 gallons, about 100 gallons, about 120 gallons, about 140 gallons, about 160 gallons, about 180 gallons, or about 200 gallons, including increments therein. In some embodiments, the ballast tank has a capacity of at least about 50 gallons, about 60 gallons, about 70 gallons, about 80 gallons, about 90 gallons, about 100 gallons, about 120 gallons, about 140 gallons, about 160 gallons, or about 180 gallons, including increments therein. In some embodiments, the ballast tank has a capacity of at most about 60 gallons, about 70 gallons, about 80 gallons, about 90 gallons, about 100 gallons, about 120 gallons, about 140 gallons, about 160 gallons, about 180 gallons, or about 200 gallons, including increments therein.

In some embodiments, the unmanned water vehicle further comprises a fixed ballast keel, a deployable ballast keel, or both. In some embodiments, the unmanned water vehicle further comprises a sensor deployment tube on an underside of the deck. In some embodiments, the sensor deployment tubes activate pneumatically, hydraulically, electrically, chemically or any combination thereof.

In some embodiments, the unmanned water vehicle comprises 5 to 20 sensor deployment tubes. In some embodiments, the unmanned water vehicle comprises 5, 6, 7, 8, 9, 10, 11, 12, 13, 14, 15, 16, 17, 18, 19, or 20 sensor deployment tubes. In some embodiments, the unmanned water vehicle comprises at least 5, 6, 7, 8, 9, 10, 11, 12, 13, 14, 15, 16, 17, 18, 19, or 20 sensor deployment tubes.

In some embodiments, the sensor deployment tubes have a length of about 15 inches to about 60 inches. In some embodiments, the sensor deployment tubes have a length of about 15 inches to about 20 inches, about 15 inches to about 25 inches, about 15 inches to about 30 inches, about 15 inches to about 35 inches, about 15 inches to about 40 inches, about 15 inches to about 45 inches, about 15 inches to about 50 inches, about 15 inches to about 55 inches, about 15 inches to about 60 inches, about 20 inches to about 25 inches, about 20 inches to about 30 inches, about 20 inches to about 35 inches, about 20 inches to about 40 inches, about 20 inches to about 45 inches, about 20 inches to about 50 inches, about 20 inches to about 55 inches, about 20 inches to about 60 inches, about 25 inches to about 30 inches, about 25 inches to about 35 inches, about 25 inches to about 40 inches, about 25 inches to about 45 inches, about 25 inches to about 50 inches, about 25 inches to about 55 inches, about 25 inches to about 60 inches, about 30 inches to about 35 inches, about 30 inches to about 40 inches, about 30 inches to about 45 inches, about 30 inches to about 50 inches, about 30 inches to about 55 inches, about 30 inches to about 60 inches, about 35 inches to about 40 inches, about 35 inches to about 45 inches, about 35 inches to about 50 inches, about 35 inches to about 55 inches, about 35 inches to about 60 inches, about 40 inches to about 45 inches, about 40 inches to about 50 inches, about 40 inches to about 55 inches, about 40 inches to about 60 inches, about 45 inches to about 50 inches, about 45 inches to about 55 inches, about 45 inches to about 60 inches, about 50 inches to about 55 inches, about 50 inches to about 60 inches, or about 55 inches to about 60 inches. In some embodiments, the sensor deployment tubes have a length of about 15 inches, about 20 inches, about 25 inches, about 30 inches, about 35 inches, about 40 inches, about 45 inches, about 50 inches, about 55 inches, or about 60 inches, including increments therein. In some embodiments, the sensor deployment tubes have a length of at least about 15 inches, about 20 inches, about 25 inches, about 30 inches, about 35 inches, about 40 inches, about 45 inches, about 50 inches, or about 55 inches, including increments therein. In some embodiments, the sensor deployment tubes have a length of at most about 20 inches, about 25 inches, about 30 inches, about 35 inches, about 40 inches, about 45 inches, about 50 inches, about 55 inches, or about 60 inches, including increments therein.

In some embodiments, the sensor deployment tubes have a diameter of about 1 inch to about 6 inches. In some embodiments, the sensor deployment tubes have a diameter of about 1 inch to about 1.5 inches, about 1 inch to about 2 inches, about 1 inch to about 2.5 inches, about 1 inch to about 3 inches, about 1 inch to about 3.5 inches, about 1 inch to about 4 inches, about 1 inch to about 4.5 inches, about 1 inch to about 5 inches, about 1 inch to about 5.5 inches, about 1 inch to about 6 inches, about 1.5 inches to about 2 inches, about 1.5 inches to about 2.5 inches, about 1.5 inches to about 3 inches, about 1.5 inches to about 3.5 inches, about 1.5 inches to about 4 inches, about 1.5 inches to about 4.5 inches, about 1.5 inches to about 5 inches, about 1.5 inches to about 5.5 inches, about 1.5 inches to about 6 inches, about 2 inches to about 2.5 inches, about 2 inches to about 3 inches, about 2 inches to about 3.5 inches, about 2 inches to about 4 inches, about 2 inches to about 4.5 inches, about 2 inches to about 5 inches, about 2 inches to about 5.5 inches, about 2 inches to about 6 inches, about 2.5 inches to about 3 inches, about 2.5 inches to about 3.5 inches, about 2.5 inches to about 4 inches, about 2.5 inches to about 4.5 inches, about 2.5 inches to about 5 inches, about 2.5 inches to about 5.5 inches, about 2.5 inches to about 6 inches, about 3 inches to about 3.5 inches, about 3 inches to about 4 inches, about 3 inches to about 4.5 inches, about 3 inches to about 5 inches, about 3 inches to about 5.5 inches, about 3 inches to about 6 inches, about 3.5 inches to about 4 inches, about 3.5 inches to about 4.5 inches, about 3.5 inches to about 5 inches, about 3.5 inches to about 5.5 inches, about 3.5 inches to about 6 inches, about 4 inches to about 4.5 inches, about 4 inches to about 5 inches, about 4 inches to about 5.5 inches, about 4 inches to about 6 inches, about 4.5 inches to about 5 inches, about 4.5 inches to about 5.5 inches, about 4.5 inches to about 6 inches, about 5 inches to about 5.5 inches, about 5 inches to about 6 inches, or about 5.5 inches to about 6 inches. In some embodiments, the sensor deployment tubes have a diameter of about 1 inch, about 1.5 inches, about 2 inches, about 2.5 inches, about 3 inches, about 3.5 inches, about 4 inches, about 4.5 inches, about 5 inches, about 5.5 inches, or about 6 inches, including increments therein. In some embodiments, the sensor deployment tubes have a diameter of at least about 1 inch, about 1.5 inches, about 2 inches, about 2.5 inches, about 3 inches, about 3.5 inches, about 4 inches, about 4.5 inches, about 5 inches, or about 5.5 inches, including increments therein. In some embodiments, the sensor deployment tubes have a diameter of at most about 1.5 inches, about 2 inches, about 2.5 inches, about 3 inches, about 3.5 inches, about 4 inches, about 4.5 inches, about 5 inches, about 5.5 inches, or about 6 inches, including increments therein.

In some embodiments, the unmanned water vehicle has a weight of about 300 pounds to about 1,200 pounds. In some embodiments, the unmanned water vehicle has a weight of about 300 pounds to about 400 pounds, about 300 pounds to about 500 pounds, about 300 pounds to about 600 pounds, about 300 pounds to about 700 pounds, about 300 pounds to about 800 pounds, about 300 pounds to about 900 pounds, about 300 pounds to about 1,000 pounds, about 300 pounds to about 1,100 pounds, about 300 pounds to about 1,200 pounds, about 400 pounds to about 500 pounds, about 400 pounds to about 600 pounds, about 400 pounds to about 700 pounds, about 400 pounds to about 800 pounds, about 400 pounds to about 900 pounds, about 400 pounds to about 1,000 pounds, about 400 pounds to about 1,100 pounds, about 400 pounds to about 1,200 pounds, about 500 pounds to about 600 pounds, about 500 pounds to about 700 pounds, about 500 pounds to about 800 pounds, about 500 pounds to about 900 pounds, about 500 pounds to about 1,000 pounds, about 500 pounds to about 1,100 pounds, about 500 pounds to about 1,200 pounds, about 600 pounds to about 700 pounds, about 600 pounds to about 800 pounds, about 600 pounds to about 900 pounds, about 600 pounds to about 1,000 pounds, about 600 pounds to about 1,100 pounds, about 600 pounds to about 1,200 pounds, about 700 pounds to about 800 pounds, about 700 pounds to about 900 pounds, about 700 pounds to about 1,000 pounds, about 700 pounds to about 1,100 pounds, about 700 pounds to about 1,200 pounds, about 800 pounds to about 900 pounds, about 800 pounds to about 1,000 pounds, about 800 pounds to about 1,100 pounds, about 800 pounds to about 1,200 pounds, about 900 pounds to about 1,000 pounds, about 900 pounds to about 1,100 pounds, about 900 pounds to about 1,200 pounds, about 1,000 pounds to about 1,100 pounds, about 1,000 pounds to about 1,200 pounds, or about 1,100 pounds to about 1,200 pounds. In some embodiments, the unmanned water vehicle has a weight of about 300 pounds, about 400 pounds, about 500 pounds, about 600 pounds, about 700 pounds, about 800 pounds, about 900 pounds, about 1,000 pounds, about 1,100 pounds, or about 1,200 pounds, including increments therein. In some embodiments, the unmanned water vehicle has a weight of at least about 300 pounds, about 400 pounds, about 500 pounds, about 600 pounds, about 700 pounds, about 800 pounds, about 900 pounds, about 1,000 pounds, or about 1,100 pounds, including increments therein. In some embodiments, the unmanned water vehicle has a weight of at most about 400 pounds, about 500 pounds, about 600 pounds, about 700 pounds, about 800 pounds, about 900 pounds, about 1,000 pounds, about 1,100 pounds, or about 1,200 pounds, including increments therein.

In some embodiments, the unmanned water vehicle has a maximum above water height of about 1 foot to about 6 feet. In some embodiments, the unmanned water vehicle has a maximum above water height of about 1 foot to about 1.5 feet, about 1 foot to about 2 feet, about 1 foot to about 2.5 feet, about 1 foot to about 3 feet, about 1 foot to about 3.5 feet, about 1 foot to about 4 feet, about 1 foot to about 4.5 feet, about 1 foot to about 5 feet, about 1 foot to about 5.5 feet, about 1 foot to about 6 feet, about 1.5 feet to about 2 feet, about 1.5 feet to about 2.5 feet, about 1.5 feet to about 3 feet, about 1.5 feet to about 3.5 feet, about 1.5 feet to about 4 feet, about 1.5 feet to about 4.5 feet, about 1.5 feet to about 5 feet, about 1.5 feet to about 5.5 feet, about 1.5 feet to about 6 feet, about 2 feet to about 2.5 feet, about 2 feet to about 3 feet, about 2 feet to about 3.5 feet, about 2 feet to about 4 feet, about 2 feet to about 4.5 feet, about 2 feet to about 5 feet, about 2 feet to about 5.5 feet, about 2 feet to about 6 feet, about 2.5 feet to about 3 feet, about 2.5 feet to about 3.5 feet, about 2.5 feet to about 4 feet, about 2.5 feet to about 4.5 feet, about 2.5 feet to about 5 feet, about 2.5 feet to about 5.5 feet, about 2.5 feet to about 6 feet, about 3 feet to about 3.5 feet, about 3 feet to about 4 feet, about 3 feet to about 4.5 feet, about 3 feet to about 5 feet, about 3 feet to about 5.5 feet, about 3 feet to about 6 feet, about 3.5 feet to about 4 feet, about 3.5 feet to about 4.5 feet, about 3.5 feet to about 5 feet, about 3.5 feet to about 5.5 feet, about 3.5 feet to about 6 feet, about 4 feet to about 4.5 feet, about 4 feet to about 5 feet, about 4 feet to about 5.5 feet, about 4 feet to about 6 feet, about 4.5 feet to about 5 feet, about 4.5 feet to about 5.5 feet, about 4.5 feet to about 6 feet, about 5 feet to about 5.5 feet, about 5 feet to about 6 feet, or about 5.5 feet to about 6 feet. In some embodiments, the unmanned water vehicle has a maximum above water height of about 1 foot, about 1.5 feet, about 2 feet, about 2.5 feet, about 3 feet, about 3.5 feet, about 4 feet, about 4.5 feet, about 5 feet, about 5.5 feet, or about 6 feet, including increments therein. In some embodiments, the unmanned water vehicle has a maximum above water height of at least about 1 foot, about 1.5 feet, about 2 feet, about 2.5 feet, about 3 feet, about 3.5 feet, about 4 feet, about 4.5 feet, about 5 feet, or about 5.5 feet, including increments therein. In some embodiments, the unmanned water vehicle has a maximum above water height of at most about 1.5 feet, about 2 feet, about 2.5 feet, about 3 feet, about 3.5 feet, about 4 feet, about 4.5 feet, about 5 feet, about 5.5 feet, or about 6 feet, including increments therein. In a particular embodiment, the profile of the vehicle above the waterline is minimized for stealth.

In some embodiments, the unmanned water vehicle (without the retractable sensor apparatus) has a maximum below water depth of about 1 foot to about 6 feet. In some embodiments, the unmanned water vehicle has a maximum below water depth of about 1 foot to about 1.5 feet, about 1 foot to about 2 feet, about 1 foot to about 2.5 feet, about 1 foot to about 3 feet, about 1 foot to about 3.5 feet, about 1 foot to about 4 feet, about 1 foot to about 4.5 feet, about 1 foot to about 5 feet, about 1 foot to about 5.5 feet, about 1 foot to about 6 feet, about 1.5 feet to about 2 feet, about 1.5 feet to about 2.5 feet, about 1.5 feet to about 3 feet, about 1.5 feet to about 3.5 feet, about 1.5 feet to about 4 feet, about 1.5 feet to about 4.5 feet, about 1.5 feet to about 5 feet, about 1.5 feet to about 5.5 feet, about 1.5 feet to about 6 feet, about 2 feet to about 2.5 feet, about 2 feet to about 3 feet, about 2 feet to about 3.5 feet, about 2 feet to about 4 feet, about 2 feet to about 4.5 feet, about 2 feet to about 5 feet, about 2 feet to about 5.5 feet, about 2 feet to about 6 feet, about 2.5 feet to about 3 feet, about 2.5 feet to about 3.5 feet, about 2.5 feet to about 4 feet, about 2.5 feet to about 4.5 feet, about 2.5 feet to about 5 feet, about 2.5 feet to about 5.5 feet, about 2.5 feet to about 6 feet, about 3 feet to about 3.5 feet, about 3 feet to about 4 feet, about 3 feet to about 4.5 feet, about 3 feet to about 5 feet, about 3 feet to about 5.5 feet, about 3 feet to about 6 feet, about 3.5 feet to about 4 feet, about 3.5 feet to about 4.5 feet, about 3.5 feet to about 5 feet, about 3.5 feet to about 5.5 feet, about 3.5 feet to about 6 feet, about 4 feet to about 4.5 feet, about 4 feet to about 5 feet, about 4 feet to about 5.5 feet, about 4 feet to about 6 feet, about 4.5 feet to about 5 feet, about 4.5 feet to about 5.5 feet, about 4.5 feet to about 6 feet, about 5 feet to about 5.5 feet, about 5 feet to about 6 feet, or about 5.5 feet to about 6 feet. In some embodiments, the unmanned water vehicle has a maximum below water depth of about 1 foot, about 1.5 feet, about 2 feet, about 2.5 feet, about 3 feet, about 3.5 feet, about 4 feet, about 4.5 feet, about 5 feet, about 5.5 feet, or about 6 feet, including increments therein. In some embodiments, the unmanned water vehicle has a maximum below water depth of at least about 1 foot, about 1.5 feet, about 2 feet, about 2.5 feet, about 3 feet, about 3.5 feet, about 4 feet, about 4.5 feet, about 5 feet, or about 5.5 feet, including increments therein. In some embodiments, the unmanned water vehicle has a maximum below water depth of at most about 1.5 feet, about 2 feet, about 2.5 feet, about 3 feet, about 3.5 feet, about 4 feet, about 4.5 feet, about 5 feet, about 5.5 feet, or about 6 feet, including increments therein.

In some embodiments, the unmanned water vehicle has a maximum RADAR cross section of about 0.05 m² to about 0.2 m². In some embodiments, the unmanned water vehicle has a maximum RADAR cross section of about 0.05 m² to about 0.075 m², about 0.05 m² to about 0.1 m², about 0.05 m² to about 0.125 m², about 0.05 m² to about 0.15 m², about 0.05 m² to about 0.175 m², about 0.05 m² to about 0.2 m², about 0.075 m² to about 0.1 m², about 0.075 m² to about 0.125 m², about 0.075 m² to about 0.15 m², about 0.075 m² to about 0.175 m², about 0.075 m² to about 0.2 m², about 0.1 m² to about 0.125 m², about 0.1 m² to about 0.15 m², about 0.1 m² to about 0.175 m², about 0.1 m² to about 0.2 m², about 0.125 m² to about 0.15 m², about 0.125 m² to about 0.175 m², about 0.125 m² to about 0.2 m², about 0.15 m² to about 0.175 m², about 0.15 m² to about 0.2 m², or about 0.175 m² to about 0.2 m². In some embodiments, the unmanned water vehicle has a maximum RADAR cross section of about 0.05 m², about 0.075 m², about 0.1 m², about 0.125 m², about 0.15 m², about 0.175 m², or about 0.2 m², including increments therein. In some embodiments, the unmanned water vehicle has a maximum RADAR cross section of at least about 0.05 m², about 0.075 m², about 0.1 m², about 0.125 m², about 0.15 m², or about 0.175 m², including increments therein. In some embodiments, the unmanned water vehicle has a maximum RADAR cross section of at most about 0.075 m², about 0.1 m², about 0.125 m², about 0.15 m², about 0.175 m², or about 0.2 m² including increments therein. In a particular embodiment, the RADAR cross section of the vehicle is minimized for stealth.

In some embodiments, the unmanned water vehicle has a maximum speed of about 8 knots to about 32 knots. In some embodiments, the unmanned water vehicle has a maximum speed of about 8 knots to about 10 knots, about 8 knots to about 12 knots, about 8 knots to about 14 knots, about 8 knots to about 16 knots, about 8 knots to about 18 knots, about 8 knots to about 20 knots, about 8 knots to about 22 knots, about 8 knots to about 24 knots, about 8 knots to about 26 knots, about 8 knots to about 28 knots, about 8 knots to about 32 knots, about 10 knots to about 12 knots, about 10 knots to about 14 knots, about 10 knots to about 16 knots, about 10 knots to about 18 knots, about 10 knots to about 20 knots, about 10 knots to about 22 knots, about 10 knots to about 24 knots, about 10 knots to about 26 knots, about 10 knots to about 28 knots, about 10 knots to about 32 knots, about 12 knots to about 14 knots, about 12 knots to about 16 knots, about 12 knots to about 18 knots, about 12 knots to about 20 knots, about 12 knots to about 22 knots, about 12 knots to about 24 knots, about 12 knots to about 26 knots, about 12 knots to about 28 knots, about 12 knots to about 32 knots, about 14 knots to about 16 knots, about 14 knots to about 18 knots, about 14 knots to about 20 knots, about 14 knots to about 22 knots, about 14 knots to about 24 knots, about 14 knots to about 26 knots, about 14 knots to about 28 knots, about 14 knots to about 32 knots, about 16 knots to about 18 knots, about 16 knots to about 20 knots, about 16 knots to about 22 knots, about 16 knots to about 24 knots, about 16 knots to about 26 knots, about 16 knots to about 28 knots, about 16 knots to about 32 knots, about 18 knots to about 20 knots, about 18 knots to about 22 knots, about 18 knots to about 24 knots, about 18 knots to about 26 knots, about 18 knots to about 28 knots, about 18 knots to about 32 knots, about 20 knots to about 22 knots, about 20 knots to about 24 knots, about 20 knots to about 26 knots, about 20 knots to about 28 knots, about 20 knots to about 32 knots, about 22 knots to about 24 knots, about 22 knots to about 26 knots, about 22 knots to about 28 knots, about 22 knots to about 32 knots, about 24 knots to about 26 knots, about 24 knots to about 28 knots, about 24 knots to about 32 knots, about 26 knots to about 28 knots, about 26 knots to about 32 knots, or about 28 knots to about 32 knots. In some embodiments, the unmanned water vehicle has a maximum speed of about 8 knots, about 10 knots, about 12 knots, about 14 knots, about 16 knots, about 18 knots, about 20 knots, about 22 knots, about 24 knots, about 26 knots, about 28 knots, or about 32 knots, including increments therein. In some embodiments, the unmanned water vehicle has a maximum speed of at least about 8 knots, about 10 knots, about 12 knots, about 14 knots, about 16 knots, about 18 knots, about 20 knots, about 22 knots, about 24 knots, about 26 knots, or about 28 knots, including increments therein. In some embodiments, the unmanned water vehicle has a maximum speed of at most about 10 knots, about 12 knots, about 14 knots, about 16 knots, about 18 knots, about 20 knots, about 22 knots, about 24 knots, about 26 knots, about 28 knots, or about 32 knots, including increments therein.

In some embodiments, the unmanned water vehicle has an operating speed of about 0.5 knots to about 3 knots. In some embodiments, the unmanned water vehicle has an operating speed of about 0.5 knots to about 0.75 knots, about 0.5 knots to about 1 knot, about 0.5 knots to about 1.25 knots, about 0.5 knots to about 1.5 knots, about 0.5 knots to about 1.75 knots, about 0.5 knots to about 2 knots, about 0.5 knots to about 2.25 knots, about 0.5 knots to about 2.5 knots, about 0.5 knots to about 2.75 knots, about 0.5 knots to about 3 knots, about 0.75 knots to about 1 knot, about 0.75 knots to about 1.25 knots, about 0.75 knots to about 1.5 knots, about 0.75 knots to about 1.75 knots, about 0.75 knots to about 2 knots, about 0.75 knots to about 2.25 knots, about 0.75 knots to about 2.5 knots, about 0.75 knots to about 2.75 knots, about 0.75 knots to about 3 knots, about 1 knot to about 1.25 knots, about 1 knot to about 1.5 knots, about 1 knot to about 1.75 knots, about 1 knot to about 2 knots, about 1 knot to about 2.25 knots, about 1 knot to about 2.5 knots, about 1 knot to about 2.75 knots, about 1 knot to about 3 knots, about 1.25 knots to about 1.5 knots, about 1.25 knots to about 1.75 knots, about 1.25 knots to about 2 knots, about 1.25 knots to about 2.25 knots, about 1.25 knots to about 2.5 knots, about 1.25 knots to about 2.75 knots, about 1.25 knots to about 3 knots, about 1.5 knots to about 1.75 knots, about 1.5 knots to about 2 knots, about 1.5 knots to about 2.25 knots, about 1.5 knots to about 2.5 knots, about 1.5 knots to about 2.75 knots, about 1.5 knots to about 3 knots, about 1.75 knots to about 2 knots, about 1.75 knots to about 2.25 knots, about 1.75 knots to about 2.5 knots, about 1.75 knots to about 2.75 knots, about 1.75 knots to about 3 knots, about 2 knots to about 2.25 knots, about 2 knots to about 2.5 knots, about 2 knots to about 2.75 knots, about 2 knots to about 3 knots, about 2.25 knots to about 2.5 knots, about 2.25 knots to about 2.75 knots, about 2.25 knots to about 3 knots, about 2.5 knots to about 2.75 knots, about 2.5 knots to about 3 knots, or about 2.75 knots to about 3 knots. In some embodiments, the unmanned water vehicle has an operating speed of about 0.5 knots, about 0.75 knots, about 1 knot, about 1.25 knots, about 1.5 knots, about 1.75 knots, about 2 knots, about 2.25 knots, about 2.5 knots, about 2.75 knots, or about 3 knots, including increments therein. In some embodiments, the unmanned water vehicle has an operating speed of at least about 0.5 knots, about 0.75 knots, about 1 knot, about 1.25 knots, about 1.5 knots, about 1.75 knots, about 2 knots, about 2.25 knots, about 2.5 knots, or about 2.75 knots, including increments therein. In some embodiments, the unmanned water vehicle has an operating speed of at most about 0.75 knots, about 1 knot, about 1.25 knots, about 1.5 knots, about 1.75 knots, about 2 knots, about 2.25 knots, about 2.5 knots, about 2.75 knots, or about 3 knots, including increments therein.

In some embodiments, the unmanned water vehicle operates independently for about 30 days to about 120 days. In some embodiments, the unmanned water vehicle operates independently for about 30 days to about 40 days, about 30 days to about 50 days, about 30 days to about 60 days, about 30 days to about 70 days, about 30 days to about 80 days, about 30 days to about 90 days, about 30 days to about 100 days, about 30 days to about 110 days, about 30 days to about 120 days, about 40 days to about 50 days, about 40 days to about 60 days, about 40 days to about 70 days, about 40 days to about 80 days, about 40 days to about 90 days, about 40 days to about 100 days, about 40 days to about 110 days, about 40 days to about 120 days, about 50 days to about 60 days, about 50 days to about 70 days, about 50 days to about 80 days, about 50 days to about 90 days, about 50 days to about 100 days, about 50 days to about 110 days, about 50 days to about 120 days, about 60 days to about 70 days, about 60 days to about 80 days, about 60 days to about 90 days, about 60 days to about 100 days, about 60 days to about 110 days, about 60 days to about 120 days, about 70 days to about 80 days, about 70 days to about 90 days, about 70 days to about 100 days, about 70 days to about 110 days, about 70 days to about 120 days, about 80 days to about 90 days, about 80 days to about 100 days, about 80 days to about 110 days, about 80 days to about 120 days, about 90 days to about 100 days, about 90 days to about 110 days, about 90 days to about 120 days, about 100 days to about 110 days, about 100 days to about 120 days, or about 110 days to about 120 days. In some embodiments, the unmanned water vehicle operates independently for about 30 days, about 40 days, about 50 days, about 60 days, about 70 days, about 80 days, about 90 days, about 100 days, about 110 days, or about 120 days, including increments therein. In some embodiments, the unmanned water vehicle operates independently for at least about 30 days, about 40 days, about 50 days, about 60 days, about 70 days, about 80 days, about 90 days, about 100 days, or about 110 days, including increments therein. In some embodiments, the unmanned water vehicle operates independently for at most about 40 days, about 50 days, about 60 days, about 70 days, about 80 days, about 90 days, about 100 days, about 110 days, or about 120 days, including increments therein.

In some embodiments, the unmanned water vehicle has a repositioning speed of about 1 knot to about 10 knots. In some embodiments, the unmanned water vehicle has a repositioning speed of about 1 knot to about 2 knots, about 1 knot to about 3 knots, about 1 knot to about 4 knots, about 1 knot to about 5 knots, about 1 knot to about 6 knots, about 1 knot to about 7 knots, about 1 knot to about 8 knots, about 1 knot to about 9 knots, about 1 knot to about 10 knots, about 2 knots to about 3 knots, about 2 knots to about 4 knots, about 2 knots to about 5 knots, about 2 knots to about 6 knots, about 2 knots to about 7 knots, about 2 knots to about 8 knots, about 2 knots to about 9 knots, about 2 knots to about 10 knots, about 3 knots to about 4 knots, about 3 knots to about 5 knots, about 3 knots to about 6 knots, about 3 knots to about 7 knots, about 3 knots to about 8 knots, about 3 knots to about 9 knots, about 3 knots to about 10 knots, about 4 knots to about 5 knots, about 4 knots to about 6 knots, about 4 knots to about 7 knots, about 4 knots to about 8 knots, about 4 knots to about 9 knots, about 4 knots to about 10 knots, about 5 knots to about 6 knots, about 5 knots to about 7 knots, about 5 knots to about 8 knots, about 5 knots to about 9 knots, about 5 knots to about 10 knots, about 6 knots to about 7 knots, about 6 knots to about 8 knots, about 6 knots to about 9 knots, about 6 knots to about 10 knots, about 7 knots to about 8 knots, about 7 knots to about 9 knots, about 7 knots to about 10 knots, about 8 knots to about 9 knots, about 8 knots to about 10 knots, or about 9 knots to about 10 knots. In some embodiments, the unmanned water vehicle has a repositioning speed of about 1 knot, about 2 knots, about 3 knots, about 4 knots, about 5 knots, about 6 knots, about 7 knots, about 8 knots, about 9 knots, or about 10 knots, including increments therein. In some embodiments, the unmanned water vehicle has a repositioning speed of at least about 1 knot, about 2 knots, about 3 knots, about 4 knots, about 5 knots, about 6 knots, about 7 knots, about 8 knots, or about 9 knots, including increments therein. In some embodiments, the unmanned water vehicle has a repositioning speed of at most about 2 knots, about 3 knots, about 4 knots, about 5 knots, about 6 knots, about 7 knots, about 8 knots, about 9 knots, or about 10 knots, including increments therein.

In some embodiments, the unmanned water vehicle has a towing capacity of about 20 pounds to about 80 pounds. In some embodiments, the unmanned water vehicle has a towing capacity of about 20 pounds to about 25 pounds, about 20 pounds to about 30 pounds, about 20 pounds to about 35 pounds, about 20 pounds to about 40 pounds, about 20 pounds to about 45 pounds, about 20 pounds to about 50 pounds, about 20 pounds to about 55 pounds, about 20 pounds to about 60 pounds, about 20 pounds to about 65 pounds, about 20 pounds to about 70 pounds, about 20 pounds to about 80 pounds, about 25 pounds to about 30 pounds, about 25 pounds to about 35 pounds, about 25 pounds to about 40 pounds, about 25 pounds to about 45 pounds, about 25 pounds to about 50 pounds, about 25 pounds to about 55 pounds, about 25 pounds to about 60 pounds, about 25 pounds to about 65 pounds, about 25 pounds to about 70 pounds, about 25 pounds to about 80 pounds, about 30 pounds to about 35 pounds, about 30 pounds to about 40 pounds, about 30 pounds to about 45 pounds, about 30 pounds to about 50 pounds, about 30 pounds to about 55 pounds, about 30 pounds to about 60 pounds, about 30 pounds to about 65 pounds, about 30 pounds to about 70 pounds, about 30 pounds to about 80 pounds, about 35 pounds to about 40 pounds, about 35 pounds to about 45 pounds, about 35 pounds to about 50 pounds, about 35 pounds to about 55 pounds, about 35 pounds to about 60 pounds, about 35 pounds to about 65 pounds, about 35 pounds to about 70 pounds, about 35 pounds to about 80 pounds, about 40 pounds to about 45 pounds, about 40 pounds to about 50 pounds, about 40 pounds to about 55 pounds, about 40 pounds to about 60 pounds, about 40 pounds to about 65 pounds, about 40 pounds to about 70 pounds, about 40 pounds to about 80 pounds, about 45 pounds to about 50 pounds, about 45 pounds to about 55 pounds, about 45 pounds to about 60 pounds, about 45 pounds to about 65 pounds, about 45 pounds to about 70 pounds, about 45 pounds to about 80 pounds, about 50 pounds to about 55 pounds, about 50 pounds to about 60 pounds, about 50 pounds to about 65 pounds, about 50 pounds to about 70 pounds, about 50 pounds to about 80 pounds, about 55 pounds to about 60 pounds, about 55 pounds to about 65 pounds, about 55 pounds to about 70 pounds, about 55 pounds to about 80 pounds, about 60 pounds to about 65 pounds, about 60 pounds to about 70 pounds, about 60 pounds to about 80 pounds, about 65 pounds to about 70 pounds, about 65 pounds to about 80 pounds, or about 70 pounds to about 80 pounds. In some embodiments, the unmanned water vehicle has a towing capacity of about 20 pounds, about 25 pounds, about 30 pounds, about 35 pounds, about 40 pounds, about 45 pounds, about 50 pounds, about 55 pounds, about 60 pounds, about 65 pounds, about 70 pounds, or about 80 pounds, including increments therein. In some embodiments, the unmanned water vehicle has a towing capacity of at least about 20 pounds, about 25 pounds, about 30 pounds, about 35 pounds, about 40 pounds, about 45 pounds, about 50 pounds, about 55 pounds, about 60 pounds, about 65 pounds, or about 70 pounds, including increments therein. In some embodiments, the unmanned water vehicle has a towing capacity of at most about 25 pounds, about 30 pounds, about 35 pounds, about 40 pounds, about 45 pounds, about 50 pounds, about 55 pounds, about 60 pounds, about 65 pounds, about 70 pounds, or about 80 pounds, including increments therein.

In some embodiments, the unmanned water vehicle has a sea state capability of 3, 4, 5, 6, or 7. In some embodiments, the power system further comprises an engine coupled to a generator and configured to charge the energy storage device. In some embodiments, the generator is powered by: compressed natural gas, diesel, gasoline, butane, propane, a fossil fuel, or any combination thereof.

Another aspect provided herein is an unmanned water vehicle comprising: two or more hulls; a wind turbine; a steerable drive apparatus; a plurality of modular deck components configured to removably couple to one or more of the two or more hulls, wherein each modular deck component comprises: one or more solar panels; and a ballast; a mobility and control system comprising: a wireless communications device; and a mobility and control module providing operation of the unmanned water vehicle in a remote piloted mode, a semi-autonomous mode, and a fully autonomous mode; and a power system comprising an energy storage device receiving energy from the one or more solar panels to power the wind turbine, the steerable drive apparatus, or both; wherein the wind turbine and the steerable drive apparatus output a sufficient power to enable a maximum speed of the unmanned water vehicle of at least about 8 knots.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a first front, top, left perspective view of a first embodiment of the unmanned water vehicle, in accordance to some embodiments herein;

FIG. 2 shows a front, bottom, left perspective view of a first embodiment of the unmanned water vehicle, in accordance to some embodiments herein;

FIG. 3 shows a left view of a first embodiment of the unmanned water vehicle, in accordance to some embodiments herein;

FIG. 4 shows a second front, top, left perspective view of a first embodiment of the unmanned water vehicle, in accordance to some embodiments herein;

FIG. 5 shows a third front, top, left perspective view of a first embodiment of the unmanned water vehicle, in accordance to some embodiments herein;

FIG. 6 shows a front, top, right perspective view of a first embodiment of the unmanned water vehicle, in accordance to some embodiments herein;

FIG. 7 shows a detailed front, top, left perspective view of a first embodiment of the unmanned water vehicle, in accordance to some embodiments herein;

FIG. 8 shows a back, top, left perspective view of a first embodiment of the unmanned water vehicle, in accordance to some embodiments herein;

FIG. 9 shows a left side elevation view of a first embodiment of the unmanned water vehicle, in accordance to some embodiments herein;

FIG. 10 shows a top plan view of a first embodiment of the unmanned water vehicle, in accordance to some embodiments herein;

FIG. 11 shows a top, left perspective view of a first embodiment of the unmanned water vehicle without solar panels, in accordance to some embodiments herein;

FIG. 12 shows a detailed front, top, right perspective view of a first embodiment of the unmanned water vehicle without solar panels, in accordance to some embodiments herein;

FIG. 13 shows a front, top perspective view of a first embodiment of the unmanned water vehicle without solar panels, in accordance to some embodiments herein;

FIG. 14 shows a front, bottom, left perspective view of a first embodiment of the unmanned water vehicle without solar panels, in accordance to some embodiments herein;

FIG. 15 shows a front, top, left perspective view of a second embodiment of the unmanned water vehicle, in accordance to some embodiments herein;

FIG. 16 shows a front, top, left perspective cross-sectioned view of a second embodiment of the unmanned water vehicle, in accordance to some embodiments herein;

FIG. 17 shows a front, bottom, left perspective view of a second embodiment of the unmanned water vehicle, in accordance to some embodiments herein;

FIG. 18 shows a top, bottom, right perspective view of a payload module of a second embodiment of the unmanned water vehicle, in accordance to some embodiments herein; and

FIG. 19 shows a top, bottom, right perspective view of a shipping container for a second embodiment of the unmanned water vehicle, in accordance to some embodiments herein.

### DETAILED DESCRIPTION

Currently, marine data acquisition is mainly performed by manned ships that tow, release, or contain the required sensor or sensors. Such manned operations, however, are prohibitively expensive for periodic or continuous operation. Further, such data collection in rough seas and dangerous international waters pose threats to the data collection crew. As such, provided herein are unmanned water vehicles capable of continuous operation for a period of time of at least about 3 months while capturing various above and below water sensor data.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B, and C together.

### First Embodiment of the Unmanned Water Vehicle

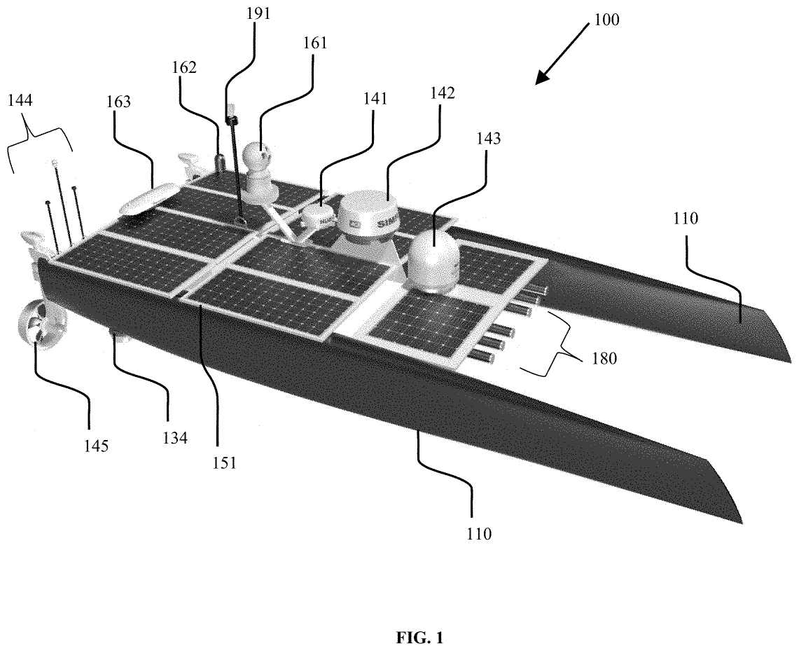

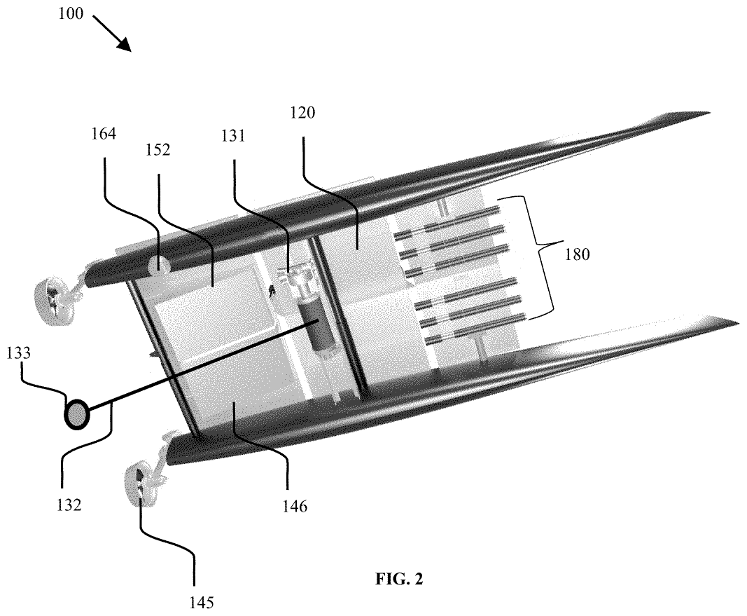

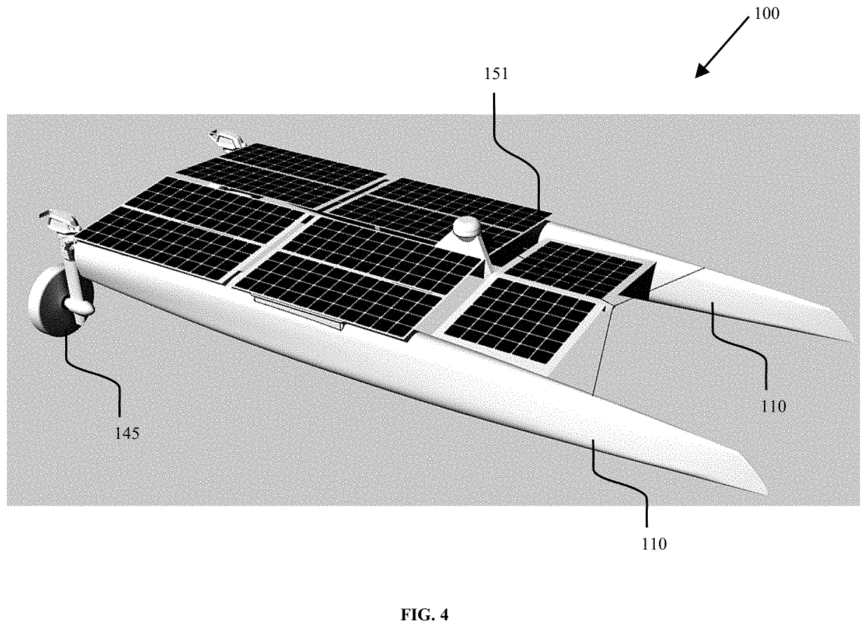

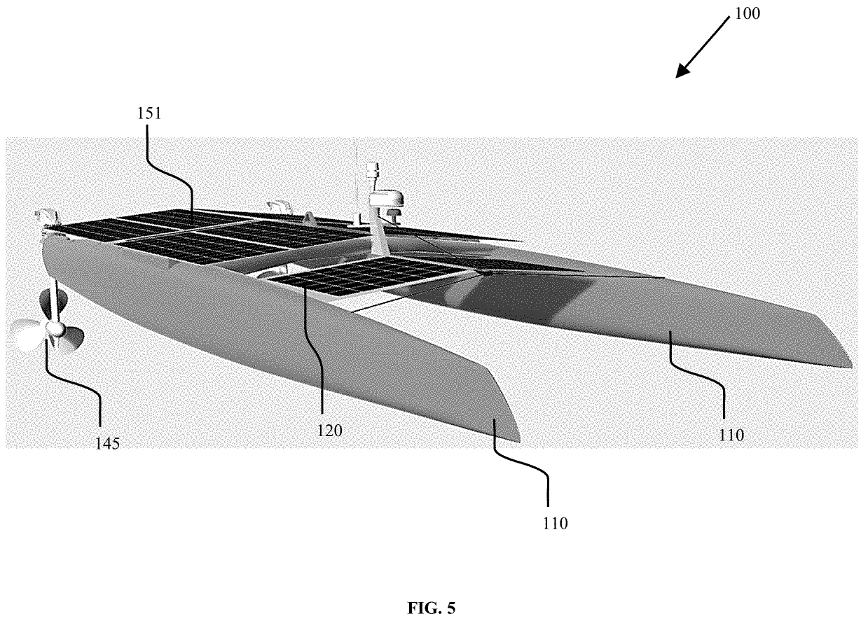

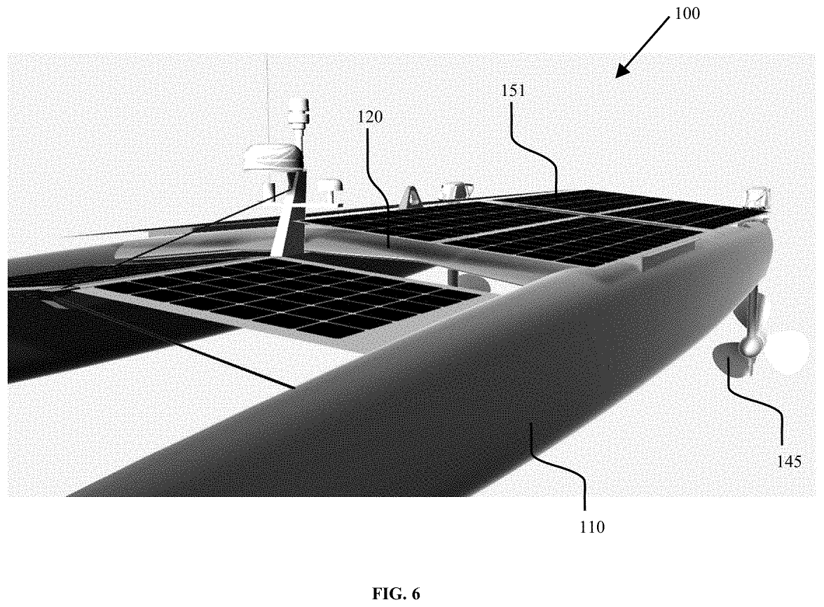

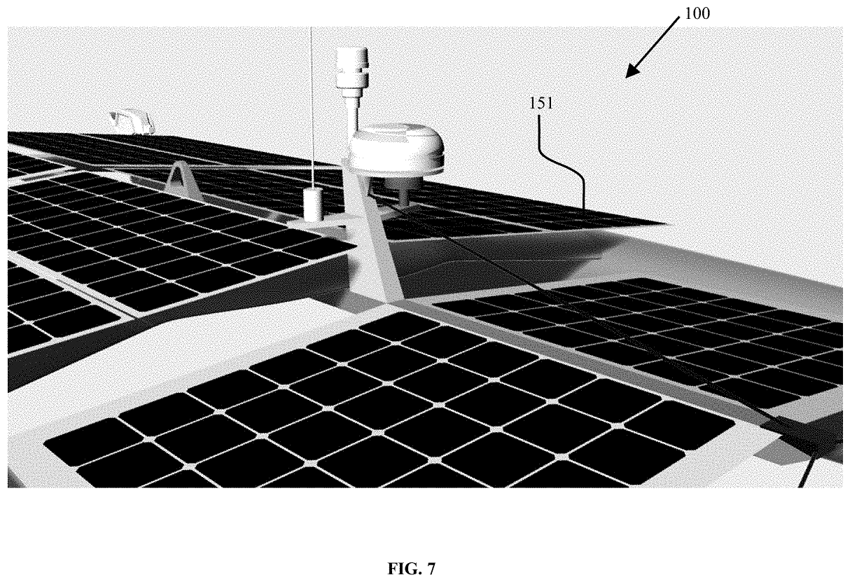

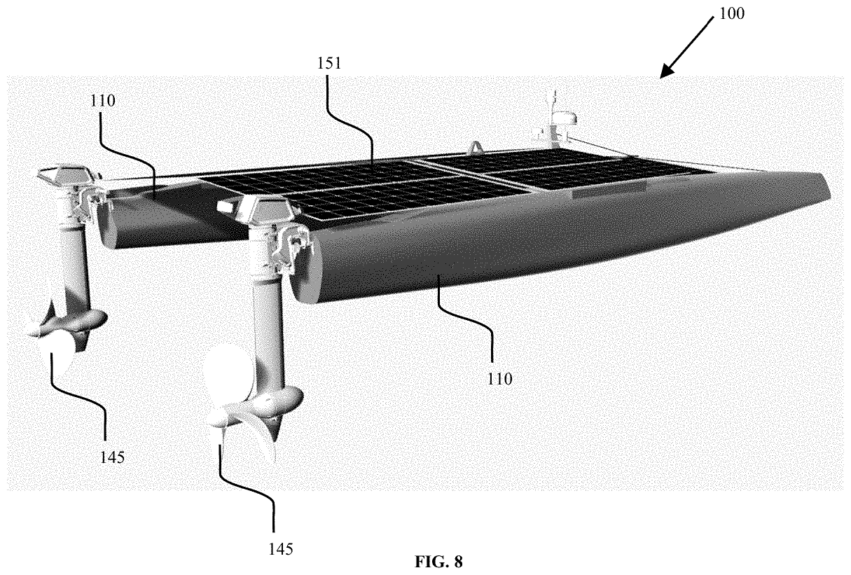

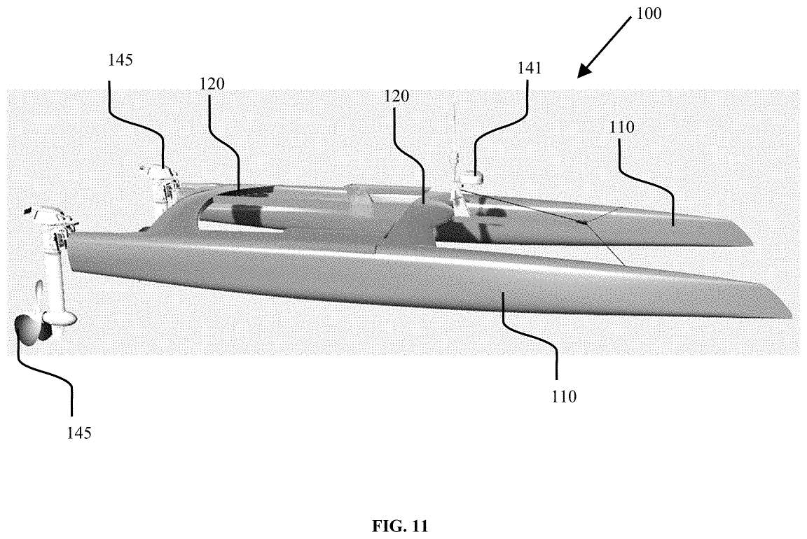

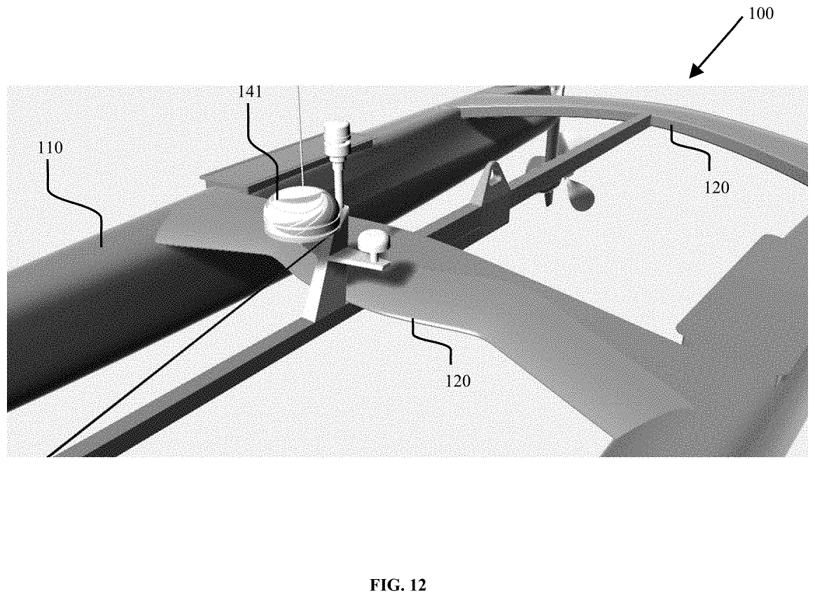

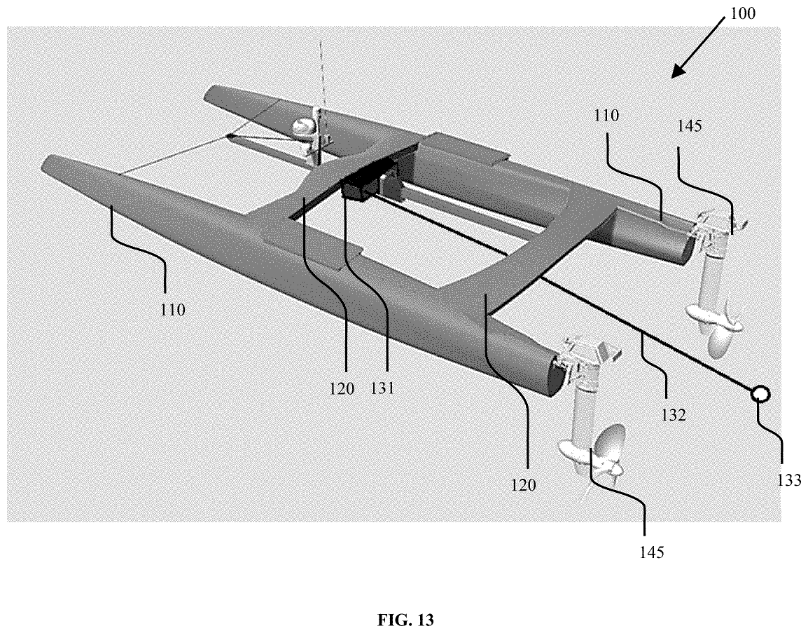

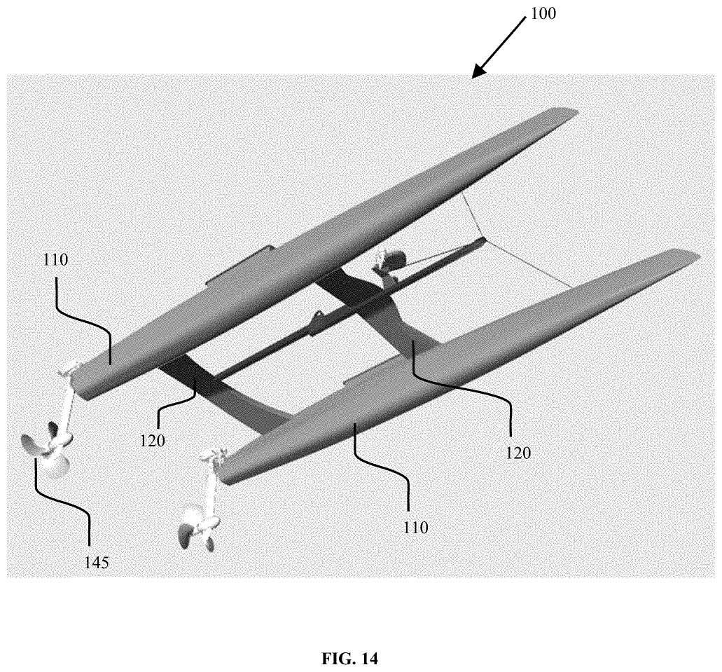

Provided herein, per FIGS. 1-14 is a first embodiment of the unmanned water vehicle 100 comprising two or more hulls 110, a deck 120 coupled between the two or more hulls 110 a communication and control system, and a power system. In some embodiments, per FIGS. 11-14, the first embodiment of the unmanned water vehicle 100 comprises two decks 120 coupled between the two or more hulls 110. In some embodiments, the first embodiment of the unmanned water vehicle 100 further comprises a retractable sensor apparatus. As shown per FIGS. 2 and 13, the retractable sensor apparatus comprises a winch 131 having a cable 132 and at least one underwater sensor 133 attached to a distal end of the cable 132. In some embodiments, the underwater sensor 133 records a sensor data. In some embodiments, the first embodiment of the unmanned water vehicle 100 further comprising a storage system to store the sensor data. In some embodiments, the storage system comprises a permanent storage system or a temporary storage system. As shown per FIG. 1, the communication and control system comprises a wireless communications device, a steerable drive apparatus 145, and a mobility and control module 146. In some embodiments, the mobility and control module 146 provides operation of the first embodiment of the unmanned water vehicle 100 in a remote piloted mode, a semi-autonomous mode, and a fully autonomous mode. As shown in FIGS. 1, 2, and 4-8, the power system comprises one or more solar panels 151 and an energy storage device 152. In some embodiments, the energy storage device 152 receives and stores energy from the one or more solar panels 151.

In some embodiments, the first embodiment of the unmanned water vehicle 100 has a continuous operation period of at least 3 months. In some embodiments, the specific power systems, communication and control systems, and sensors herein enable continuous operation of the first embodiment of the unmanned water vehicle 100 for a period of at least 3 months. In some embodiments, the first embodiment of the unmanned water vehicle 100 operates independently for about 30 days to about 120 days. The continuous operation period of the first embodiment of the unmanned water vehicle 100 herein enables longer uninterrupted monitoring periods for more complete data collection without the need for human maintenance.

In some embodiments, the first embodiment of the unmanned water vehicle 100 has a sea state capability of 3, 4, 5, 6, or 7. The sea state capability indicates a class condition of a free surface on a large body of water withstood by a vessel with respect to wave height, wave period, and wave power spectrum. In some embodiments, the sea state is determined by a weather buoy, a wave RADAR, a remote sensing satellite, or any combination thereof. In some embodiments, the first embodiment of the unmanned water vehicle 100 can withstand wave heights of at most about 20, 19, 18, 17, 16, 15, 14, 13, 12, 11, or 10 feet. In some embodiments, the first embodiment of the unmanned water vehicle 100 can withstand a sea state capability of 3, 4, 5, 6, or 7. In some embodiments, the material of the two or more hulls 110 and the deck 120 and the weight and specific materials and components of the first embodiment of the unmanned water vehicle 100 allow it to withstand greater sea forces, for increased operational capacity and lower risks of damage or loss.

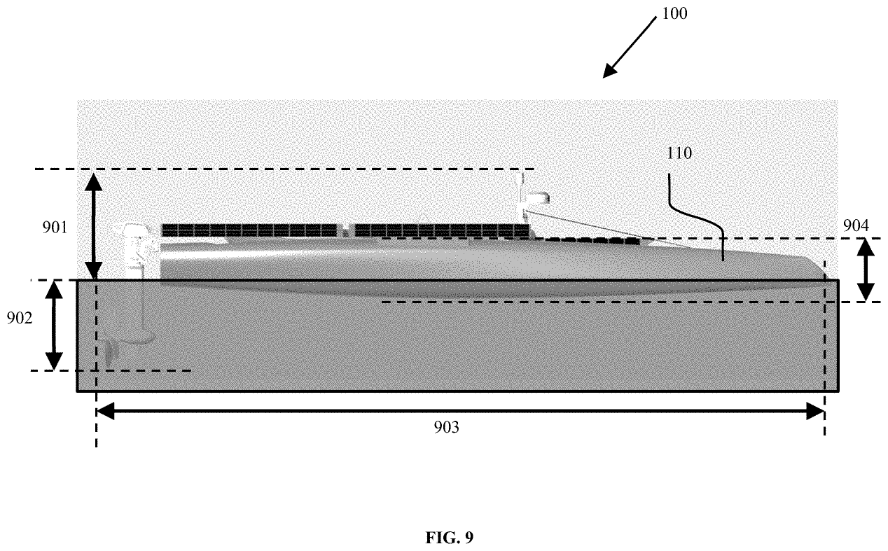

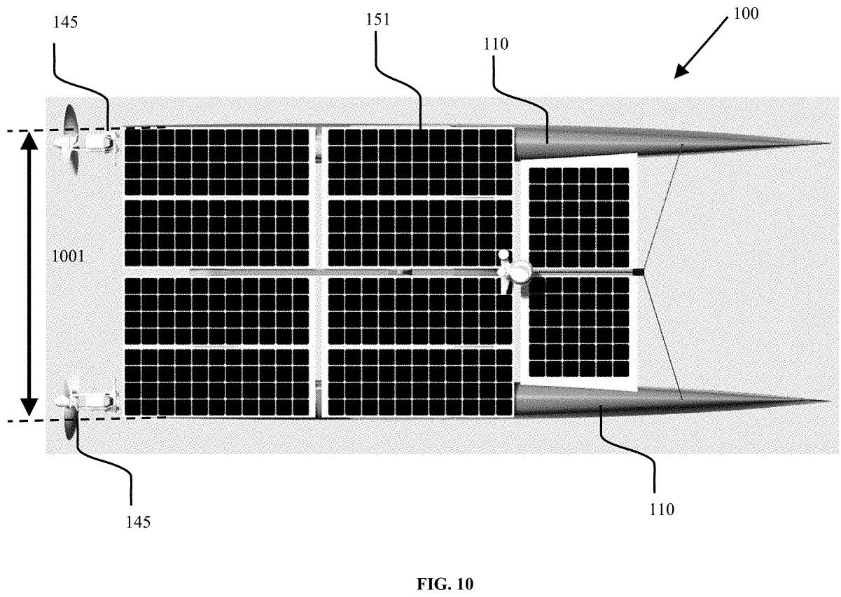

In some embodiments, per FIGS. 9 and 10, the first embodiment of the unmanned water vehicle 100 has a maximum above water height 901 of about 1 foot to about 6 feet. In some embodiments, the first embodiment of the unmanned water vehicle 100 has a maximum below water depth 902 of about 1 foot to about 6 feet. In some embodiments, the first embodiment of the unmanned water vehicle 100 has a maximum RADAR cross section of about 0.1 m² W. In some embodiments, the RADAR cross section is the measure of a target's ability to reflect RADAR signals in the direction of the RADAR receiver. In some embodiments, the RADAR cross section is a measure of the ratio of backscatter density in the direction of the RADAR from the target to the power density that is intercepted by the target. In some embodiments, the two or more hulls 110 have a length 903 of about 9 feet to about 36 feet. In some embodiments, the two or more hulls 110 have a height 904 of about 1 foot to about 6 feet. In some embodiments, a width 1001 of the two or more hulls 110 is about 3 feet to about 14 feet. In some embodiments, the above water height 901, the below water height 902, specific materials and components of the first embodiment of the unmanned water vehicle 100, or any combination thereof dictate its visibility at sea. In some embodiments, the small above water height 901, the small below water height 902, specific materials and components of the first embodiment of the unmanned water vehicle 100, or any combination thereof reduce or prevent detection during clandestine operations.

In some embodiments, the first embodiment of the unmanned water vehicle 100 has a weight of about 300 pounds to about 1,200 pounds. In some embodiments, the first embodiment of the unmanned water vehicle 100 has a towing capacity of about 20 pounds to about 80 pounds. In some embodiments, the weight of the first embodiment of the unmanned water vehicle 100, alone or in combination with the specific power systems, the steerable drive apparatus 145, or both, enables the towing capacity, the maximum speed, the operating speed, and the repositioning speed, the continuous operation period, or any combination thereof of the first embodiment of the unmanned water vehicles 100 herein. In some embodiments, the low weight of the first embodiment of the unmanned water vehicle 100, alone or in combination with the specific power systems, the steerable drive apparatus 145, or both, enables the high towing capacity, the high maximum speed, the high operating speed, the high repositioning speed, the long continuous operation period, or any combination thereof of the first embodiment of the unmanned water vehicles 100 herein. One of skill in the art will easily comprehend that the increased speeds and towing capacities expand the operational capacity of the first embodiment of the unmanned water vehicles 100 herein. In some embodiments, the first embodiment of the unmanned water vehicles 100 further comprises of one or more non-steerable drive apparatus. In some embodiments, the non-steerable drive is rotatably fixed to the first embodiment of the unmanned water vehicles 100. In some embodiments, the non-steerable drive is fixed to provide a thrust parallel to longitudinal axis of the hulls 110.

In some embodiments, the first embodiment of the unmanned water vehicle 100 has a maximum speed of about 8 knots to about 32 knots. In some embodiments, the first embodiment of the unmanned water vehicle 100 has an operating speed of about 0.5 knots to about 3 knots. In some embodiments, the first embodiment of the unmanned water vehicle 100 has a repositioning speed of about 1 knot to about 10 knots. In some embodiments, the operating speed is a maximum, minimum, or average speed that the first embodiment of the unmanned water vehicle 100 is capable of traveling while towing the underwater sensor 133 at an operating depth. In some embodiments, the repositioning speed is a maximum, minimum, or average speed that the first embodiment of the unmanned water vehicle 100 is capable of traveling while towing the underwater sensor 133 at a depth shallower than the operating depth. In some embodiments, the repositioning speed is a maximum, minimum, or average speed that the first embodiment of the unmanned water vehicle 100 is capable of traveling while the underwater sensor 133 is above water.

In some embodiments, per FIG. 1, the first embodiment of the unmanned water vehicle 100 further comprises a navigation light 191. In some embodiments, the first embodiment of the unmanned water vehicle 100 further comprises a ballast system. In some embodiments, the ballast system comprises a ballast tank, a ballast pump, a ballast valve, or any combination thereof.

In some embodiments, the two or more hulls 110 comprise 2, 3, 4, 5, 6, 7, 8, 9, 10 or more hulls. In some embodiments, the unmanned water vehicle 100 comprises 2, 3, 4, 5, 6, 7, 8, 9, 10 or more decks 120. In some embodiments, at least one of the two or more hulls 110 and the deck 120 are formed of aluminum, steel, stainless steel, carbon fiber, fiberglass, fabric, wood, plastic, or any combination thereof. In some embodiments, the two or more hulls 110 comprise carbon-fiber honeycomb hulls 110. In some embodiments, the interior of the honeycomb hull is formed of a material having a cross-sectional honeycomb pattern.

In some embodiments, the material of the two or more hulls 110 and the deck 120 determines the weight of the unmanned water vehicles 100 herein. In some embodiments, the material of the two or more hulls 110 and the deck 120 enable the low weight of the unmanned water vehicles 100 herein. In some embodiments, the two or more hulls 110 and the deck 120 weigh about 50 pounds to about 200 pounds. In some embodiments, one or more of the hulls 100 comprises a lifting point. In some embodiments, the deck 120 comprises a lifting point. In some embodiments, one or more of the hulls 100 and the deck 120 comprise a lifting point. In some embodiments, the unmanned water vehicle 100 comprises 2, 3, 4, 5, 6, 7, 8 or more lifting points. In some embodiments, the lifting point comprises a flange, a clip, a carabiner, a hole, or any combination thereof. In some embodiments, the lifting point is configured to receive a rope or cable to lift the unmanned water vehicle 100.

### Second Embodiment of the Unmanned Water Vehicle

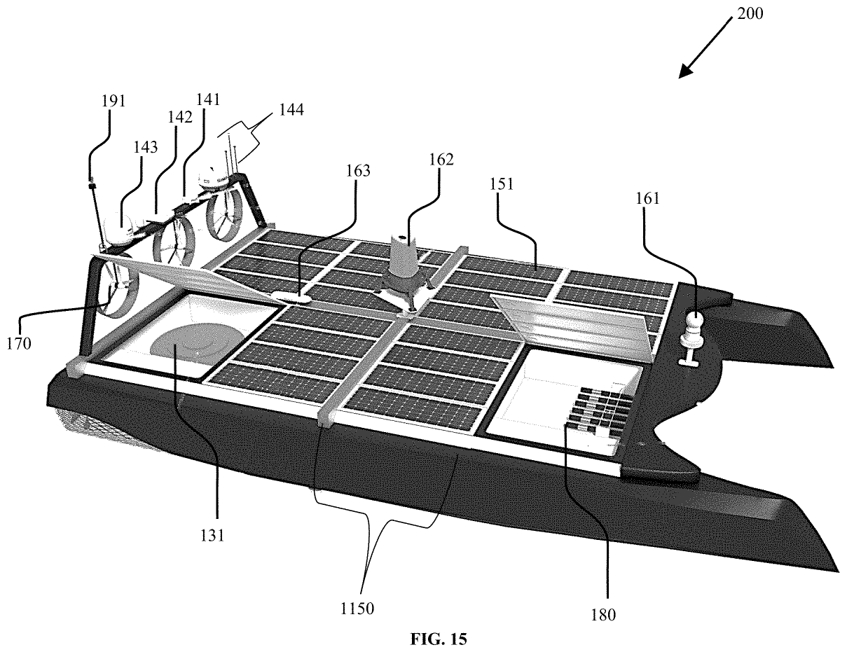

Provided herein, per FIGS. 15-19 is a second embodiment of the unmanned water vehicle 200 comprising two or more hulls 110, a deck 120 coupled between the two or more hulls 110 a communication and control system, and a power system. In some embodiments, the second embodiment of the unmanned water vehicle 200 comprises two decks 120 coupled between the two or more hulls 110. In some embodiments, the second embodiment of the unmanned water vehicle 200 further comprises a retractable sensor apparatus. As shown per FIG. 15, the retractable sensor apparatus comprises a winch 131 having a cable 132 and at least one underwater sensor 133 attached to a distal end of the cable 132. In some embodiments, the underwater sensor 133 records a sensor data. In some embodiments, the second embodiment of the unmanned water vehicle 200 further comprises a storage system to store the sensor data. In some embodiments, the storage system comprises a permanent storage system or a temporary storage system. In some embodiments, the communication and control system comprises a wireless communications device, a steerable drive apparatus 145, and a mobility and control module 146. In some embodiments, the mobility and control module 146 provides operation of the second embodiment of the unmanned water vehicle 200 in a remote piloted mode, a semi-autonomous mode, and a fully autonomous mode. In some embodiments, the power system comprises one or more solar panels 151 and an energy storage device 152. In some embodiments, the energy storage device 152 receives and stores energy from the one or more solar panels 151.

In some embodiments, the second embodiment of the unmanned water vehicle 200 has a continuous operation period of at least 3 months. In some embodiments, the specific power systems, communication and control systems, and sensors herein enable continuous operation of the second embodiment of the unmanned water vehicle 200 for a period of at least 3 months. In some embodiments, the second embodiment of the unmanned water vehicle 200 operates independently for about 30 days to about 120 days. The continuous operation period of the second embodiment of the unmanned water vehicle 200 herein enables longer uninterrupted monitoring periods for more complete data collection without the need for human maintenance.

In some embodiments, the second embodiment of the unmanned water vehicle 200 has a sea state capability of 3, 4, 5, 6, or 7. The sea state capability indicates a class condition of a free surface on a large body of water withstood by a vessel with respect to wave height, wave period, and wave power spectrum. In some embodiments, the sea state is determined by a weather buoy, a wave RADAR, a remote sensing satellite, or any combination thereof. In some embodiments, the second embodiment of the unmanned water vehicle 200 can withstand wave heights of at most about 20, 19, 18, 17, 16, 15, 14, 13, 12, 11, or 10 feet. In some embodiments, the second embodiment of the unmanned water vehicle 200 can withstand a sea state capability of 3, 4, 5, 6, or 7. In some embodiments, the material of the two or more hulls 110 and the deck 120 and the weight and specific materials and components of the second embodiment of the unmanned water vehicle 200 allow it to withstand greater sea forces, for increased operational capacity and lower risks of damage or loss.

In some embodiments, the second embodiment of the unmanned water vehicle 200 has a maximum above water height of about 1 foot to about 6 feet. In some embodiments, the second embodiment of the unmanned water vehicle has a maximum below water depth of about 1 foot to about 6 feet. In some embodiments, the second embodiment of the unmanned water vehicle has a maximum RADAR cross section of about 0.1 m² W. In some embodiments, the RADAR cross section is the measure of a target's ability to reflect RADAR signals in the direction of the RADAR receiver. In some embodiments, the RADAR cross section is a measure of the ratio of backscatter density in the direction of the RADAR from the target to the power density that is intercepted by the target. In some embodiments, the two or more hulls 110 have a length of about 9 feet to about 36 feet. In some embodiments, the two or more hulls 110 have a height of about 1 foot to about 6 feet. In some embodiments, a width 2001 of the two or more hulls 110 is about 3 feet to about 14 feet. In some embodiments, the above water height, the below water height, specific materials and components of the second embodiment of the unmanned water vehicle 200, or any combination thereof dictate its visibility at sea. In some embodiments, the small above water height, the small below water height, specific materials and components of the second embodiment of the unmanned water vehicle 200, or any combination thereof reduce or prevent detection during clandestine operations.

In some embodiments, the second embodiment of the unmanned water vehicle 200 has a weight of about 300 pounds to about 1,200 pounds. In some embodiments, the second embodiment of the unmanned water vehicle 200 has a towing capacity of about 20 pounds to about 80 pounds. In some embodiments, the weight of the second embodiment of the unmanned water vehicle 200, alone or in combination with the specific power systems, the steerable drive apparatus 145, or both, enables the towing capacity, the maximum speed, the operating speed, and the repositioning speed, the continuous operation period, or any combination thereof of the second embodiment of the unmanned water vehicles 200 herein. In some embodiments, the low weight of the second embodiment of the unmanned water vehicle 200, alone or in combination with the specific power systems, the steerable drive apparatus 145, or both, enables the high towing capacity, the high maximum speed, the high operating speed, the high repositioning speed, the long continuous operation period, or any combination thereof of the second embodiment of the unmanned water vehicles 200 herein. One of skill in the art will easily comprehend that the increased speeds and towing capacities expand the operational capacity of the second embodiment of the unmanned water vehicles 200 herein. In some embodiments, the second embodiment of the unmanned water vehicles 200 further comprises of one or more non-steerable drive apparatus. In some embodiments, the non-steerable drive is rotatably fixed to the second embodiment of the unmanned water vehicles 200. In some embodiments, the non-steerable drive is fixed to provide a thrust parallel to longitudinal axis of the hulls 110.

In some embodiments, the second embodiment of the unmanned water vehicle 200 has a maximum speed of about 8 knots to about 32 knots. In some embodiments, the second embodiment of the unmanned water vehicle 200 has an operating speed of about 0.5 knots to about 3 knots. In some embodiments, the second embodiment of the unmanned water vehicle 200 has a repositioning speed of about 1 knot to about 10 knots. In some embodiments, the operating speed is a maximum, minimum, or average speed that the second embodiment of the unmanned water vehicle 200 is capable of traveling while towing the underwater sensor 133 at an operating depth. In some embodiments, the repositioning speed is a maximum, minimum, or average speed that the second embodiment of the unmanned water vehicle 200 is capable of traveling while towing the underwater sensor 133 at a depth shallower than the operating depth. In some embodiments, the repositioning speed is a maximum, minimum, or average speed that the second embodiment of the unmanned water vehicle 200 is capable of traveling while the underwater sensor 133 is above water.

In some embodiments, per FIG. 15, the second embodiment of the unmanned water vehicle 200 further comprises a navigation light 191. In some embodiments, the second embodiment of the unmanned water vehicle 200 further comprises a ballast system. In some embodiments, the ballast system comprises a ballast tank, a ballast pump, a ballast valve, or any combination thereof.

In some embodiments, the two or more hulls 110 of the second embodiment of the unmanned water vehicle 200 comprise 2, 3, 4, 5, 6, 7, 8, 9, 10 or more hulls. In some embodiments, the unmanned water vehicle 100 comprises 2, 3, 4, 5, 6, 7, 8, 9, 10 or more decks 120. In some embodiments, at least one of the two or more hulls 110 and the deck 120 are formed of aluminum, steel, stainless steel, carbon fiber, fiberglass, fabric, wood, plastic, or any combination thereof. In some embodiments, the two or more hulls 110 comprise carbon-fiber honeycomb hulls 110. In some embodiments, the interior of the honeycomb hull is formed of a material having a cross-sectional honeycomb pattern.

In some embodiments, the material of the two or more hulls 110 and the deck 120 determines the weight of the unmanned water vehicles 100 herein. In some embodiments, the material of the two or more hulls 110 and the deck 120 enable the low weight of the unmanned water vehicles 100 herein. In some embodiments, the two or more hulls 110 and the deck 120 weigh about 50 pounds to about 200 pounds.

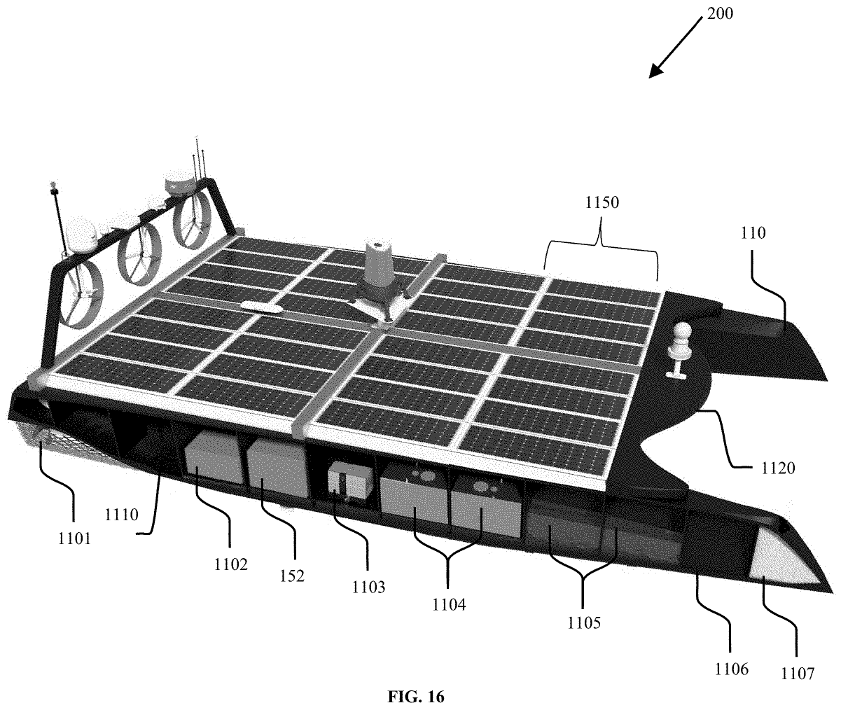

In some embodiments, per FIG. 16, one or more of the two or more hulls 110 of the second embodiment of the unmanned water vehicle 200 comprises a plurality of internal cavities 1110. In some embodiments, each of the internal cavities 1110 has an inner width of about 18 inches to about 72 inches. In some embodiments, one or more of the two or more hulls 110 comprises 3, 4, 5, 6, 7, 8, 9, 10, 11, 12, 13, 14, 15, 16 or more internal cavities 1110. In some embodiments, one or more of the plurality of internal cavities 1110 houses one or more of an energy storage device 152, an electronics package 1102, a diesel generator 1103, a diesel tank 1104. In some embodiments, the energy storage device 152 has a power of about 20 kW to about 60 kW. In some embodiments, one or more of the plurality of internal cavities 1110 is a water-tight crash bulkhead 1106. In some embodiments, one or more of the plurality of internal cavities 1110 is filled with an impact foam 1107.

In some embodiments, one or more of the two or more hulls 110 the deck 120, or both further comprises a ballast system. In some embodiments, the ballast system comprises a ballast tank 1106, a ballast pump, a ballast valve, or any combination thereof. In some embodiments, the ballast tank 1105 has a capacity of about 50 gallons to about 200 gallons. In some embodiments, the unmanned water vehicle 100 further comprises a fixed ballast keel, a deployable ballast keel, or both. At least one of the ballast, the fixed ballast keel, the deployable ballast keel maintains stability of the unmanned water vehicle 100 during sensor data collection, inclement weather, or both.

In some embodiments, one or more of the hulls 100 comprises a lifting point. In some embodiments, the deck 120 comprises a lifting point. In some embodiments, one or more of the hulls 100 and the deck 120 comprise a lifting point. In some embodiments, the unmanned water vehicle 100 comprises 2, 3, 4, 5, 6, 7, 8 or more lifting points. In some embodiments, the lifting point comprises a flange, a clip, a carabiner, a hole, or any combination thereof. In some embodiments, the lifting point is configured to receive a rope or cable to lift the unmanned water vehicle 100.

In some embodiments, per FIG. 15, the deck 120 comprises a wave breaker 1120 in a forward position on the unmanned water vehicle 100. In some embodiments, the wave breaker 1120 enables smoother operation of the unmanned water vehicle 100 in heavy seas and/or clears water splash from decks to enable more efficient operation. In some embodiments, the specific size and/or shape of wave breaker 1120 enables smoother operation of the unmanned water vehicle 100 in heavy Seas and/or clears water/splash from decks to enable more efficient operation. In some embodiments, the wave breaker 1120 removably couples to one or more of the hulls 110, the deck 120, or both. In some embodiments, the wave breaker 1120 removably couples to one or more of the hulls 110, the deck 120, or both via a nut, a bolt, a screw, a tie, a hook, a clasp, a clamp, a pin, a slot, or any combination thereof.

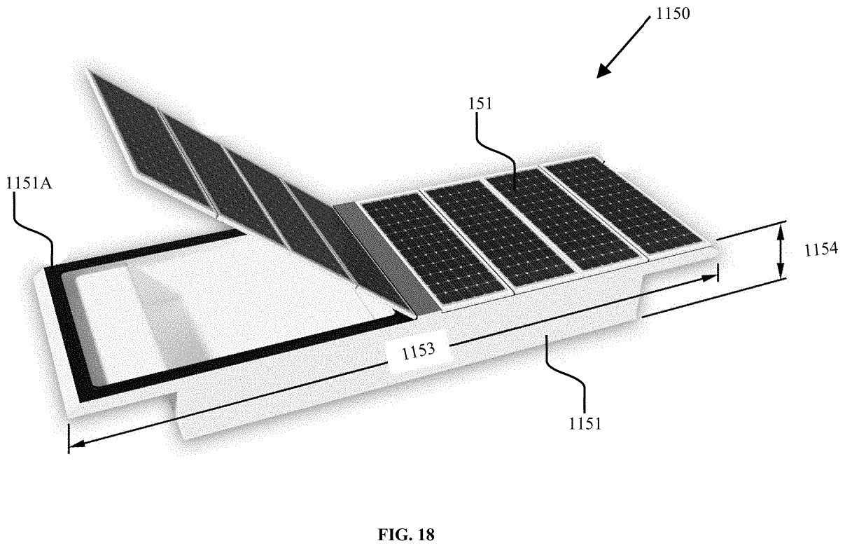

In some embodiments, per FIGS. 15-18 the deck 120 is formed of a plurality of payload modules 1150. As shown the deck 120 is formed of 4 payload modules 1150. Alternatively, in some embodiments, the deck 120 is formed of 2, 3, 5, 6, 7, 8, 9, 10, or more payload modules 1150. In some embodiments, each payload module 1150 removably couples to another payload module 1150, at least one hull 110, or both. In some embodiments, each payload module 1150 removably couples to another payload module 1150, at least one hull 110, or both via a nut, a bolt, a screw, a tie, a hook, a clasp, a clamp, a pin, a slot, or any combination thereof. Per FIG. 18, each payload module 1150 comprises a frame 1151 and the solar panel 151. As shown, each payload module 1150 comprises two solar panel 151. Alternatively, in some embodiments, each payload module 1150 comprises 1 solar panel 151 Alternatively, in some embodiments, each payload module 1150 comprises 3, 4, 5, 6, 7, 8, 9, 10 or more solar panels 151. As shown, the frame 1151 comprises a cavity for storing a payload. In some embodiments, the frame 1151 comprises a seal 1151A to seal the cavity against the solar panel 151. Further as shown, two solar panels 151 are rotatably attached to a mesial portion of the frame 1151. Alternatively, in some embodiments, the payload module 1150 comprises two or solar panels 151 wherein each solar panel 151 is rotatably attached to a distal portion of the frame 1151. In some embodiments, the solar panel 151 is removably attached to the frame 1151. In some embodiments, the solar panel 151 is permanently attached to the frame 1151. In some embodiments, the solar panel 151 is not rotatably attached to the frame 1151.

As shown in FIG. 18, the frame 1151 of the payload module 1150 has a maximum length 1153 and a maximum height 1154. In some embodiments, the maximum length 1153 is about 9 feet to about 30 feet. In some embodiments, the maximum height 1154 is about 1 foot to about 4 feet. In some embodiments, the frame 1151 of the payload module 1150 is formed of fiberglass, carbon-fiber, metal, plastic, ceramic, or any combination thereof.

### Winch

In some embodiments, the retractable sensor apparatus comprises a winch 131 having a cable 132 and at least one underwater sensor 133 attached to a distal end of the cable 132. As shown in FIGS. 2, 13, and 15 the winch 131 is coupled to an underside of the deck 120 of the first embodiment of the unmanned water vehicle 100. Per FIG. 15 the winch 131 is coupled to an underside of the deck 120 of the second embodiment of the unmanned water vehicle 200. Alternatively, in some embodiments, the winch 131 is further or alternatively coupled to one or more of the two or more hulls 110. In some embodiments, the winch 131 has a power of about 5 horsepower. In some embodiments, the unmanned water vehicle 100, the second embodiment of the unmanned water vehicle 200, or both comprise two or more winches 131. In some embodiments, each of the two or more winches 131 comprises a cable 132. In some embodiments, the power of the winch 131 is sufficient to overcome the drag on the cable 132 and the sensor 133 when the unmanned water vehicle 100, the second embodiment of the unmanned water vehicle 200, or both is at rest or at its maximum speed.

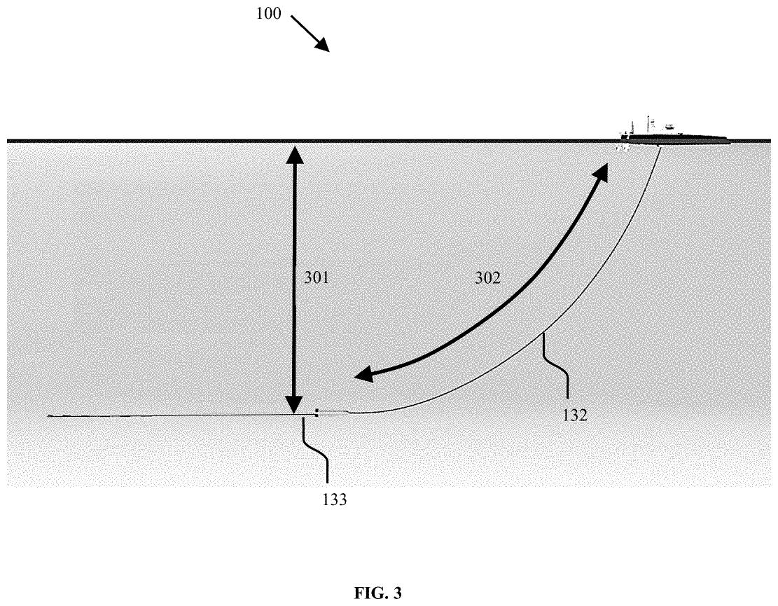

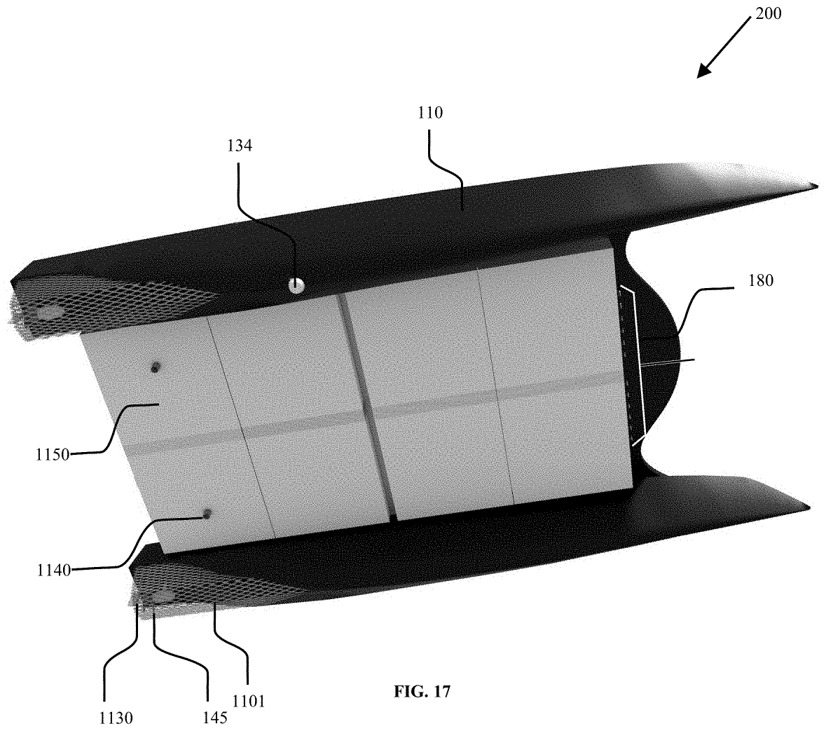

Per FIG. 3, the cable 132 has a length 302 of at least about 100 meters. In some embodiments, a length 302 of cable 132 determines the sensor depth 301. In some embodiments, longer cable lengths 302 enable greater sensor depths 301. In some embodiments, the sensor depth 301 further depends on the speed of the first embodiment of the unmanned water vehicle 100, the second embodiment of the unmanned water vehicle 200, or both. In some embodiments, the cable 132 has a maximum length 302 enabling a maximum sensor depth 301. In some embodiments, the sensor depth 301 is adjusted by the winch 131 decreasing or increasing the cable length 302. In some embodiments, longer cable lengths 302 and higher unmanned watercraft speeds increase the amount of drag and thus the required towing capacity. As such, the cable length 302 of the unmanned water vehicle 100, the second embodiment of the unmanned water vehicle 200, or both, alone or in combination with the specific power systems, the steerable drive apparatus 145, or both, enables the high operating speed, the high repositioning speed, the long continuous operation period, or any combination thereof of the unmanned water vehicles 100 herein. In some embodiments, per FIG. 15, the winch comprises a drum winch. In some embodiments, per FIG. 17, the deck 120 comprises one or more winch tubes 1140 to allow the cable 132 to pass through the deck 120.

### Sensors

As shown per FIGS. 2 and 13, the retractable sensor apparatus comprises a winch 131 having a cable 132 and at least one underwater sensor 133 attached to a distal end of the cable 132. In some embodiments, the underwater sensor 133 is removably attached to the distal end of the cable 132. In some embodiments, the at least one underwater sensor 133 comprises 2, 3, 4, 5, 6, 7, 8, 9, 10, or more sensors. In some embodiments, the at least one underwater sensor 133 comprises an array of sensors. In some embodiments, the underwater sensor 133 records a sensor data. In some embodiments, the at least one underwater sensor 133 comprises a first sensor recording a first sensor data and a second sensor recording a second sensor data different from the first sensor data.

In some embodiments, the at least one underwater sensor 133 comprises an acoustic sensor, a RADAR, a LiDAR, a thermometer, a barometer, a pitot tube, a pH meter, a salinity meter, a chemical sensor, a DNA analyzer, an acoustic modem, a conductivity sensor, a depth sensor, a wave height sensor, an inertial measurement system, a magnetic compass, a magnetometer, a GPS sensor, a camera, an infrared camera, or any combination thereof. In some embodiments, the camera comprises a 360-degree panoramic camera. In some embodiments, the underwater sensor 133 does not comprise a LiDAR.

In some embodiments, per FIG. 3, in some embodiments, the sensor depth 301 depends on the size and the weight of the sensor. In some embodiments, the sensor depth 301 further depends on the speed of the first embodiment of the unmanned water vehicle 100, the second embodiment of the unmanned water vehicle 200, or both. In some embodiments, larger sensors, heavier sensors, increased unmanned watercraft speeds, or any combination thereof increases the amount of drag and thus the required towing capacity. As such, the size and the weight of the sensor, alone, in combination, or further with respect to the specific power systems, the steerable drive apparatus 145, or both, enables the high operating speed, the high repositioning speed, the long continuous operation period, or any combination thereof of the unmanned water vehicles 100 herein.

As shown in FIGS. 1 and 17, in some embodiments, the first embodiment of the unmanned water vehicle 100, the second embodiment of the unmanned water vehicle 200, or both further comprises an underwater deck sensor 134 attached to one or more of the two or more hulls 110, the deck 120, or both. In some embodiments, the first embodiment of the unmanned water vehicle 100, the second embodiment of the unmanned water vehicle 200, or both further comprises 2, 3, 4, 5, 6, 7, 8, 9, 10 or more underwater deck sensors 134. As shown the underwater deck sensor 134 comprises an Acoustic Doppler Current Profiler (ACDP). Alternatively, in some embodiments, the underwater deck sensor 134 comprises an acoustic sensor, a RADAR, a LiDAR, a thermometer, a barometer, a pitot tube, a pH meter, a salinity meter, a chemical sensor, a DNA analyzer, an acoustic modem, a conductivity sensor, a depth sensor, a wave height sensor, a GPS sensor, a camera, an infrared camera, an inertial reference system, a magnetic compass, a magnetometer or any combination thereof. In some embodiments, the camera comprises a 360-degree panoramic camera. In some embodiments, the underwater deck sensor 134 does not comprise a LiDAR.

As seen in FIGS. 1 and 15, the first embodiment of the unmanned water vehicle 100, the second embodiment of the unmanned water vehicle 200, or both further comprises an above-water sensor coupled to one or more of the two or more hulls 110, the deck 120, or both. In some embodiments, the first embodiment of the unmanned water vehicle 100, the second embodiment of the unmanned water vehicle 200, or both further comprises 2, 3, 4, 5, 6, 7, 8, 9, 10, or more above-water sensors. As shown, the above-water sensor comprises an infrared camera 161, a LiDAR 162, and GPS sensor 163. Further, as shown, the infrared camera 161 and the GPS sensor 163 are positioned symmetrically between the two hulls 110, whereas the LiDAR 162 is positioned at the aft port side of the first embodiment of the unmanned water vehicle 100, the second embodiment of the unmanned water vehicle 200, or both. Alternatively, in some embodiments, the infrared camera 161, the GPS sensor 163, and the LiDAR 162 are positioned in any position or respective orientation on the first embodiment of the unmanned water vehicle 100, the second embodiment of the unmanned water vehicle 200, or both. In some embodiments, the position and respective orientation of the sensors on the first embodiment of the unmanned water vehicle 100, the second embodiment of the unmanned water vehicle 200, or both enable precise and accurate data collection while preventing sensor interference. In some embodiments, the sensor data recorded by one or more of the above-water sensors is adjusted based of its location on the first embodiment of the unmanned water vehicle 100, the second embodiment of the unmanned water vehicle 200, or both. Alternatively, in some embodiments, the above-water sensor comprises an acoustic sensor, a RADAR, a LiDAR, a thermometer, a barometer, a pitot tube, a pH meter, a salinity meter, a chemical sensor, a DNA analyzer, an acoustic modem, a conductivity sensor, a depth sensor, a wave height sensor, a GPS sensor, a camera, an infrared camera, an inertial reference system, a magnetic compass, a magnetometer or any combination thereof. In some embodiments, the camera comprises a 360-degree panoramic camera. In some embodiments, the above-water sensor does not comprise a LiDAR. In some embodiments, the first embodiment of the unmanned water vehicle 100, the second embodiment of the unmanned water vehicle 200, or both of FIG. 1 is configured for monitoring of offshore wind production equipment

In some embodiments, the power requirements of at least one of the underwater sensor 133 and the above-water sensor, independently or in combination with the power systems herein, enable the continuous operation of the first embodiment of the unmanned water vehicle 100, the second embodiment of the unmanned water vehicle 200, or both for a period of at least 3 months.

Per FIGS. 1, 2, and 15, the first embodiment of the unmanned water vehicle 100, the second embodiment of the unmanned water vehicle 200, or both further comprises a sensor deployment tube 180. In some embodiments, the sensor deployment tube 180 is mounted on an underside of the deck 120. In some embodiments, the sensor deployment tube 180 is mounted within the deck 120. In some embodiments, the sensor deployment tube 180 releases a tethered sensor, an untethered sensor, or both from the first embodiment of the unmanned water vehicle 100, the second embodiment of the unmanned water vehicle 200, or both at a specified time. In some embodiments, the sensor deployment tubes 180 release two or more types of tethered sensors, two or more types of untethered sensors, or both. In some embodiments, the specified time comprises a specified location. In some embodiments, the sensor deployment tube 180 is triggered by the mobility and control module 146. In some embodiments, the first embodiment of the unmanned water vehicle 100, the second embodiment of the unmanned water vehicle 200, or both comprises 5 to 20 sensor deployment tubes. In some embodiments, each of the one or more sensor deployment tubes 180 is individually triggered by the mobility and control module 146. Such individual control allows for distributed sensor placement. In some embodiments, the first embodiment of the unmanned water vehicle 100, the second embodiment of the unmanned water vehicle 200, or both comprises 5, 6, 7, 8, 9, 10, 11, 12, 13, 14, 15, 16, 17, 18, 19, 20, or more sensor deployment tubes. In some embodiments, the first embodiment of the unmanned water vehicle 100, the second embodiment of the unmanned water vehicle 200, or both comprises at least 5, 6, 7, 8, 9, 10, 11, 12, 13, 14, 15, 16, 17, 18, 19, 20, or more sensor deployment tubes. In some embodiments, the sensor deployment tubes 180 have a length of about 15 inches to about 140 inches. In some embodiments, the sensor deployment tubes 180 comprise one or more tubes having a length of about 36 inches, one or more tubes having a length of about 72 inches, or both. In some embodiments, the sensor deployment tubes 180 have a diameter of about 1 inch to about 6 inches. In some embodiments, the size and number of the sensor deployment tubes 180 determines the size and number of sensors that can be temporarily stored within and released upon command. In some embodiments, at least a portion of the sensor tube 180 lies underwater while the first embodiment of the unmanned water vehicle 100, the second embodiment of the unmanned water vehicle 200, or both is in operation. In some embodiments, at least a portion of the sensor tube 180 lies above water while the first embodiment of the unmanned water vehicle 100, the second embodiment of the unmanned water vehicle 200, or both is in operation.

In some embodiments, at least one of the underwater sensors 133, the underwater deck sensors 134, and the above water sensors unmanned water vehicle 100 are configured for a specific purpose of the first embodiment of the unmanned water vehicle 100, the second embodiment of the unmanned water vehicle 200, or both. In some embodiments, the first embodiment of the unmanned water vehicle 100, the second embodiment of the unmanned water vehicle 200, or both is configured for monitoring of offshore wind production equipment wherein at least one of the underwater sensors 133, the underwater deck sensors 134, and the above water sensors comprise an infrared camera, a LiDAR, and a sensor, and wherein the wireless communications device comprises an Inmarsat Broadband Global Area Network (BGAN) SATCOM device, a cellular device, a Very Small Aperture Terminal (VSAT), and an antenna array. In some embodiments, the first embodiment of the unmanned water vehicle 100, the second embodiment of the unmanned water vehicle 200, or both is configured for national security monitoring, wherein at least one of the underwater sensors 133, the underwater deck sensors 134, and the above water sensors comprise a RADAR, a RADAR intercept, a RADAR transponder, a sonar array, a laser range finder, a laser target identifier, an acoustic modem, and a communications intercept. In some embodiments, the first embodiment of the unmanned water vehicle 100, the second embodiment of the unmanned water vehicle 200, or both configured for national security monitoring does not comprise a LiDAR. In some embodiments, the first embodiment of the unmanned water vehicle 100, the second embodiment of the unmanned water vehicle 200, or both is configured for oil and gas equipment monitoring, wherein at least one of the underwater sensors 133, the underwater deck sensors 134, and the above water sensors comprise an ACDP, a chemical sensor, a DNA analyzer, an acoustic modem, and an acoustic array.

### Drive Apparatus

As shown in FIGS. 1, 2, and 4-14, in some embodiments, the steerable drive apparatus 145 is coupled to the deck 120, the two or more hulls 110, or both. As shown, the first embodiment of the unmanned water vehicle 100, the second embodiment of the unmanned water vehicle 200, or both comprises two steerable drive apparatus 145. Alternatively, in some embodiments, the first embodiment of the unmanned water vehicle 100, the second embodiment of the unmanned water vehicle 200, or both comprises 3, 4, 5, 6, 7, 8, 9, 10, or more steerable drive apparatus 145. As shown the two steerable drive apparatus 145 are coupled to an aft portion of the first embodiment of the unmanned water vehicle 100, the second embodiment of the unmanned water vehicle 200, or both. Alternatively, in some embodiments, the two or more steerable drive apparatus 145 are arranged in any pattern or orientation on the first embodiment of the unmanned water vehicle 100, the second embodiment of the unmanned water vehicle 200, or both. In some embodiments, the steerable drive apparatus 145 comprises an electric, hydraulic, pneumatic, ocean-assisted, or servo-steerable drive apparatus. In some embodiments, the steerable drive apparatus 145 comprises a propeller, a ducted propeller, a propulsor, a rudder, a waterjet, an azimuth drive, or any combination thereof. In some embodiments, the steerable drive apparatus 145 is steerable about a vertical axis. In some embodiments, the steerable drive apparatus 145 is steerable within about 180 degrees about the vertical axis. In some embodiments, the steerable drive apparatus 145 is steerable about 2 or more axes.

In some embodiments, the steerable drive apparatus 145 operates on a current of about 200 amps to about 800 amps. In some embodiments, the steerable drive apparatus 145 requires a power of about 1,000 W to about 5,000 W. In some embodiments, the steerable propeller outputs a power at a speed of 1 knot of about 150 W to about 1,600 W. In some embodiments, the steerable drive apparatus 145 has a power efficiency of about 40% to about 80%. In some embodiments, the steerable drive apparatus 145 requires a voltage of about 20 V to about 100 V. In some embodiments, the steerable drive apparatus 145 produces a thrust of about 90 pounds to about 380 pounds. In some embodiments, the steerable drive apparatus 145 produces a thrust of about 4 horsepower to about 50 horsepower. In some embodiments, the current, voltage, power, efficiency, thrust, or any combination thereof of the steerable drive apparatus 145, alone, in combination, or further with respect to the specific power systems, sensors, hull 110, and deck 120 materials, or any combination thereof, enables the high towing capacity, the high maximum speed, the high operating speed, the high repositioning speed, the long continuous operation period, or any combination thereof of the unmanned water vehicles 100 herein.

In some embodiments, the steerable drive apparatus 145 is coupled to the deck 120, the two or more hulls 110, or both via a vertically rotatable coupling. In some embodiments, the vertically rotatable coupling enables at least a portion of the steerable drive apparatus 145 to rotate from a position below one or more of the two or more hulls 110, to a position above one or more of the two or more hulls 110. In some embodiments, the vertically rotatable coupling enables at least a portion of the steerable drive apparatus 145 to rotate about an axis parallel to the steerable drive apparatus's 145 axis of thrust. In some embodiments, the vertically rotatable coupling enables at least a portion of the steerable drive apparatus 145 to rotate about an axis perpendicular to the steerable drive apparatus's 145 axis of thrust. In some embodiments, the rotatable coupling enables the vehicle 100 to be towed on a standard trailer. In some embodiments, the rotatable coupling enables the vehicle 100 to be towed on a standard trailer without damaging the vehicle.

In some embodiments, the first embodiment of the unmanned water vehicle 100, the second embodiment of the unmanned water vehicle 200, or both further comprises a non-steerable drive apparatus. In some embodiments, the first embodiment of the unmanned water vehicle 100, the second embodiment of the unmanned water vehicle 200, or both comprises 3, 4, 5, 6, 7, 8, 9, 10, or more non-steerable drive apparatus 145. As shown the two non-steerable drive apparatus 145 are coupled to an aft portion of the first embodiment of the unmanned water vehicle 100, the second embodiment of the unmanned water vehicle 200, or both. Alternatively, in some embodiments, the two or more non-steerable drive apparatus 145 are arranged in any pattern or orientation on the first embodiment of the unmanned water vehicle 100, the second embodiment of the unmanned water vehicle 200, or both. In some embodiments, the non-steerable drive apparatus 145 comprises an electric, hydraulic, pneumatic, ocean-assisted, or servo non-steerable drive apparatus.

In some embodiments, per FIG. 17, the non-steerable drive apparatus 145 comprises a rudder 1130. Alternatively, in some embodiments, the non-steerable drive apparatus 145 comprises a propeller, a ducted propeller, a propulsor, a rudder, a waterjet, an azimuth drive, or any combination thereof. In some embodiments, the second embodiment of the unmanned water vehicle 200 comprises two or more non-steerable drive apparatus 145, wherein the second embodiment of the unmanned water vehicle 200 is steered by differential thrust between the two or more non-steerable drive apparatus 145. Further, per FIGS. 16 and 17, in some embodiments, the non-steerable drive apparatus 145 is at least partially encapsulated by a hydro gate 1101. Alternatively, in some embodiments, the non-steerable drive apparatus 145 is not encapsulated by a hydro gate 1101. In some embodiments, the hydro gate 1101 protects the non-steerable drive apparatus 145 from damage due to debris in its environment.

In some embodiments, the non-steerable drive apparatus operates on a current of about 200 amps to about 800 amps. In some embodiments, the non-steerable drive apparatus requires a power of about 1,000 W to about 5,000 W. In some embodiments, the non-steerable propeller outputs a power at a speed of 1 knot of about 150 W to about 1,600 W. In some embodiments, the non-steerable drive apparatus has a power efficiency of about 40% to about 80%. In some embodiments, the non-steerable drive apparatus requires a voltage of about 20 V to about 100 V. In some embodiments, the non-steerable drive apparatus produces a thrust of about 90 pounds to about 380 pounds. In some embodiments, the non-steerable drive apparatus produces a thrust of about 4 horsepower to about 50 horsepower. In some embodiments, the current, voltage, power, efficiency, thrust, or any combination thereof of the non-steerable drive apparatus, alone, in combination, or further with respect to the specific power systems, sensors, hull 110, and deck 120 materials, or any combination thereof, enables the high towing capacity, the high maximum speed, the high operating speed, the high repositioning speed, the long continuous operation period, or any combination thereof of the unmanned water vehicles 100 herein.

In some embodiments, the non-steerable drive apparatus is coupled to the deck 120, the two or more hulls 110, or both via a vertically rotatable coupling. In some embodiments, the vertically rotatable coupling enables at least a portion of the non-steerable drive apparatus to rotate from a position below one or more of the two or more hulls 110, to a position above one or more of the two or more hulls 110. In some embodiments, the rotatable coupling enables the vehicle 100 to be towed on a standard trailer. In some embodiments, the rotatable coupling enables the vehicle 100 to be towed on a standard trailer without damaging the vehicle.

### Mobility and Control Module

As shown in FIG. 2, the mobility and control module 146 is mounted to a bottom surface of the deck 120 of the first embodiment of the unmanned water vehicle 100, the second embodiment of the unmanned water vehicle 200, or both. Alternatively, in some embodiments, the mobility and control module 146 is mounted to any other surface of the deck 120, the hull 110, or any combination thereof of the first embodiment of the unmanned water vehicle 100, the second embodiment of the unmanned water vehicle 200, or both. In some embodiments, the mobility and control module 146 commands the steerable drive apparatus 145 the non-steerable drive apparatus, or both based on a heading, a position, or both. In some embodiments, the mobility and control module 146 commands the speed, the direction, or both of the steerable drive apparatus 145 based on a heading, a position, or both. In some embodiments, the mobility and control module 146 independently commands two or more of the steerable drive apparatus 145 based on a heading, a position, or both.

In some embodiments, the heading comprises a direction, a speed, or both. In some embodiments, the mobility and control module 146 comprises a Real-Time Kinematic GPS, a gyrocompass, a magnetic compass, or any combination thereof. In some embodiments, the mobility and control module 146 commands the winch 131 to retract the cable 132 and extend the cable 132. In some embodiments, the mobility and control module 146 commands the winch 131 to retract the cable 132 by a retraction distance. In some embodiments, the mobility and control module 146 commands the winch 131 to extend the cable 132 by an extension distance.

In some embodiments, the mobility and control module 146 provides operation of the first embodiment of the unmanned water vehicle 100, the second embodiment of the unmanned water vehicle 200, or both in a remote piloted mode, a semi-autonomous mode, and a fully autonomous mode. In some embodiments, operation of the first embodiment of the unmanned water vehicle 100, the second embodiment of the unmanned water vehicle 200, or both in at least one of the semi-autonomous mode and the fully autonomous mode comprises automatic obstacle avoidance. In some embodiments, at least one of the direction of the steerable drive apparatus 145 and the direction of the winch 131 are performed by a human operator in the semi-autonomous mode. In some embodiments, neither the direction of the steerable drive apparatus 145 nor the direction of the winch 131 are performed by a human operator in the fully-autonomous mode.

### Wireless Communications Device

As shown in FIGS. 1 and 15, the wireless communications device comprises an Inmarsat Broadband Global Area Network (BGAN) SATCOM device 141, a cellular device 142, a Very Small Aperture Terminal (VSAT) 143, and an antenna array 144. In some embodiments, the antenna array 144 comprises a High Frequency (HF) antenna, a Very High Frequency (VHF) antenna, a weather station, or any combination thereof. Alternatively, in some embodiments, the wireless communications device comprises a Wi-Fi device, a 5G cellular device, an Iridium Short Burst Data device, an Iridium Router-Based Unrestricted Digital Internetworking Connectivity Solutions device, or any combination thereof. In some embodiments, the wireless communications device comprises 2, 3, 4, 5, 6, 7, 8, 9, 10, or more wireless communications devices. In some embodiments, the first embodiment of the unmanned water vehicle 100, the second embodiment of the unmanned water vehicle 200, or both of FIG. 1 is configured for monitoring of offshore wind production equipment

Further, as shown, the Inmarsat Broadband Global Area Network (BGAN) SATCOM device 141, the cellular device 142, and the Very Small Aperture Terminal (VSAT) 143 are positioned symmetrically between the two hulls 110, whereas the antenna array 144 is positioned at the aft side of the first embodiment of the unmanned water vehicle 100, the second embodiment of the unmanned water vehicle 200, or both. Alternatively, in some embodiments, the Inmarsat Broadband Global Area Network (BGAN) SATCOM device 141, the cellular device 142, the Very Small Aperture Terminal (VSAT) 143, and the antenna array 144 are positioned in any position or respective orientation on the first embodiment of the unmanned water vehicle 100, the second embodiment of the unmanned water vehicle 200, or both. In some embodiments, the position and respective orientation of the wireless communication devices on the first embodiment of the unmanned water vehicle 100, the second embodiment of the unmanned water vehicle 200, or both enable precise and accurate communications while preventing interference. In some embodiments, the wireless communication device transmits the sensor data.

In some embodiments, the wireless communication device receives the command from a handheld remote control, a fixed remote control, or both. In some embodiments, the command comprises a waypoint, a speed, a heading, a thrust output, a motor position, a motor differential thrust, or any combination thereof. In some embodiments, the handheld remote control, the fixed remote control, or both further receive a RADAR data, an AIS data, a LiDAR data, a computer vision data, or a data from any other sensor in its communication. In some embodiments, the command further comprises the RADAR data, AIS data, LiDAR data, computer vision data, or other data from the handheld remote control, the fixed remote control, or both.

### Power System

As shown in FIGS. 1, 2, and 4-8, the power system comprises one or more solar panels 151 and an energy storage device 152. Per FIGS. 1, 2, and 4-8, the one or more solar panels 151 are mounted to a top surface of the hull 110, the deck 120, or both of the first embodiment of the unmanned water vehicle 100, the second embodiment of the unmanned water vehicle 200, or both. Per FIG. 2 the energy storage device 152 is mounted to a bottom surface the deck 120 of the first embodiment of the unmanned water vehicle 100, the second embodiment of the unmanned water vehicle 200, or both. Alternatively, in some embodiments, the energy storage device 152 is mounted to any surface the deck 120, the hull 110, or both of the first embodiment of the unmanned water vehicle 100, the second embodiment of the unmanned water vehicle 200, or both. Per FIG. 16, the energy storage device 152 is mounted within one or more of the hulls 110.

As shown the first embodiment of the unmanned water vehicle 100, the second embodiment of the unmanned water vehicle 200, or both comprises 10 solar panels 151. Alternatively, in some embodiments, the first embodiment of the unmanned water vehicle 100, the second embodiment of the unmanned water vehicle 200, or both comprises 1, 2, 3, 4, 5, 6, 7, 8, 9, 10, 12, 14, 16, 18, 20, 25, 30, 35, 40, 45, 50, or more solar panels 151. In some embodiments, a total surface area of the one or more solar panels 151 is about 45 sq. ft. to about 180 sq. ft. In some embodiments, each solar panel 151 has a surface area of about 4 sq. ft. to about 18 sq. ft. In some embodiments, the one or more solar panels 151 have a total power of about 700 W to about 2,800 W. In some embodiments, each solar panel 151 has a power of about 60 W to about 300 W.

In some embodiments, one or more of the size, number, and power of the one or more solar panels 151, alone, in combination, or further with respect to the specific material of the two or more hulls 110 and the deck 120, the wireless communication devices and sensors, the energy storage device 152, the winch 131, the steerable drive apparatus 145 or any combination thereof, enables the high towing capacity, the high maximum speed, the high operating speed, the high repositioning speed, the long continuous operation period, or any combination thereof of the unmanned water vehicles 100 herein. In some embodiments, one or more of the size, number, and power of the one or more solar panels 151, alone or in combination garner sufficient solar energy to power the steerable drive apparatus 145, the wireless communication devices, the sensors, the winch 131, the steerable drive apparatus 145 or any combination for a continuous operation period of at least 3 months.

In some embodiments, the energy storage device 152 receives energy from the one or more solar panels 151. In some embodiments, the energy storage device 152 comprises a rechargeable energy storage device. In some embodiments, the energy storage device 152 comprises a non-rechargeable energy storage device. In some embodiments, the non-rechargeable energy storage device is configured to be jettisoned from one or more of the hulls, or the deck during operation. In some embodiments, the energy storage device 152 comprises a battery, a supercapacitor, a capacitor, a spring, a flywheel, an accumulator device, or any combination thereof. In some embodiments, the energy storage device 152 comprises a lithium ion phosphate energy storage device 152. In some embodiments, the first embodiment of the unmanned water vehicle 100, the second embodiment of the unmanned water vehicle 200, or both comprises two or more energy storage devices 152. In some embodiments, each of the two or more hulls 110 comprises at least one energy storage device 152. In some embodiments, the energy storage device 152 further comprises a state of charge display, an energy storage device management system, an external charger, or any combination thereof. In some embodiments, the energy storage device management system balances the incoming solar power, with the stored energy and the energy required by the steerable drive apparatus 145 and the winch 131. In some embodiments, the energy storage device 152 has a power of about 10 W to about 30 W. In some embodiments, the energy storage device 152 stores an energy of about 10 kW/h to about 40 kW/h. In some embodiments, the two or more energy storage devices 152 have a total energy of about 10 kW/h to about 40 kW/h. In some embodiments, the energy storage device 152 has a voltage of about 24 V DC to about 120 V DC. In some embodiments, the energy storage device 152 has a current of about 200 A to about 600 A. In some embodiments, the energy storage device 152 has a capacity of about 50 Ah to about 200 Ah.

In some embodiments, one or more of the power, the energy, the voltage, the current, or the capacity of one or more energy storage devices 152, alone, in combination, or further with respect to the specific material of the two or more hulls 110 and the deck 120, the solar panels 151, the wireless communication devices and sensors, the energy storage device 152, the winch 131, the steerable drive apparatus 145 or any combination thereof, enables the high towing capacity, the high maximum speed, the high operating speed, the high repositioning speed, the long continuous operation period, or any combination thereof of the unmanned water vehicles 100 herein. In some embodiments, one or more of the power, the energy, the voltage, the current, or the capacity of one or more energy storage devices 152, alone or in combination store sufficient energy to power the steerable drive apparatus 145, the wireless communication devices, the sensors, the winch 131, or any combination for a continuous operation period of at least 3 months.

In some embodiments, the power system further comprises an engine coupled to a generator and configured to charge the energy storage device. In some embodiments, the generator is powered by: compressed natural gas, diesel, gasoline, butane, propane, a fossil fuel, or any combination thereof. In some embodiments, the power system further comprises the compressed natural gas, diesel, gasoline, butane, propane, a fossil fuel, or any combination thereof. In some embodiments, per FIG. 15, the power system further comprises a wind-driven vane 170 that generates electricity and provides the generated electricity to the energy storage device. In some embodiments, the power system further comprises a towed or fixed vane that generates electricity from travel through the water. In some embodiments, the power system comprises or further comprises a thermoelectric source. In some embodiments the thermoelectric system is powered by decay heat, ionization heat, or both.

In some embodiments, the first embodiment of the unmanned water vehicle 100, the second embodiment of the unmanned water vehicle 200, or both further comprises a solar controller regulating the charging of the one or more solar panels 151. In some embodiments, the solar controller regulates the voltage output of the one or more panels 151 to about 25 V DC to about 100 V DC. In some embodiments, the solar controller regulates the current output of the one or more panels 151 to about 4 A to about 16 A. In some embodiments, the solar controller enables the collection and storage of sufficient energy to power the steerable drive apparatus 145, the wireless communication devices, the sensors, the winch 131, or any combination for a continuous operation period of at least 3 months.

### Unmanned Water Vehicle Platform

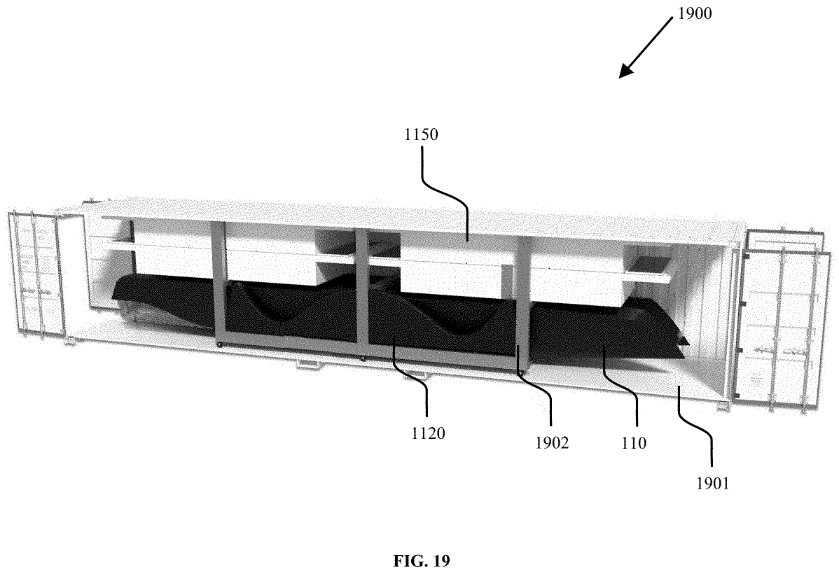

Further provided herein per FIG. 19, is an unmanned water vehicle platform 1900 comprising a shipping container 1901 and a rack 1902 to secure the components of the unmanned water vehicle. As shown, an upper portion of the rack 1902 constrains the payload module 1150, whereas a lower portion of the rack 1902 constrains two or more hulls 110 and the wave breaker 1120. Alternatively, in some embodiments, a lower portion of the rack 1902 constrains the payload module 1150, whereas an upper portion of the rack 1902 constrains two or more hulls 110 and the wave breaker 1120. As shown the rack 1902 constrains 4 payload modules 1150. Alternatively, in some embodiments, the rack 1902 constrains 2 or more payload modules 1150. As shown, in some embodiments, the rack 1902 constrains one or more pairs of payload modules 1150 such that the solar panels of each pair of payload modules 1150 are face to face. Alternatively, in some embodiments, the rack 1902 constrains one or more pairs of payload modules 1150 such that the solar panels of each pair of payload modules 1150 are both facing upwards or both facing downwards. In some embodiments, the rack 1902 constrains the payload module 1150, the two or more hulls 110, and the wave breaker 1120 of the unmanned water vehicle using bolts, screws, ties, clamps, straps, cradles, hook and loop fasteners, hooks, clasps, pins, or any combination thereof.

In some embodiments, the shipping container 1901 comprises a standard 40 foot shipping container. In some embodiments, the shipping container 1901 comprises a standard 20 foot shipping container. In some embodiments, the shipping container 1901 comprises a custom shipping container. As shown, the rack 1902 is configured to fit within the shipping container 1901. In some embodiments, a maximum outer width of the rack 1902 is less than a maximum inner width of the shipping container 1901. In some embodiments, a maximum outer height of the rack 1902 is less than a maximum inner height of the shipping container 1901. In some embodiments, a maximum outer length of the rack 1902 is less than a maximum inner length of the shipping container 1901. configured to fit within the shipping container 1901.

In some embodiments, the rack 1902 is configured to slide within the shipping container 1901. In some embodiments, at least one of the shipping container 1902 and the rack 1902 comprise a wheel, a slide, or both to allow the rack 1902 to slide within the shipping container 1901. In some embodiments, at least one of the rack 1902 and the shipping container 1901 comprises a fastener to removably couple the rack 1902 to the shipping container during transport. In some embodiments, the fastener is a nut, a bolt, a screw, a tie, a hook, a clasp, a clamp, a pin, a slot, or any combination thereof. In some embodiments, the rack 1902 comprises a shock absorber configured to dampen vibration between the rack 1902 and the shipping container 1901, between the rack 1902 and the components of the unmanned water vehicle, or both.

### EXAMPLES

The following illustrative examples are representative of embodiments of the subject matter described herein and are not meant to be limiting in any way.

### Example 1—National Security Configuration

In first example herein, the multi-hull unmanned water vehicle is configured for national security applications by a governmental agency to monitor activity in a port. Specifically, the unmanned water vehicle is outfitted with selected above-water sensors to provide sufficient data collection for threat detection, while enabling continuous operation of the unmanned water vehicle for a period of at least 3 months. For this configuration, an above-water sensor package includes a RADAR, a RADAR intercept, and a RADAR transponder for navigation and detection of surface craft, subsurface craft, and aircraft of various sizes and shapes. A laser range finder and a laser target identifier are further incorporated to supplement and confirm the readings of the RADAR, RADAR intercept, and RADAR transponder. A thermal imaging camera is also used as an above-water sensor to detect heat emitted by, for example, humans or animals, and a communications intercept allows for further detection of potential threats via radio frequency or other emitted signals. These above-water sensors enable threat detection and identification during all conditions of light and weather. Additionally, a below-water sensor package including one or more towed sonar arrays and an acoustic modem improve the detection and identification of surface and subsurface watercraft.

### Example 2—Oil and Gas Industry Configuration

In second example herein, the multi-hull unmanned water vehicle is configured to monitor and secure the waters surrounding offshore oil and gas mining equipment. The above-water sensors are selected to enable continuous detection and troubleshooting of issues with the oil and gas mining infrastructure as well as environmental safety concerns for a period of at least 3 months. For this configuration, an above-water sensor package includes a thermal imaging camera to detect heat emitted by leaks, spills, explosions, collisions, and the like. Additionally, a below-water sensor package including chemical and DNA sampling equipment is configured to detect oil, gas, or other chemical leaks or spills, as well as their effect on the natural environment. Further, a below-water acoustic array, an Acoustic Doppler Current Profiler (ADCP), and an acoustic modem improve the detection and identification of subsurface leaks, spills, explosions, or collisions, and enable underwater imaging for diagnostics and monitoring of subsurface infrastructure.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. An unmanned water vehicle comprising:
(a) two or more hulls;
(b) a deck coupled between the two or more hulls;
(c) a mobility and control system comprising:
(i) a wireless communications device;
(ii) a steerable drive apparatus; and
(iii) a mobility and control module providing operation of the unmanned water vehicle in a remote piloted mode, a semi-autonomous mode, and a fully autonomous mode; and
(b) a power system comprising:
(i) one or more solar panels; and
(ii) an energy storage device receiving energy from the one or more solar panels;
the power system enabling continuous operation of the unmanned water vehicle for a period of at least 3 months.

2. The unmanned water vehicle of claim 1, further comprising an above-water sensor coupled to one or more of the two or more hulls, the deck, or both.

3. The unmanned water vehicle of claim 2, wherein the above-water sensor comprises an acoustic sensor, a RADAR, a LiDAR, a thermometer, a barometer, a pitot tube, a pH meter, a salinity meter, a conductivity sensor, a depth sensor, wave height sensor, a camera, an infrared camera, an inertial reference system, a magnetic compass, a magnetometer, or any combination thereof.

4. The unmanned water vehicle of claim 3, wherein the camera comprises a 360-degree panoramic camera.

5. The unmanned water vehicle of claim 3, further comprising a data storage system to store sensor data.

6. The unmanned water vehicle of claim 1, further comprising a retractable sensor apparatus comprising:
(a) a winch having a cable; and
(b) at least one sensor configured to record a sensor data, the at least one sensor attached to a distal end of the cable.

7. The unmanned water vehicle of claim 6, wherein the at least one sensor comprises an acoustic sensor, a RADAR, a LiDAR, a thermometer, a barometer, a pitot tube, a pH meter, a salinity meter, a conductivity sensor, a depth sensor, wave height sensor, a camera, an infrared camera, an inertial reference system, a magnetic compass, a magnetometer, or any combination thereof.

8. The unmanned water vehicle of claim 7, wherein the camera comprises a 360-degree panoramic camera.

9. The unmanned water vehicle of claim 6, wherein the wireless communication device transmits the sensor data.

10. The unmanned water vehicle of claim 1, wherein the wireless communications device comprises a Wi-Fi device, a cellular device, a satellite communications systems, an over the horizon RF communications system, or any combination thereof.

11. The unmanned water vehicle of claim 1, wherein the steerable drive apparatus comprises a propeller, a ducted propeller, a propulsor, a rudder, a waterjet, an azimuth drive, or any combination thereof.

12. The unmanned water vehicle of claim 1, wherein the steerable drive apparatus is coupled to the deck, the two or more hulls, or both.

13. The unmanned water vehicle of claim 1, wherein the steerable drive apparatus comprises an electric, hydraulic, pneumatic, ocean-assisted, or servo-steerable drive apparatus.

14. The unmanned water vehicle of claim 1, wherein the steerable drive apparatus operates on a current of at most about 400 amps.

15. The unmanned water vehicle of claim 1, wherein the steerable drive apparatus requires a power of about 1,000 W to about 5,000 W.

16. The unmanned water vehicle of claim 1, wherein the steerable drive apparatus outputs a power at a speed of 1 knot of about 150 W to about 1,600 W.

17. The unmanned water vehicle of claim 1, wherein the steerable drive apparatus produces a thrust of about 90 pounds to about 380 pounds.

18. The unmanned water vehicle of claim 1, wherein the steerable drive apparatus produces a thrust of about 4 horsepower to about 50 horsepower.

19. The unmanned water vehicle of claim 1, comprising two or more steerable drive apparatus.

20. The unmanned water vehicle of claim 1, further comprising one or more non-steerable drive apparatus.

21. The unmanned water vehicle of claim 20, wherein the mobility and control module commands the steerable drive apparatus, the non-steerable drive apparatus, or both based on a heading, a position, or both.

22. The unmanned water vehicle of claim 21, wherein the command comprises a direction, a speed, or both.

23. The unmanned water vehicle of claim 22, wherein the wireless communication device receives the command from a handheld remote control, a fixed remote control, or both.

24. The unmanned water vehicle of claim 22, wherein the command further comprises a waypoint, a heading, a thrust output, a motor position, a motor differential thrust, or any combination thereof.

25. The unmanned water vehicle of claim 21, wherein the mobility and control module comprises a Real-Time Kinematic GPS, a gyrocompass, a magnetic compass, or any combination thereof.

26. The unmanned water vehicle of claim 1, wherein the mobility and control module operates the unmanned water vehicle in the remote piloted mode via a command received by the wireless communication device.

27. The unmanned water vehicle of claim 1, wherein the mobility and control module commands the winch to retract the cable and extend the cable.

28. The unmanned water vehicle of claim 1, wherein operation of the unmanned water vehicle in at least one of the semi-autonomous mode and the fully autonomous mode comprises automatic obstacle avoidance.

29. The unmanned water vehicle of claim 1, wherein a total surface area of the one or more solar panels is about 45 square feet to about 180 square feet.

30. The unmanned water vehicle of claim 1, wherein the one or more solar panels have a total power of about 700 W to about 2800 W.

31. The unmanned water vehicle of claim 1, further comprising a solar controller regulating the charging of the one or more solar panels.

32. The unmanned water vehicle of claim 31, wherein the solar controller regulates the voltage output of the one or more panels to about 25 V DC to about 100 V DC.

33. The unmanned water vehicle of claim 31, wherein the solar controller regulates the current output of the one or more panels to about 4 A to about 16 A.

34. The unmanned water vehicle of claim 1, wherein the energy storage device has a power of about 10 W to about 30 W.

35. The unmanned water vehicle of claim 1, wherein the energy storage device has a voltage of about 24 V DC to about 120 V DC.

36. The unmanned water vehicle of claim 1, wherein the energy storage device has a current of about 200 A to about 600 A.

37. The unmanned water vehicle of claim 1, wherein the energy storage device has a capacity of about 50 Ah to about 200 Ah.

38. The unmanned water vehicle of claim 1, wherein the energy storage device has an energy of about 10 kW/h to about 40 kW/h.

39. The unmanned water vehicle of claim 1, wherein the energy storage device comprises a rechargeable energy storage device.

40. The unmanned water vehicle of claim 1, wherein the energy storage device comprises a non-rechargeable energy storage device.

41. The unmanned water vehicle of claim 40, wherein the non-rechargeable energy storage device is configured to be jettisoned from one or more of the hulls, or the deck during operation.

42. The unmanned water vehicle of claim 1, further comprising a ballast system comprising a ballast tank within one or more of the two or more hulls, the deck, or both and at least one of a ballast pump and a ballast valve.

43. The unmanned water vehicle of claim 42, wherein the ballast tank has a capacity of about 50 gallons to about 200 gallons.

44. The unmanned water vehicle of claim 1, further comprising a fixed ballast keel, a deployable ballast keel, or both.

45. The unmanned water vehicle of claim 1, further comprising a swinging ballasted keel.

46. The unmanned water vehicle of claim 1, further comprising at least one sensor deployment tube on an underside of the deck, an underside of hull, or both.

47. The unmanned water vehicle of claim 46, comprising 5 to 20 sensor deployment tubes.

48. The unmanned water vehicle of claim 1, having a weight of about 300 pounds to about 1,200 pounds.

49. The unmanned water vehicle of claim 1, having a maximum above water height of about 1 foot to about 6 feet.

50. The unmanned water vehicle of claim 1, wherein the hull has a maximum above water height of about 1 foot to about 4 feet.

51. The unmanned water vehicle of claim 1, having a maximum below water depth of about 1 foot to about 6 feet.

52. The unmanned water vehicle of claim 1, having a maximum RADAR cross section of about 0.1 m².

53. The unmanned water vehicle of claim 1, having a maximum speed of about 16 knots.

54. The unmanned water vehicle of claim 1, having an operating speed of about 0.5 knots to about 3 knots.

55. The unmanned water vehicle of claim 1, configured to operate independently for about 30 days to about 120 days.

56. The unmanned water vehicle of claim 1, having a towing capacity of about 20 pounds to about 80 pounds.

57. The unmanned water vehicle of claim 1, having a sea state capability of 3, 4, 5, 6, or 7.

58. The unmanned water vehicle of claim 1, wherein the power system further comprises an engine coupled to a generator and configured to charge the energy storage device.

59. The unmanned water vehicle of claim 1, wherein the power system further comprises a wind-driven vane that generates electricity and provides the generated electricity to the energy storage device.

60. The unmanned water vehicle of claim 1, further comprising a wave breaker coupled to the deck, one or more of the two or more hulls, or both.

61. The unmanned water vehicle of claim 1, wherein the deck is formed of a plurality of payload modules.

62. A platform comprising:
(a) the unmanned water vehicle of claim 1;
(b) a frame securing at least a portion of the unmanned water vehicle; and
(c) a shipping container housing the frame and the unmanned water vehicle.

63. An unmanned water vehicle comprising:
(a) two or more hulls;
(b) a wind turbine;
(c) a steerable drive apparatus;
(d) a plurality of modular deck components configured to removably couple to one or more of the two or more hulls, wherein each modular deck component comprises:
(i) one or more solar panels; and
(ii) a ballast;
(e) a mobility and control system comprising:
(i) a wireless communications device; and
(ii) a mobility and control module providing operation of the unmanned water vehicle in a remote piloted mode, a semi-autonomous mode, and a fully autonomous mode; and
(b) a power system comprising an energy storage device receiving energy from the one or more solar panels to power the wind turbine, the steerable drive apparatus, or both; wherein the wind turbine and the steerable drive apparatus output a sufficient power to enable a maximum speed of the unmanned water vehicle of at least about 8 knots.
